(19) United States
(12) Patent Application Publication
(10) Pub. No.: US 2009/0324143 A1
(43) Pub. Date: Dec. 31, 2009

(54) BAGS HAVING COMPOSITE STRUCTURES AND RELATED METHODS

(75) Inventors: Stuart Sharp, Greer, SC (US); Allyson Smith, Columbia, SC (US); George Solomon, Spartanburg, SC (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: EXOPACK, LLC., Spartanburg, SC (US)

(21) Appl. No.: 12/556,151

(22) Filed: Sep. 9, 2009

Related U.S. Application Data
(63) Continuation-in-part of application No. 11/214,419, filed on Aug. 29, 2005.
Application No. 11/214,419 is a continuation-in-part of application No. 11/214,434, filed on Aug. 29, 2005.
Application No. 11/214,434 is a continuation-in-part of application No. 11/240,944, filed on Sep. 30, 2005.
Application No. 11/240,944 is a continuation-in-part of application No. 12/341,080, filed on Dec. 22, 2008.
(60) Provisional application No. 60/709,512, filed on Aug. 19, 2005.

(51) Int. Cl. B65D 30/08; B32B 37/02

(52) U.S. Cl. 383/109; 156/227; 156/92

(57) ABSTRACT

A bag can include walls formed of a material having multiple layers, which can include a paper layer located between an outer layer and an inner layer. The outer layer can be formed from a nylon material and the inner layer can be formed from a polyolefin material, and the bag can exhibit grease-resistant properties. The bag can be formed into a variety of configurations, such as a sewn-open-mouth configuration in which a stitching element extends through a wall of the bag or a variety of pinch-type closure configurations.

### CROSS-REFERENCE TO RELATED APPLICATIONS

This patent application is a continuation-in-part of prior U.S. patent application Ser. No. 11/214,419, filed on Aug. 29, 2005; is a continuation-in-part of prior U.S. patent application Ser. No. 11/214,434, filed on Aug. 29, 2005; is a continuation-in-part of prior U.S. patent application Ser. No. 11/240,944 filed on Sep. 30, 2005, which claims the benefit of U.S. Provisional Patent Application No. 60/709,512, filed on Aug. 19, 2005; and is a continuation-in-part of prior U.S. patent application Ser. No. 12/341,080, filed on Dec. 22, 2008. Each of the foregoing applications is hereby incorporated by reference herein.

### TECHNICAL FIELD

Embodiments disclosed herein relate generally to bags that can be used in the packaging industry.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 illustrates a perspective view of an embodiment of a bag having a product with a grease component disposed therein;

FIG. 2 illustrates a side elevation view of the bag of FIG. 1;

FIG. 3 illustrates a perspective view of the bag of FIG. 1 in which product is being deposited through an open end of the bag;

FIG. 4 illustrates a partial cross-section view of the bag of FIG. 1 that depicts grease-resistant properties of an embodiment of a material compatible with the bag;

FIG. 5A illustrates a partial exploded view of an embodiment of an outer ply compatible with the bag of FIG. 1;

FIG. 5B illustrates a partial exploded view of another embodiment of an outer ply compatible with the bag of FIG. 1;

FIG. 5C illustrates a partial exploded view of another embodiment of an outer ply compatible with the bag of FIG. 1 in which a film portion of the outer ply is reverse printed;

FIG. 6A illustrates a partial cross-sectional view of the outer ply of FIG. 4A taken along the view line 6A-6A in FIG. 5A;

FIG. 6B illustrates a partial cross-sectional view of the outer ply of FIG. 5B taken along the view line 6B-6B in FIG. 5B;

FIG. 7 illustrates a partial exploded view of an embodiment of an inner ply compatible with the bag of FIG. 1;

FIG. 8 illustrates a partial cross-sectional view of the inner ply of FIG. 7 taken along the view line 8-8 in FIG. 7;

FIG. 9 illustrates a partial exploded view of an embodiment of a material having an embodiment of an inner ply and an embodiment of an outer ply and that is compatible with the bag of FIG. 1;

FIG. 10A illustrates a partial cross-sectional view of the material of FIG. 9 taken along the view line 10A-10A in FIG. 9;

FIG. 10B illustrates a partial cross-sectional view of another embodiment of material compatible with the bag of FIG. 1;

FIG. 11 illustrates a partial exploded view of an embodiment of material such as that of FIG. 9 that is capable of being formed into a tube-like structure;

FIG. 12 illustrates a perspective view of the material of FIG. 11 in the form of an embodiment of a tube;

FIG. 13 illustrates a partial perspective view of an embodiment of a closed end of a bag;

FIG. 14A illustrates a cross-sectional view of the bag of FIG. 13, during formation of the closed end, taken along the view line 14-14 in FIG. 13;

FIG. 14B illustrates a cross-sectional view of the bag of FIG. 14A, after formation of the closed end, taken along the view line 14-14 in FIG. 13;

FIG. 14C illustrates a cross-sectional view such as that of FIG. 14A of another embodiment of a closed end of a bag;

FIG. 14D illustrates a cross-sectional view such as that of FIG. 14A of another embodiment of a closed end of a bag;

FIG. 14E illustrates a cross-sectional view such as that of FIG. 14A of another embodiment of a closed end of a bag;

FIG. 15 illustrates a perspective view of another embodiment of a closed end of a bag;

FIG. 16A illustrates a cross-sectional view of the closed end of the bag shown in FIG. 15 taken along the view line 16A-16A in FIG. 15;

FIG. 16B illustrates a cross-sectional view such as that of FIG. 16A of another embodiment of a closed end of a bag;

FIG. 17 illustrates a flow diagram that depicts a method for constructing some embodiments of the bags disclosed herein;

FIG. 18 illustrates a table comparing various properties of various materials, at least some of which are compatible with embodiments of a grease-resistant bag;

FIG. 19 illustrates a table comparing various properties of various materials, at least some of which are compatible with embodiments of a grease-resistant bag;

FIG. 20 illustrates a table comparing various properties of various materials, at least some of which are compatible with embodiments of a grease-resistant bag;

FIG. 21 illustrates a table comparing various properties of various materials, at least some of which are compatible with embodiments of a grease-resistant bag;

FIG. 22 illustrates a perspective view of an embodiment of a bag having a product with a grease component disposed therein;

FIG. 23 illustrates a side elevation view of the bag of FIG. 22;

FIG. 24 illustrates a cutaway perspective view of an embodiment of a bag-end heat-sealing apparatus with a plurality of bags disposed thereon;

FIG. 25 illustrates a cutaway perspective view of an end portion of the bag of FIG. 22, wherein the end portion is in a closed configuration;

FIG. 26 illustrates a cutaway cross-section view of the end portion closed configuration as depicted in FIG. 25 taken along the view line 26-26 in FIG. 25;

FIG. 27 illustrates a flow diagram that depicts another method for constructing some embodiments of the bags disclosed herein;

FIG. 28 illustrates a flow diagram that depicts another method for constructing some embodiments of the bags disclosed herein;

FIG. 29 illustrates a perspective view of an embodiment of a bag that includes an embodiment of a composite material having multiple layers, wherein the bag has a sewn end and an open end;

FIG. 30 illustrates a perspective view of the bag of FIG. 29 having a product disposed therein and two sewn ends;

FIG. 31 illustrates a partial cross-sectional view of a sewing needle penetrating an end portion of material during formation of an embodiment of a bag;

FIG. 32A illustrates a partial cross-sectional view of a portion of an embodiment of a bag through which an embodiment of a stitching element extends;

FIG. 32B illustrates a partial cross-sectional view of another portion of the bag of FIG. 32A through which an embodiment of a stitching element extends;

FIG. 33 illustrates a perspective view of a portion of an embodiment of a zipper closure at an end of an embodiment of a bag;

FIG. 34 illustrates a partial cross-sectional view of the zipper closure of FIG. 14 taken along the view line 34-34 in FIG. 33;

FIG. 35 illustrates a partial cross sectional view of another embodiment of a zipper closure;

FIG. 36 illustrates a table comparing various properties of various bags;

FIG. 37 illustrates a table comparing the results of drop tests performed on various bags;

FIG. 38 illustrates a perspective view of another embodiment of a bag constructed from an embodiment of a composite material;

FIG. 39 illustrates a cutaway exploded perspective view of another embodiment of a composite material from which the bag of FIG. 38 may be formed;

FIG. 40 illustrates a cross-section view of the composite material of FIG. 39 taken along the view lines 40-40 in FIGS. 39 and 41;

FIG. 41 illustrates a cutaway perspective view of the composite material of FIG. 39;

FIG. 42 illustrates a cutaway perspective view of the bottom end of the bag of FIG. 38;

FIG. 43 illustrates a cross-sectional view of the bottom end of the bag of FIG. 38 taken along the view line 43-43 in FIG. 42;

FIG. 44 illustrates a cross-sectional view of another embodiment of a composite material compatible with embodiments of the bag of FIG. 38;

FIG. 45 illustrates a cross-sectional view of another embodiment of a composite material compatible with embodiments of the bag of FIG. 38;

FIG. 46 illustrates a cross-sectional view of the composite material of FIG. 45, wherein the material defines a closure;

FIG. 47 illustrates a cross-sectional view of another embodiment of a composite material;

FIG. 48 illustrates a cross-sectional view of an embodiment of a bag closure that includes an embodiment of the composite material of FIG. 47; and

FIG. 49 illustrates a cross-sectional view of another embodiment of a composite material compatible with embodiments of the bag of FIG. 38.

### DETAILED DESCRIPTION

Embodiments of bags are disclosed. In many embodiments, a bag can comprise multiple layers. Each layer can provide the bag with one or more desirable characteristics, depending on the application of the bag. In certain embodiments, the bag can comprise a paper layer, which can contribute to the stiffness of the bag and can aid in manufacturing the bag using standard converting equipment. In some embodiments, the bag can comprise one or more polyolefin and/or polyamide layers. In some embodiments, the one or more polyolefin and/or polyamide layers can provide the bag with grease-resistant properties and/or increased strength and durability. Such embodiments, as well as others, are disclosed in greater detail.

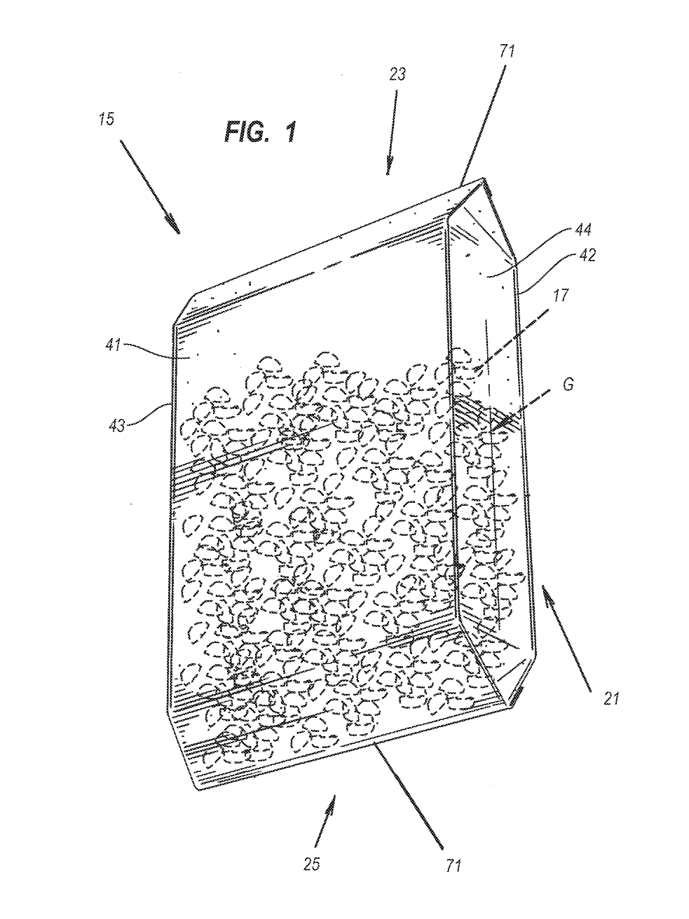

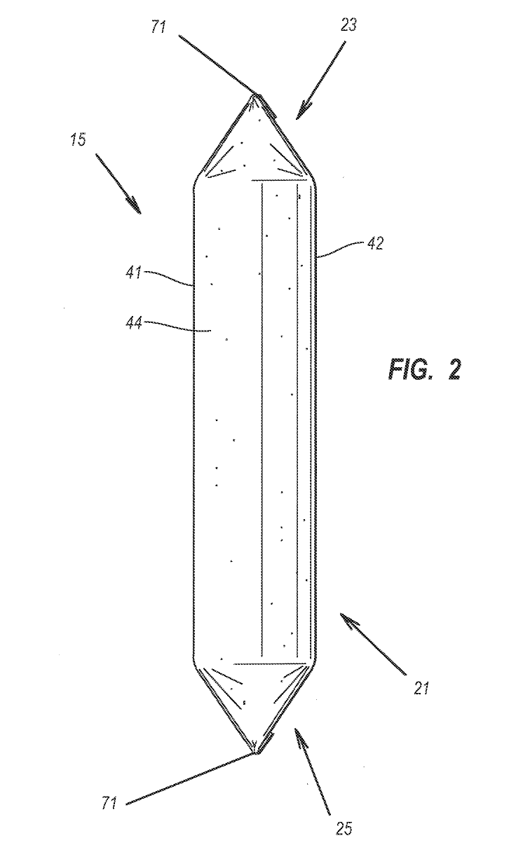

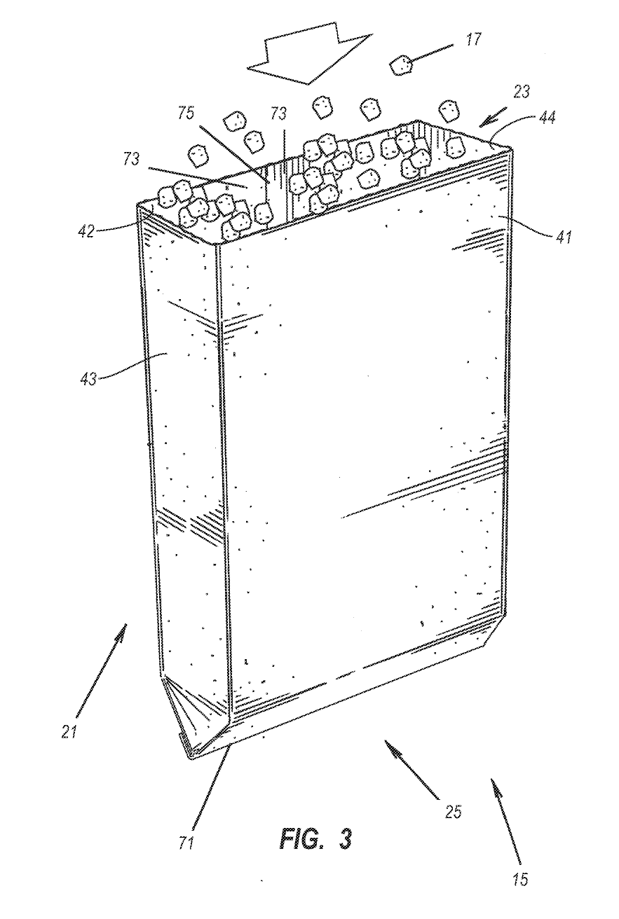

FIG. 1 illustrates a perspective view of an embodiment of a bag 15. The bag 15 can include a body portion 21, which can be substantially tubular in form. For example, the bag 15 can include a front wall 41, a rear wall 42 a left side wall 43, and a right side wall 44 (see also FIGS. 2 and 3), which can be arranged in any suitable tubular arrangement. The body portion 21 may comprise a top end 23 and a bottom end 25. As used herein, terms describing orientation, such as top, bottom, front, back, left, right, etc. are recited from the perspective illustrated in FIG. 1. Such directional terms are used for convenience and should not be construed as limiting. For example, in some embodiments, the front wall 41 may in fact be printed with material generally relegated to the back of a package, whereas the rear wall 42 may be printed with material generally displayed on the front of a package. Likewise, the top end 23 may in fact be configured for use as a base end of the bag 15, with the bottom end 25 serving as an upper end of the bag 15.

As further discussed below, the material from which the body portion 21 is formed can comprise multiple layers, each of which can provide or aid in providing desirable functional characteristics to the bag 15. In certain embodiments, the bag 15 can have contents disposed therein, such as a product 17. In some embodiments, the product 17 includes a grease component G. Once the product 17 is within the bag 15, the top end 23 of the bag 15 can be closed in any suitable fashion. For example, in the depicted embodiment, each of the top end 23 and the bottom end 25 comprises a compressed lip 71.

FIG. 2 illustrates a side elevation view of the bag 15 of FIG. 1. The tubular structure of body portion 21 may be more readily appreciated in the depiction of FIG. 2. The top end 23 is closed via an upper compressed lip 71, and the bottom end 25 is closed via a lower compressed lip 71. As described herein, the top and bottom ends 23 and 25 may be closed via any of a variety of techniques, which may employ adhesives, heat-seal films, stitches, or a combination of the preceding. For example, in some embodiments, the bag ends 23, 25 are not necessarily compressed in order to form a closure.

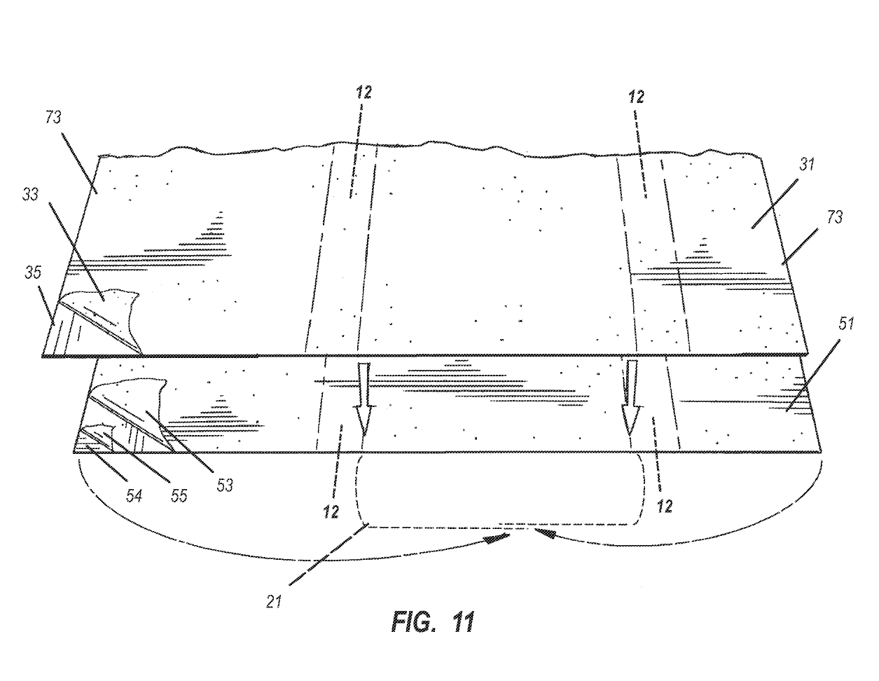

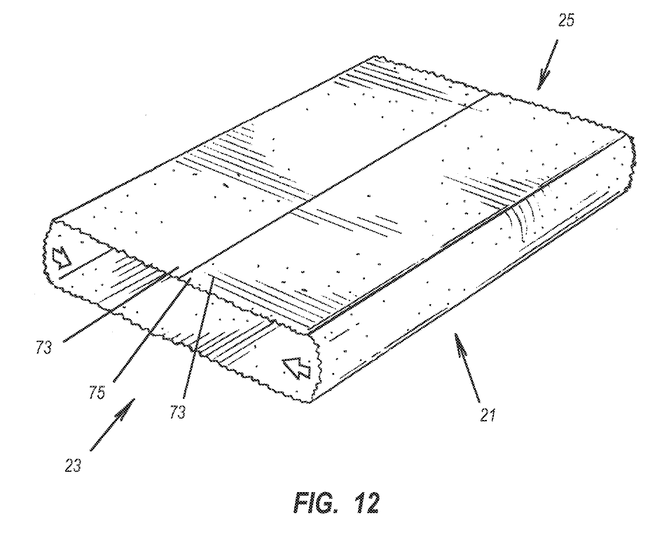

FIG. 3 illustrates a perspective view of the bag of FIG. 1 in which the top end 23 is in an open configuration and the body portion 21 is receiving the product 17. In the depiction of FIG. 3, lateral sides 73 are shown coupled together at a seam 75 such that the tubular shape of the body portion 21 is formed (see also FIGS. 11 and 12 and the associated discussion below). The bottom end 25 is in a closed configuration, and in particular, is closed via a compressed lip 71.

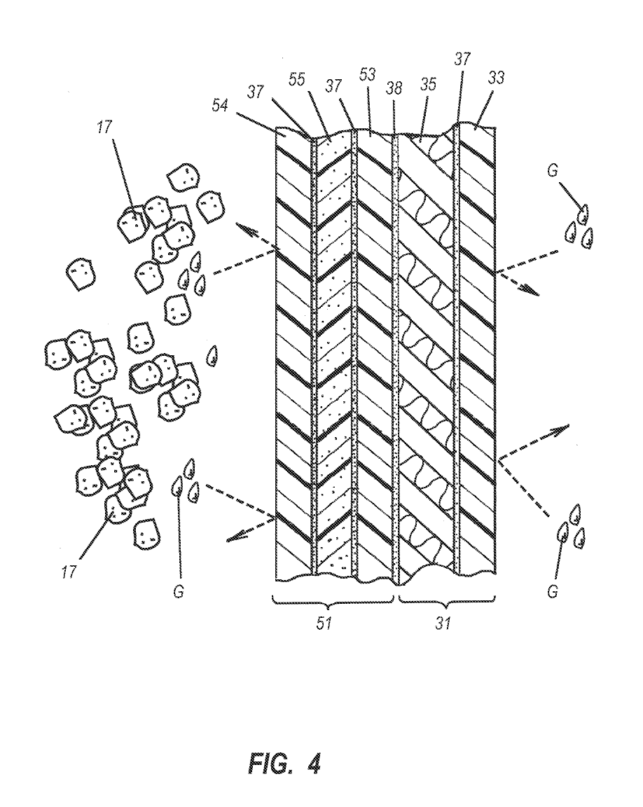

As schematically illustrated in FIG. 4, in some embodiments, the bag 15 can substantially prevent grease G from the product 17 from migrating or penetrating from within the bag 15 to a position outside the bag 15. In further embodiments, the bag 15 can prevent grease at a position outside of the bag 15 from migrating into or otherwise penetrating the bag 15. The bag 15 can also substantially block or serve as a barrier to elements other than grease, such as, for example, liquids or odors. These properties are described in further detail below.

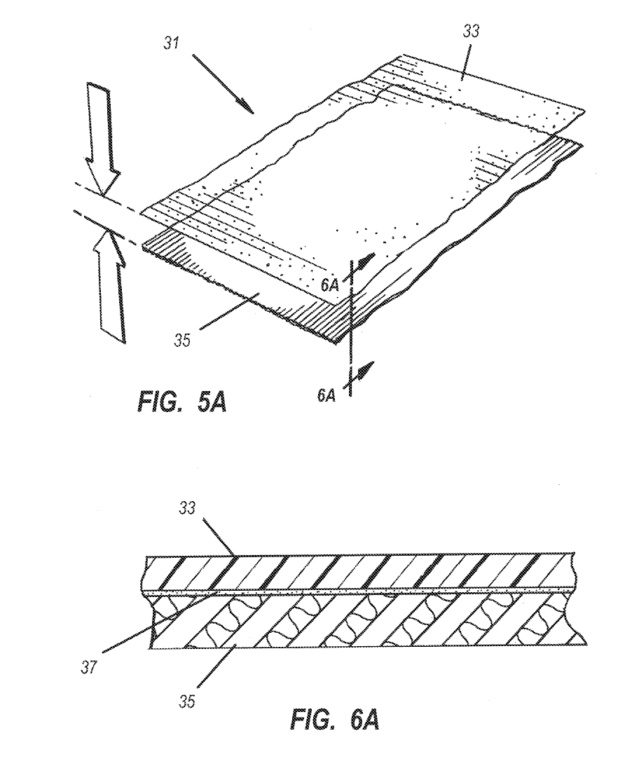

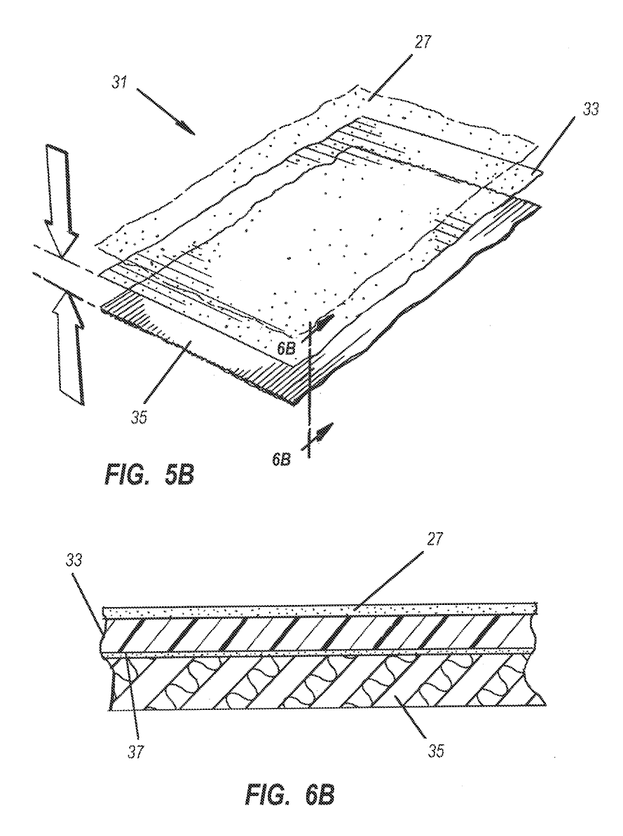

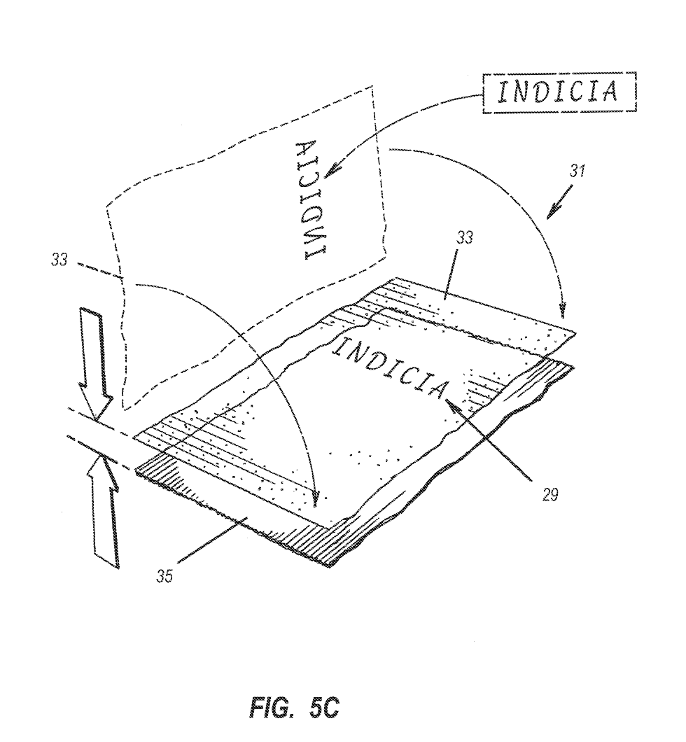

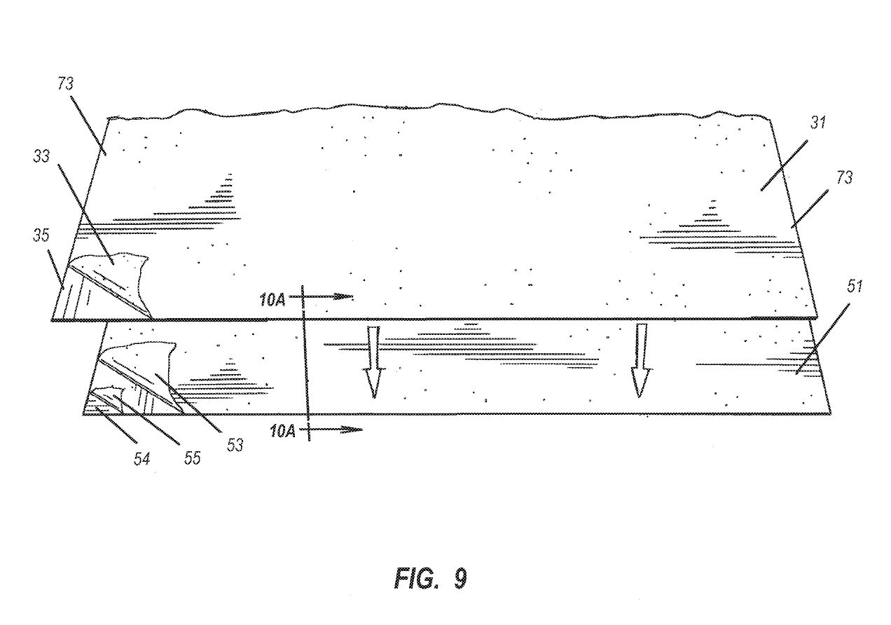

With reference to FIGS. 4-10B, in certain embodiments, the material of which the body portion 21 of the bag 15 is formed can comprise an outer ply 31 and an inner ply 51. In some embodiments, an inner face (e.g., an inwardly facing surface) of the outer ply 31 is adhered to an outer face (e.g., an outwardly facing surface) of the inner ply 51. In further embodiments, the inner and outer plies 51, 31 can be in abutting contact. For example, the inner ply 51 can be laminated to the outer ply 31. With reference generally to FIGS. 4-6B, and more particularly to FIGS. 5A and 6A, in certain embodiments, the outer ply 31 can comprise a film 33 and a paper layer 35. The film 33 and the paper layer 35 can be joined in any suitable fashion. For example, the film 33 and the paper layer 35 can be laminated, such as via adhesive lamination or extrusion lamination. The film 33 can be adhered (e.g., in abutting contact) to an outer face of the paper layer 35 via a tie layer 37. In various embodiments, the tie layer 37 can comprise a solventless adhesive, a plastic-type bonding material, or a co-extruded film. In some embodiments, the tie layer 37 comprises polyurethane. Other suitable materials are possible for the tie layer 37. For example, solvent-based adhesives may be used.

Any suitable methods and equipment can be used to join the film 33 and the paper layer 35, including those known in the art and those yet to be devised. For example, an adhesive can be applied in a conventional manner on conventional equipment. In some embodiments, the adhesive can comprise a water-adhesive in a mixture, or can comprise a 100% solids glue. For example, in some embodiments, the adhesive can comprise a radiation-cured adhesive, a solventless adhesive, a solvent-based adhesive, or a water-based adhesive. In other embodiments, extrusion coating lamination may be used. For example, in some embodiments, an extrusion coating lamination comprises the use of a PE blend as the extrudate. In some embodiments, the lamination is performed via a separate piece of equipment designed for laminating and extruding. In other embodiments, an in-line tuber is used.

In certain embodiments, the film 33 comprises a polyolefin, and may comprise a thermoplastic material. For example, in various embodiments, the film 33 comprises polyethylene terephthalate (PET), polyethylene terephthalate polyester (PETP), polytrimethylene terephthalate (PTT), polybutylene terephthalate (PBT), or polypropylene (PP). In some instances, PTT and PBT may be more expensive than PET. Certain films 33, such as some embodiments that comprise polyester (e.g., PETP), can be puncture-resistant, tear-resistant, scratch-resistant, grease-resistant, and/or absorption-resistant. These properties can aid in providing a bag 15 with, and in maintaining, an aesthetically pleasing appearance.

In some embodiments, the film 33 can include one or more materials configured to provide or enhance the grease-resistance or other barrier properties of the film 33. For example, in some embodiments, the film 33 can be resistant to or substantially impermeable to mineral oils, solvents, and acids. The film 33 can include, for example, plastics, polyvinyl chloride (PVC), polyamide (PA), polyethylene (PE), polystyrene (PS), and/or polypropylene (PP).

In some embodiments, the film 33 can be in a range of from about 30 gauge to about 300 gauge. In other embodiments, the thickness can be in a range from about 36 gauge to about 48 gauge. For example, in certain pet food bag applications, the film 33 can be about 48 gauge. The film 33, however, can have other gauges for pet food bags, or for other applications, as needed or desired.

With reference to FIGS. 5B and 6B, in certain embodiments, the film 33 can be treated with a coating 27 on the outer face thereof. The coating 27 can provide an enhanced barrier, and can inhibit or substantially prevent grease and/or moisture from penetrating the bag 15 from the outside. The coating 27 can protect against abrasion of the film 33, and may provide an aesthetically appealing gloss finish. In some embodiments, the coating 27 can facilitate adhesion and bonding and can increase a coefficient of friction of the bag 15. In some embodiments, the coating 27 can include printed indicia, which can be surface printed or reverse printed. In various embodiments, the coating 27 can comprise, for example, a flexography coating 27, a proprietary coating 27, or any other suitable coating 27. For example, in some embodiments, the coating 27 can comprise the proprietary coating REPELLENCE™ barrier coating or AQUA CRYSTAL™ film coating, each of which is manufactured by Exopack, LLC of Spartanburg, S.C.

In some embodiments, the coating 27 can provide oil, grease, and/or water resistance without the use of traditional films and/or foils, which can be inferior for various purposes. The coating 27 can effectively preserve the quality of the package contents as well as the physical integrity of the bag 15 as a whole. For example, in some embodiments, a coating 27 that comprises REPELLENCE™ can be used with products that contain oil or grease, or for bags 15 that may occasionally be subjected to rain or other elements. In some embodiments, a coating 27 that comprises AQUA CRYSTAL™ can be relatively clear and glossy, thereby providing a bag 15 with an attractive appearance.

In still other embodiments, one or more additional polyolefin films 33 can be combined with the illustrated film 33. For example, an additional polyolefin film 33 can replace the coating 27, or in further embodiments, the additional polyolefin film can be joined with an outwardly facing surface of the illustrated film 33, and the coating 27 can be applied to an outwardly facing surface of the additional polyolefin film 33.

In certain embodiments, an outer face of the film 33 can have a coefficient of friction in a range of from about 0.5 to about 0.9. Other ranges and values are also possible. The coefficient of friction, for example, for certain pet food bag applications can be sufficiently large to inhibit slipping or sliding of a bag 15 when positioned on a shelf or cabinet.

With reference to FIG. 5C, in some embodiments, an inner face of the film 33 of the outer ply 31 can include printed indicia 29, which can aid in the identification and/or advertisement of the contents of the bag, the distributor of the bag, etc. In some embodiments, the film 33 exhibits properties (e.g., clarity, shininess, scratch resistance, etc.) that can enhance visual appearance of the bag 15, as described above. The film 33 can be configured to transmit light such that the printed indicia 29 is visible at a position outside of the bag 15.

In certain embodiments, the film 33 can be amorphous, which is a classification indicating that the film 33 is highly transparent and colorless, or can be semi-crystalline, which is a classification indicating that the film 33 is translucent or opaque with an off-white coloring. In some cases, amorphous polyester films 33 can have better ductility than semi-crystalline polyesters, but can exhibit less hardness and stiffness than the semi-crystalline type. In some embodiments, a film 33 can be printed with solvent-based inks or water based inks, and can be printed overall with a flood coat of white ink, which may allow for high-quality graphics. Certain embodiments that include a flood coat of white ink may also mask grease that might penetrate through the film 33 (e.g., via a cut or crack in the film 33). In some embodiments, portions of the film 33 are treated with an acrylic chemical suitable for adhering to solvent based inks, water based inks, or other inks.

In certain embodiments, instead of reverse printing indicia 29 on the inner face of the film 33, indicia 29 can be surface printed on the outer face of the film 33. It is also possible to print indicia 29 on both the inner and outer faces of the film 33. In other embodiments, the film 33 can be unprinted (e.g., the film 33 can be substantially plain and/or clear). The film 33 can provide a bag 15 with a superior appearance, as compared with, for example, standard pet food bags. For example, a printing on the film 33 can be more aesthetically pleasing than similar printing applied to paper bags that do not have an outer film 33.

With reference again to FIGS. 4-6B generally, in certain embodiments, the paper layer 35 of the outer ply 31 can exhibit a bending stiffness, modulus, and/or tensile stiffness that is larger than that of the film 33. In further embodiments, the paper layer 35 can be thicker than the film 33. In some embodiments, the paper layer 35 can provide sufficient structural rigidity to permit the bag 15 to be placed in and remain in an upright position. For example, the bag 15 might contain a product 17 in an amount sufficient to fill only a fraction (e.g., ¼, ⅓) of the bag 15. In certain of such embodiments, the product 17 can be settled at the bottom end 25 of the bag 15, and the bag 15 can be set upright on its bottom end 25. Although the product 17 does not generally support the top end 23 of the bag 15 in such a configuration, the bag 15 can nevertheless remain in a substantially upright configuration, and can resist gravitational force acting on the top end 23 of the bag 15 due to the stiffness of the paper layer 35.

As used herein, the term stiffness is a broad term used in its ordinary sense, and can include bending stiffness or tensile stiffness. Other suitable measurements of stiffness can also be utilized, such as droop stiffness, folding endurance, or other alternative measurements. In certain instances, bending stiffness represents the rigidity of paper or paperboard. In some cases, the bending stiffness of an item can be a function of (e.g., can be proportional to) the cube of the caliper thickness of the item. Bending stiffness can also be related to the modulus of elasticity of the item. In many embodiments, the bending stiffness of a paper layer 35 generally increases as the thickness of the paper layer 35 is increased.

Various instruments may be used to measure stiffness, many of which determine the stiffness of an item by subjecting it to bending of one variety or another. For example, some instruments employ 2-point bending, while others employ 4-point bending. Solid fiber boards and small fluted combined boards (which can be used in folding cartons) are typically measured with 2-point bending instruments. Suitable instruments for measuring bending stiffness can include Taber, Gurley, and L&W instruments.

Industry standards for measuring stiffness adopted by the Technical Association of the Pulp and Paper Industry (TAPPI) can be used to characterize the stiffness of a bag 15 or portions (e.g. layers) thereof. For example, the Gurley Stiffness value can be measured via a Gurley Stiffness Tester, manufactured by Gurley Precision Instruments of Troy, N.Y. The Gurley Stiffness Tester measures the externally applied moment required to produce a given deflection of a strip of material of specific dimensions fixed at one end and having a concentrated load applied to the other end. The results are obtained as “Gurley Stiffness” values, which can be in units of grams.

Similarly, stiffness can be measured in Taber Stiffness Units using a Taber® Stiffness Tester manufactured by Taber Industries of North Tonawanda, N.Y. Taber Stiffness Units can be defined as the bending moment of ⅕ of a gram applied to a 1.5 inch wide specimen at a 5 centimeter test length, flexing it to an angle of 15 degrees. Stiffness Units can be expressed in grams.

To obtain a reading of the Taber Stiffness of a test strip of material, the test strip can be deflected 7.5 degrees or 15 degrees in opposite directions (e.g., to the left and to the right). The average reading of the deflections can then be obtained. This average can then be multiplied using the appropriate number provided in Table A below for a particular range. The resultant product is the stiffness value of the material in Taber Stiffness Units.

TABLE A

| | Stiffness | Test | Roller | Specimen | | Angle of | Scaling |
|---|---|---|---|---|---|---|---|
| Range | Units | Length | Position | Size | Weight | Deflection | Multiplier |
| 1 | 0-1 | 2 cm | SR | 1½ × 1½ | 10 unit | 15° | 0.01 |
| | | | Attachment | | compensator | | |
| 2 | 0-10 | 1 cm | Up | 1½ × 1½ | 10 unit | 15° | 0.1 |
| | | | | | compensator | | |
| 3 | 10-100 | 5 cm | Down | 1½ × 2¾ | — | 15° | 1 |
| 4 | 50-500 | 5 cm | Down | 1½ × 2¾ | 500 units | 15° | 5 |
| 5 | 100-1000 | 5 cm | Down | 1½ × 2¾ | 1000 | 15° | 10 |
| | | | | | units | | |
| 6 | 200-2000 | 5 cm | Down | 1½ × 2¾ | 2000 | 15° | 20 |
| | | | | | units | | |
| 7 | 300-3000 | 5 cm | Down | 1½ × 2¾ | 3000 | 15° | 30 |
| | | | | | units | | |
| 8 | 500-5000 | 5 cm | Down | 1½ × 2¾ | 5000 | 15° | 50 |
| | | | | | units | | |
| 9 | 1000-10000 | 5 cm | Down | 1½ × 2¾ | 5000 | 7.5° | 100 |
| | | | | | units | | |

The following formula can apply to Taber Stiffness measurements:

E=0.006832×(1/(w×d³×θ))×S_{T}

where E is stiffness in flexure in pounds per square inch, w is specimen width in inches, d is the specimen thickness in inches, θ is the deflection of the specimen expressed in radians, and S_{T} is Taber Stiffness Units.

There can be a reasonable correlation between Gurley Stiffness and Taber Stiffness, such as for paperboard grades. For example, the following formula can be used to convert between Gurley Stiffness and Taber Stiffness:

S_{T}=0.01419S_{G}−0.935

where S_{T} is Taber Stiffness Units and S_{G} is Gurley Stiffness Units. As indicated in TAPPI Test Method T-543, paragraph 4.1.5, Gurley values can range from approximately 1.39 to 56,888 Gurley Stiffness units, and can correspond roughly to Taber values ranging from approximately 0 to 806.3 Taber Stiffness units.

In many embodiments, the stiffness of the paper layer 35 is selected such that the multi-layer material of which a bag 15 is ultimately formed can be laminated on existing machinery. Likewise, in many embodiments, the stiffness of the paper layer 35 is selected such that the material can be formed into the bag 15 on existing converting equipment. In some embodiments, the paper layer 35 can define a thickness in a range of between about 1.75 mils and about 10 mils, and in further embodiments, the thickness can be between about 3.0 mils and about 4.0 mils. For example, in some embodiments, the minimum thickness is about 1.9 mils.

In various embodiments, the film 33 can define a thickness in a range of between about 0.25 mils and about 1.25 mils, between about 0.25 mils and about 0.75 mils, or between about 0.70 mils and about 1.25 mils. In some embodiments, the film 33 can be 48 gauge and/or have a thickness in the range of about 0.475 mils to about 0.485 mils. Increased thickness of the paper layer 35 and/or the film 33 can provide for increased bending stiffness and increased stabilization of a bag 15. In some embodiments, the film 33 can comprise PET and can define a thickness within a range of between about 0.25 mils and about 0.75 mils. In other embodiments, the film 33 can comprise BOPP and can define a thickness within a range of between about 0.70 mils and about 1.25 mils.

In certain embodiments, the paper layer 35 can enhance the durability of a bag 15. Various basis weights of paper can be utilized, for example, ranging from about 30 pound-force/inch to about 50 pound-force/inch, as these units are understood by those skilled in the art. In other embodiments, the paper can be in a range between about 20 pounds per 3,000 square feet and about 80 pounds per 3,000 square feet. Embodiments of the paper layer 35 can be coated (e.g., clay-coated) and/or bleached, or in other embodiments, can be manufactured without coating or bleach.

In many embodiments, the paper layer 35 is substantially free of fluorocarbons. Many prior art bags include a paper constituent that has been treated with a fluorocarbon chemical, which can provide the paper with a degree of grease resistance. However, in some embodiments in which the paper layer 35 is substantially free of fluorocarbons, interior layers that are applied to the paper layer 35 (as discussed below) can provide sufficient grease resistance.

In other embodiments, the paper layer 35 can be treated to improve its grease-resistance. For example, in some embodiments, the paper layer 35 can be treated with a fluorocarbon chemical. Treatments (e.g., chemical treatments) other than fluorocarbon treatments are also possible, and may provide enhanced protection from grease penetrating through the paper layer 35 of the bag 15.

In some embodiments, an outer face of the paper layer 35 can include printed indicia. Procedures for printing indicia can include process printing, rotogravure printing, innovative flexographic printing, etc. In some embodiments, the film 33 does not include printed indicia 29 (see FIG. 4C) when the paper layer 35 is printed, which can prevent the film 33 from obscuring the printed matter of the paper layer 35. In other embodiments, both the paper layer 35 and the film 33 can include printed portions.

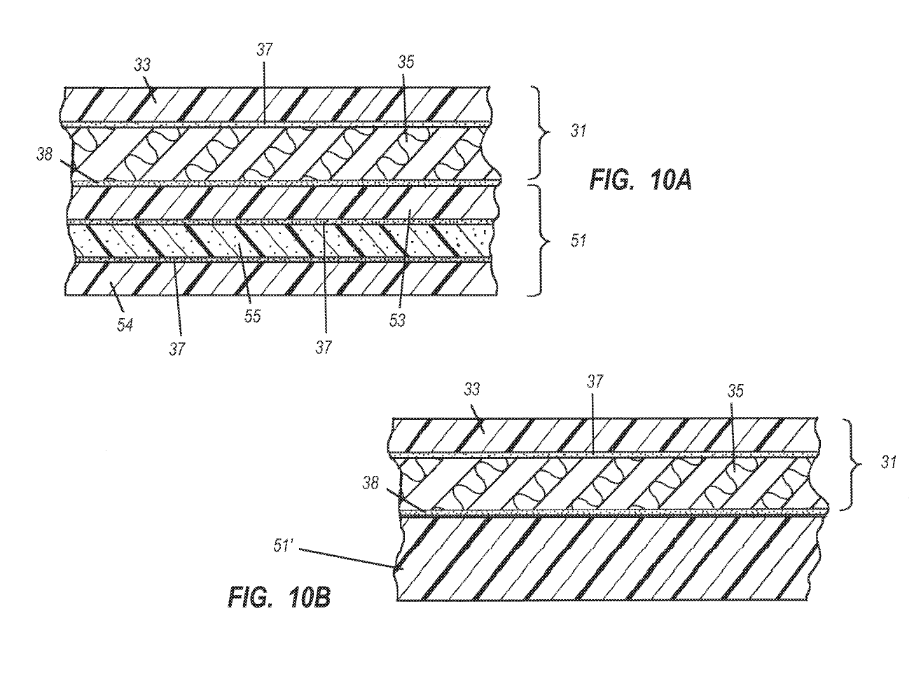

With reference generally to FIGS. 4, 9, 10A, and 10B, in various embodiments, the inner ply 51 is adhered or otherwise joined to the outer ply 31. As shown in FIGS. 4, 7-9, and 10B, in some embodiments, the inner ply 51 comprises multiple layers. As shown in FIG. 10A, in other embodiments, the inner ply 51 comprises a single layer. In either case, the inner ply 51 can be configured to resist or prevent the penetration or absorption of grease, mineral oils, solvents, and acids into or through the walls of bag 15. The inner ply 51 can thus prevent grease within the bag 15 from contacting the paper layer 35.

In some embodiments, the inner ply 51 exhibits a high degree of puncture resistance. This property can also be advantageous depending on the type of product stored in a bag 15. For example, in some embodiments, the packed product can be relatively abrasive such that the inner ply 51 is desirably capable of withstanding the formation of pinholes during transportation and/or use of the bag 15.

In some embodiments, the inner ply 51 comprises a high modulus (e.g., modulus of elasticity) such that the inner ply 51 is able to elastically stretch. When incorporated into the multi-layered material that forms the body portion 21 of a bag 15, such an inner ply 51 can provide the bag 15 with resiliency, which can help to prevent rips, tears, or punctures. As further discussed below, in some embodiments, the resiliency afforded by the inner ply 51 can aid in sealing holes created by a sewing needle during assembly of a bag 15.

With reference to FIG. 10A, in certain embodiments, the inner ply 51 can include a single-layer or mono-layer film, which can be grease resistant or can include one or more grease-resistant components. In some embodiments, the inner ply 51 can comprise a polyolefin film layer or a laminate. For example, in certain embodiments, the inner ply 51 comprises nylon or polypropylene. In some embodiments, the inner ply 51 comprises biaxially oriented polypropylene (BOPP). In other embodiments, the inner ply 51 can comprise a material of which merely a component is nylon (e.g., a suitable polyamide) or polypropylene, and can include other materials capable of resisting grease. Some grease-resistant materials can include, for example, metalized films, ethylene vinyl alcohol, polyester, or specialty resins. In some embodiments, the grease-resistant materials provide resistance to and/or prevention of the penetration or absorption of grease, mineral oils, solvents, and/or acids.

In certain embodiments, the inner ply 51 comprises a single layer of polypropylene film. In various embodiments, the polypropylene inner ply 51 can exhibit relatively high grease-resistance, rigidity, translucence, chemical resistance, toughness, fatigue resistance, integral hinge properties, and/or heat resistance. Various forms of polypropylene are possible, and may be selected based on particular needs and cost considerations. For example, the inner ply 51 can comprise homopolymers, block copolymers, or random copolymers. Homopolymers, in this sense, are a general purpose grade polypropylene. Block copolymers can incorporate 5-15% ethylene and have much improved impact resistance extending to temperatures below −20 degrees C. In some instances, the toughness of block copolymers can be increased by the addition of impact modifiers, such as elastomers, in a blending process. Random copolymers can incorporate co-monomer units arranged randomly (as distinct from discrete blocks) along the polypropylene long chain molecule, typically contain 1-7% ethylene, and can be used where a relatively low melting point, relatively high flexibility, and clarity are desired.

In certain embodiments, the inner ply 51 comprises a single layer of nylon film. A nylon inner ply 51 can have such properties as relatively high wear and abrasion resistance, relatively high strength, and/or a relatively high modulus (e.g., modulus of elasticity).

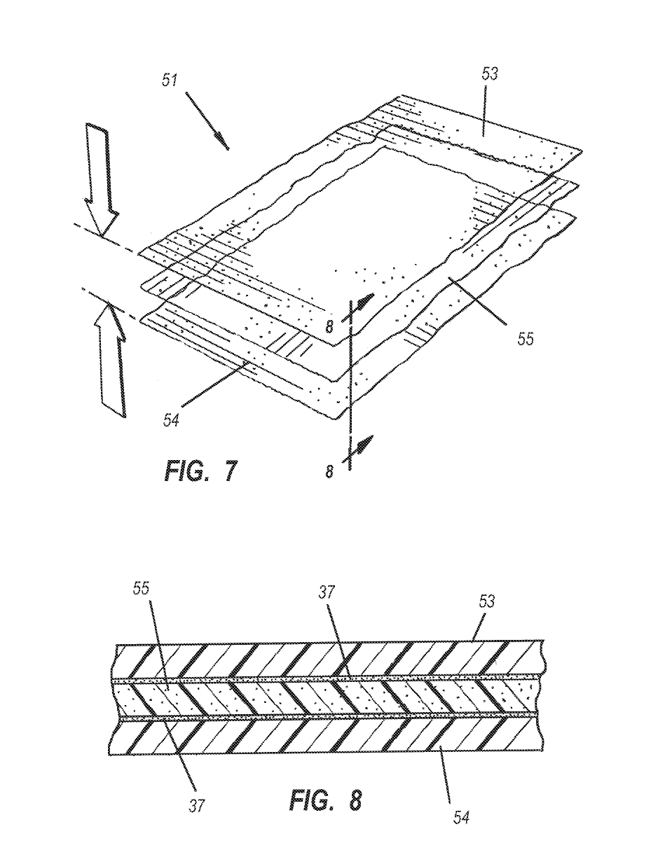

With reference to FIGS. 7-9 and 10B, in certain embodiments, the inner ply 51 includes a multi-layer film or laminate. The inner ply 51 can comprise a core layer 55 positioned between one or more films 53, 54. For example, an inner face of a first film 53 can be abuttingly adhered to an outer face of a core layer 55 and/or an inner face of the core layer 55 can be abuttingly adhered to an outer face of a second film 54. In some embodiments, the core layer 55 and the one or more films 53, 54 are co-extruded such that the inner ply 51 comprises at least three co-extruded layers. Other suitable laminated structures are also possible. For example, in some embodiments, the inner ply 51 comprises four or more co-extruded layers or five or more co-extruded layers. The core layer 55 can be positioned at a center of the inner ply 51 in some embodiments, and in other embodiments, can be at an off-centered position.

One or more of the core layer 55, the films 53, 54, and/or other layers of a ply 51 can comprise any suitable combination of the materials discussed above with respect to the single-layer inner ply 51. In some embodiments, the core layer 55 comprises nylon or polypropylene. In other embodiments, the core layer 55 can comprise a metalized film, ethylene vinyl alcohol, polyester, or a specialty resin. In some embodiments, the core layer 55 is substantially grease-proof, is highly puncture resistant, and/or comprises a high modulus.

In various embodiments, one or more of the films 53, 54 and/or additional co-extruded layers of the inner ply 51 can comprise polyethylene, linear low density polyethylene, or metalicine. Other materials are also possible. In various embodiments, one or more of the films 53, 54 and/or additional co-extruded layers of the inner ply 51 can define a thickness of between about 0.5 mils and about 6.0 mils.

In certain embodiments, one or more of the films 53, 54 can be heat-sealable, which can be advantageous for certain uses of a bag 15 or in certain manufacturing procedures used to construct the bag 15. For example, one or more of the films 53, 54 can be configured to melt and closingly seal at least one of the bag ends 23 and 25 in response to the application of heat. As another example, in some embodiments, an inner film 54 that is heat-sealable can be coupled to a zipper closure, as further discussed below. In certain embodiments, one or more of the films 53, 54 can comprise heat-sealable polyethylene (PE) or oriented polypropylene (OPP). In some embodiments, the core layer 55 can be heat-sealable. Such an arrangement can be advantageous, such as when the inner ply 51 does not include an inner film 54.

In certain embodiments, the inner ply 51 defines a thickness in a range of between about 0.5 mils and about 7.0 mils. In some embodiments, the thickness is in a range of between about 2.0 mils and about 6.0 mils. Other thickness ranges or gauge values are also possible, and can depend on the use of a bag 15 into which the inner ply 51 is incorporated. For example, in some embodiments, relatively large or heavy bags (e.g., bags having a capacity of about 20 kilograms or more) can benefit from a relatively thicker inner ply 51. Similarly, in some embodiments, bags used to store relatively sharp or abrasive products can benefit from a relatively thicker inner ply 51.

Where the inner ply 51 is formed by a laminated material, the first and second films 53, 54 can be adhered to the core layer 55 of the inner ply 51 in any suitable manner, such as those described above with respect to joining layers of the outer ply 31. For example, in some embodiments, the first and second films 53, 54 can be adhered to the core layer 55 via one or more tie layers 37. In certain embodiments, one or more of the tie layers 37 chemically bonds the respective films 53, 54 to the layer 55. For example, in some embodiments, one or more of the tie layers 37 comprises a functionalized polyethylene copolymer. The one or more tie layers 37 can comprise other suitable adhesives.

In some embodiments, relatively inexpensive varieties of paper can be used for the paper layer 35 in conjunction with the inner ply 51. For example, in some embodiments, the inner ply 51 is sufficiently grease resistant to prevent grease from coming into contact with the paper layer 35. As a result, paper that is untreated for grease resistance may be utilized, which can reduce manufacturing costs. For similar reasons, grease-resistant properties of the film 33 of the outer ply 31 can also contribute to cost savings that result from the use of paper that is not treated for grease resistance. In some embodiments, the paper used for the paper layer 35 can be selected based primarily on the stiffness and stability that it provides to the bag 15 without regard to the grease resistant properties of the paper.

With reference to FIGS. 10A and 10B, in some embodiments, the outer ply 31 is joined to an outer face of the inner ply 51. Any suitable method for joining the outer ply 31 and the inner ply 51 is contemplated, including any suitable method described above with respect to joining layers of the outer ply 31. For example, the inner ply 51 and the outer ply 31 can be joined via co-extrusion. In some embodiments, such as those illustrated in FIGS. 8A and 8B, the inner ply 51 and the outer ply 31 are joined via an adhesive 38. Any other suitable lamination technique is also possible.

With reference to FIGS. 11 and 12, in some embodiments, multi-layer material formed in any of the manners described above can be converted into a bag 15. For example, the multi-layer material can comprise an outer ply 31 joined to an inner ply 51, and the outer and inner plies 31, 51 can be formed into a bag 15. In some embodiments, the outer and inner plies 31, 51 can be substantially coextensive with each other, save for a protruding salvage edge. For example, in some embodiments, the outer ply 31 overlaps the inner ply 51 and is defines a surface area that is slightly larger than that of the inner ply 51 such that a portion of the outer ply 31 extends past a peripheral edge of the inner ply 51 to define a salvage edge, as this term is understood in the art. In other embodiments, the inner ply 51 can define a salvage edge. In further embodiments, the inner ply 51 can define a surface area that is larger than that of the outer ply 31, or the inner ply 51 and the outer ply 31 can define surface areas that are substantially the same.

In certain embodiments, the material is cut or otherwise formed such that it has opposing lateral sides 73. In some embodiments, the lateral sides 73 are overlapped and joined to each other to define a tubular body 21. The lateral sides 73 can be joined in any suitable manner. For example, in some embodiments, one lateral side 73 is joined to the other lateral side 73 via an adhesive. In other embodiments, the film 33 of the outer ply 31 and the film 54 of the inner ply 51 can comprise heat-sealable materials such that the lateral sides 73 can be joined via a heat seal. In certain embodiments, a portion of the film 54 overlies a portion of the film 33 to define a seam 75, which can extend along a full longitudinal extent of the tubular body 21.

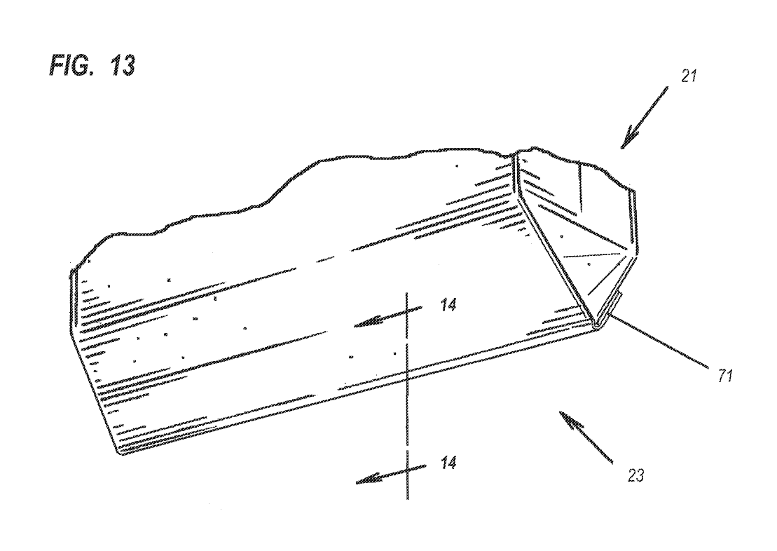

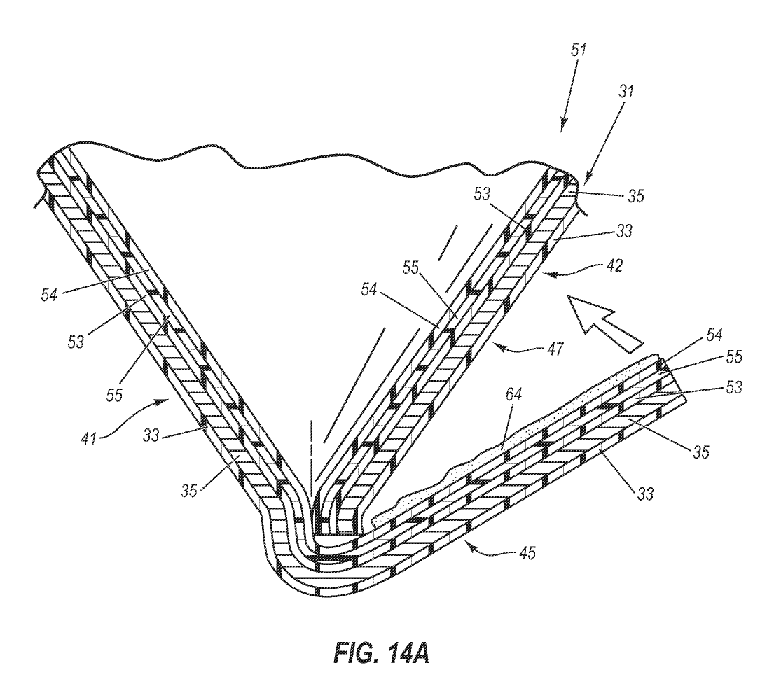

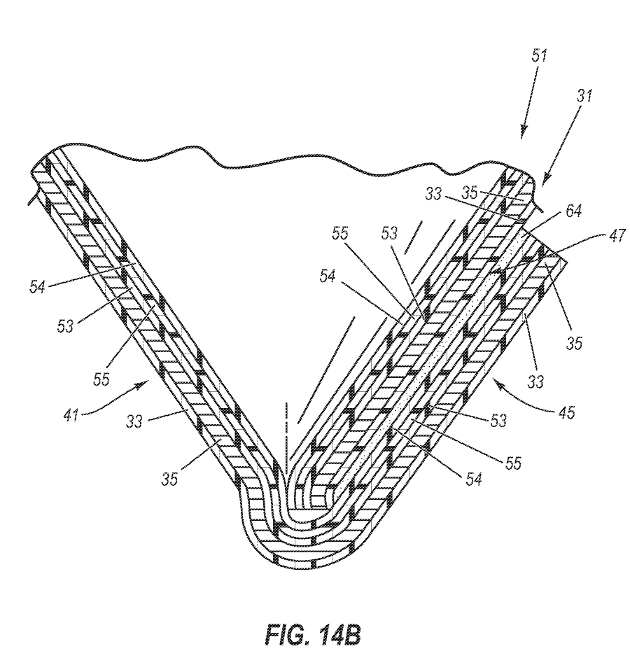

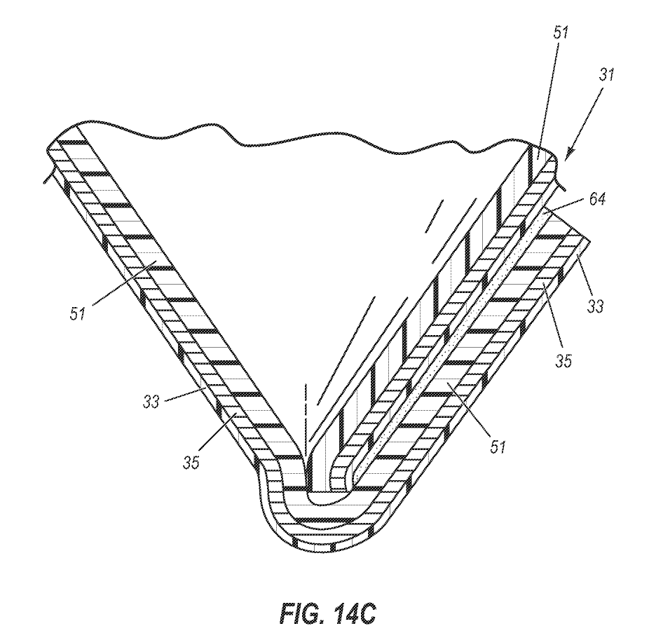

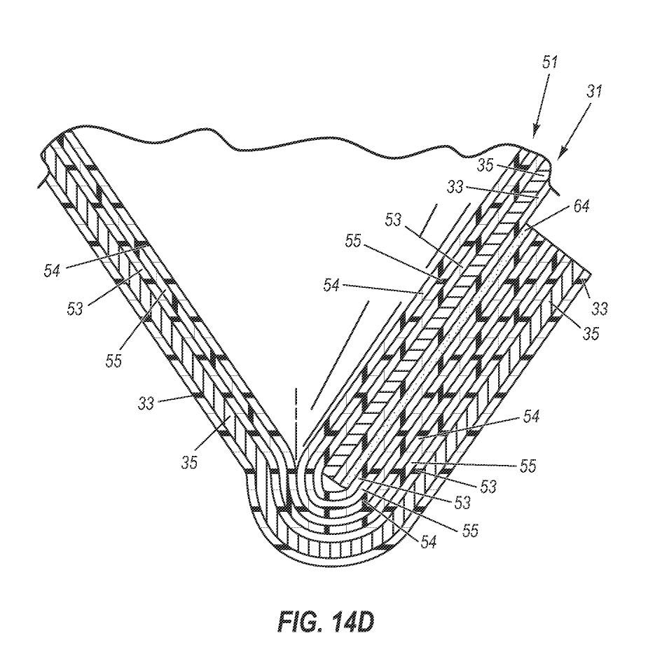

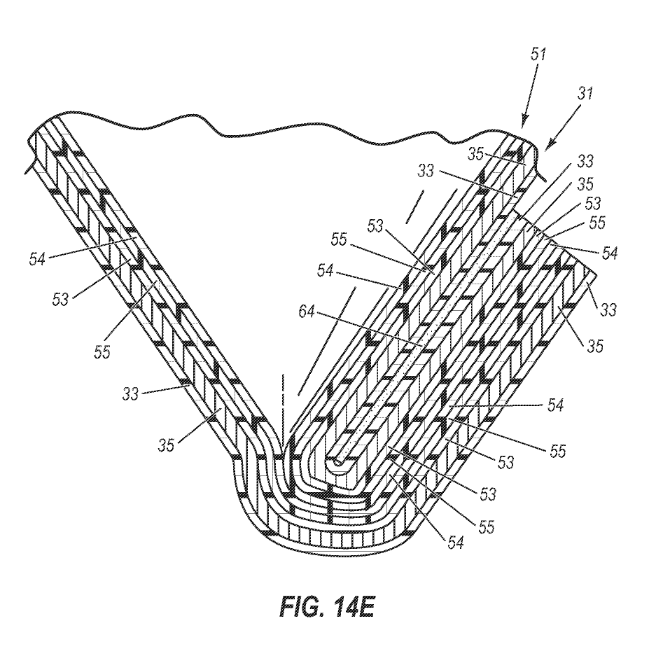

With reference to FIGS. 13-14E, in some embodiments, a portion of at least one of the inner and outer plies 51, 31 of at least one of the opposing bag ends 23, 25 foldingly and adheringly overlies another portion of the one bag end 23 to define an overlapping seam extending along substantially an entire transverse extent of the one bag end 23 to thereby closingly seal the one bag end 23 so that a product, when positioned therein, is retained within inner confines of the bag 15 between the opposing pair of bag ends 23 and 25.

Embodiments can include the inner face of the inner ply 51 of at least one of the opposing bag ends 23 adheringly overlying the outer face of the outer ply 31 of the same bag end 23 to define an overlapping seam substantially extending along a transverse extent of the bag end 23. For example, as shown in FIG. 14A, a flap 45 can extend downwardly from the front wall 41 beyond a bottom edge of the rear wall 42. An inner surface of the flap 45 (e.g., the film 54 of the inner ply 51 of the flap 45) can be adhered to an outer surface of the rear wall 42 (e.g., to the film 33 of the outer ply 31 of the rear wall 42).

Embodiments can also include the outer face of the outer ply 31 of at least one of the opposing bag ends 23 adheringly overlying the same outer face of the same outer ply 51 of the same bag end 23 to define an overlapping seam substantially extending along a transverse extent of the bag end 23. In certain of such embodiments, a heat seal is formed between opposing faces of the inner ply 51.

Additionally, such as shown in FIG. 14A, embodiments of a bag and/or bag closure can include an adhesive 64. In certain embodiments, the adhesive 64 comprises a hot melt adhesive. The adhesive 64 can include components of rosin ester and ethylene vinyl acetate adhering a portion of at least one of the inner and outer plies 51, 31 of at least one of the opposing bag ends 23 to another portion of the same bag end 23 to define an overlapping seam substantially extending along a transverse extent of at least one of the pair of bag ends 23. In some embodiments, the hot melt adhesive 64 can comprise Product No. 70-4467 from NATIONAL STARCH AND CHEMICAL COMPANY of Bridgewater, N.J. In other embodiments, the hot melt adhesive 64 can comprise Product No. 34-3402 or 34-3412 from Henkel Corporation of Henkel Corporation of Rocky Hill, Conn. In further embodiments, the adhesive 64 can include a component selected from the group consisting of styrene-isoprene-styrene copolymers, styrene-butadiene-styrene copolymers, ethylene ethyl acrylate copolymers, polyurethane reactive adhesives, tackifiers, waxes, paraffin, antioxidants, plasticizers, plant sterols, terpene resins, polyterpene resins, turpentines, hydrocarbon resins, resin acids, fatty acids, polymerized rosins, and polyamide adhesives.

Certain embodiments of the bag 15, such as those illustrated for example in FIGS. 14A-14D, can include a tubular bag body having a pair of opposing bag ends 23 and 25 and an inner face of an outer ply 31 abuttingly adhering to an outer face of an inner ply 51. The outer ply 31 can include a grease-resistant film, and the inner ply 51 can include a grease-resistant material. An end portion of at least one of the inner and outer plies 51, 31 of at least one of the opposing bag ends 23 can adheringly overlie another portion of the same bag end 23 with an adhesive 64, such as described above, so that the grease resistant film of the outer ply 31 contacts the adhesive 64 and the grease resistant material of the inner ply 51 contacts the adhesive 64 to thereby define an overlapping seam substantially extending along a transverse extent of the same bag end 23 to thereby closingly seal the bag end 23.

With reference to FIGS. 14A and 14B, in some embodiments, a portion of the bag 15 to which the hot melt adhesive 64 is to be applied, or with which the hot melt adhesive 64 will otherwise come into contact, is preheated. For example, in the illustrated embodiment, an inner face of the flap 45 of the front wall 41 and/or a portion of the rear wall 42 can be preheated. In some embodiments all or substantially all of an inner face of the inner ply 31 of the flap 45 can be preheated. In other or further embodiments a laterally extending strip 47 of an outer face of the outer ply 51 of the rear wall 42 can be preheated. In various embodiments, the laterally extending preheated strip 47 can extend between the sidewalls 43, 44 (see, e.g., FIGS. 1 and 3) so as to cover all or substantially all of the distance between the sidewalls 43, 44, a majority of the distance between the sidewalls 43, 44, or a minority of the distance between the sidewalls 43, 44. In other or further embodiments, the laterally extending preheated strip 47 extends upwardly from a bottom edge of the rear wall 42 by a distance of no less than about 0.5 inches, no less than about 0.75 inches, or no less than about 1.0 inches. In various embodiments, the flap 45 of the front wall 41 and/or the preheated strip 47 of the rear wall 42 are preheated to a temperature within a range of from about 140 degrees Fahrenheit to about 350 degrees Fahrenheit, no less than about 140 degrees Fahrenheit, no less than about 200 degrees Fahrenheit, no less than about 250 degrees Fahrenheit, no less than about 300 degrees Fahrenheit, or about 250 degrees Fahrenheit. In some embodiments, the preheating occurs prior to compression of the portions of the flap 45 of the front wall 41 and of the rear wall 41 that contact the adhesive 64. Preheating can be employed similarly for embodiments such as those shown in FIGS. 14C-14E.

Other embodiments of the bag 15, such as that shown in FIG. 14E, can include a tubular bag body having a pair of opposing bag ends 23 and 25 and an inner face of an outer ply 31 abuttingly adhering to an outer face of an inner ply 51. The outer ply 31 can include a polyester film, and the inner ply 51 can include a polymeric material. An end portion of at least one of the inner and outer plies 51, 31 of at least one of the opposing bag ends 23 can adheringly overlie another portion of the same bag end 23 with an adhesive 64, such as described above, so that the polyester material of the outer ply 31 contacts the adhesive 64 and the polymeric material of the inner ply 51 contacts the adhesive 64 to thereby define a bag closure to thereby define an overlapping seam substantially extending along a transverse extent of the same bag end 23 to thereby closingly seal the bag end 23.

Within the adhesives industry, hot melts, for example, can have good performance and usage benefits, as understood by those skilled in the art. Hot melt adhesives can be solvent-free adhesives that are characteristically solid at temperatures below 180 degrees F., are low viscosity fluids above 180 degrees F., and rapidly set upon cooling. Hot melt adhesives are used in a variety of manufacturing processes. There are a number of hot melt adhesives in use, with the most common being those used for hot melt pressure sensitive adhesive applications. For example, hot melt adhesives can include ethylene vinyl acetate (EVA) copolymers, which can be compatible with paraffin; styrene-isoprene-styrene (SIS) copolymers; styrene-butadiene-styrene (SBS) copolymers; ethylene ethyl acrylate copolymers (EEA); and polyurethane reactive (PUR).

Generally, these polymers may not exhibit the full range of performance characteristics that can be required for certain end products by themselves. For this reason, for example, a variety of tackifying resins, waxes, antioxidants, plasticizers, viscosity reducers, and other materials can be added to the adhesive formulation to enhance the polymer performance.

For example, the PUR adhesive is a 100 percent solid, one-component urethane prepolymer that behaves like a standard hot melt until it reacts with moisture to crosslink or chain extend, forming a new polyurethane polymer. By curing the polymer in this way, PURs have performance characteristics that can be more enhanced than those of standard hot melts. Unlike many of the other hot melts, which can require a slot die or roll coater, PURs can be applied to a substrate as a dot or a thin glue line, can set in seconds, and can be structurally rigid in minutes following a final set. These adhesives have been accepted in many manufacturing industries, for example, where they can be applied in small bond points to eliminate use of mechanical fasteners, such as staples, screws, rivets, clips, snaps, nails or stitching.

Furthermore, for example, certain groups of pine chemicals (with the exception of plant sterols, in many instances), can also be used by the adhesives and sealants industry. Pine chemicals are renewable, naturally occurring materials derived from the pine tree (genus pinus). The range of chemical classes obtained from pine trees includes numerous plant sterols, terpenes (or turpentine), resin acids (or rosin) and fatty acids. Rosin resins, including esters and polymerized rosins, are used as tackifiers to modify the properties of selected polymers to produce adhesives and sealants. Polyterpene resins are used to modify non-polar polymers for these same applications. Tall oil fatty acids can be dimerized to produce dimer fatty acids that, in turn, can be a major ingredient in thermoplastic polyamide adhesives.

For example, three major classes of tackifier resins for the adhesives industry can include terpene, hydrocarbon and rosin resins. Terpene resins (pine-based) and hydrocarbon resins (petrochemical-based) are both hydrocarbons; that is, they contain only carbon and hydrogen. Although they are somewhat similar in that respect, they impart somewhat different properties to the resultant adhesives. Terpene-based resins are more diverse than petrochemical hydrocarbons in that these resins can be readily modified with other chemicals (e.g., phenol) to produce an array of products. Notably, for example, rosin resins significantly differ from the previous two types in that they contain carboxylic acid and/or ester groups. These resins are generally more polar and narrower in molecular weight, for example, making them good tackifiers for a variety of end-use applications.

In some instances, hot-melt packaging adhesives can be developed to run faster than traditional adhesives, in some applications, and can perform on a range of substrates. Terpene phenolic resins, derivatives of alpha-pinene, can deliver enhanced adhesion qualities to difficult substrates such as recycled cardboard. They can offer better green strength, making them useful for high-speed packaging lines with short set times. Rosin esters are commonly used to increase adhesion and the temperature performance range of ethylene vinyl acetate (EVA) based adhesives. This combination of elements in a hot melt adhesive can be used as a closure (e.g., end, sides, or other overlap region) for a bag in applications, for example, of a polyester or grease-resistant material facing another polymeric or grease resistant material. Rosin esters can be compatible with a range of polymers, thus limiting formulating complexity.

Ethylene vinyl acetate (EVA), for example, can be produced by the random copolymerization of ethylene and vinyl acetate in predetermined ratio. The presence of VA reduces the crystallinity as the large acetoxy group distorts the chain structure. The stiffness of EVA varies with VA content. However, beyond about 60 percent VA, the stiffness rises sharply as pure vinyl acetate is a glass-like substance at room temperature. The practical limit for certain “mechanical” uses of EVA is about 20 percent VA content; however, for certain “adhesive” uses, higher levels of VA can be employed. High VA level copolymers are typically used in adhesive applications, while lower vinyl acetate containing copolymers, which can have greater tensile moduli and surface hardness, find greatest use in films, profile extrusions and injection molding. The higher percent VA resins have a good compatibility with other materials. Thus, EVA is widely used in blends and compounds. One main application, for example, is hot melt adhesives, where the EVA is blended with tackifier and paraffin wax.

As understood by those skilled in the art, the polarity of the VA molecule makes the copolymers receptive to high filler loadings and to combination with tackifiers and other adhesive components. The addition of the rosin ester to EVA can produce a compatible mixture. The increase in the VA amount decreases the crystallinity of EVA and the elastic and viscous modules, but increases the peel strength and the tack. The tackifier improves the adhesion and increases the “open time” of the formulation.

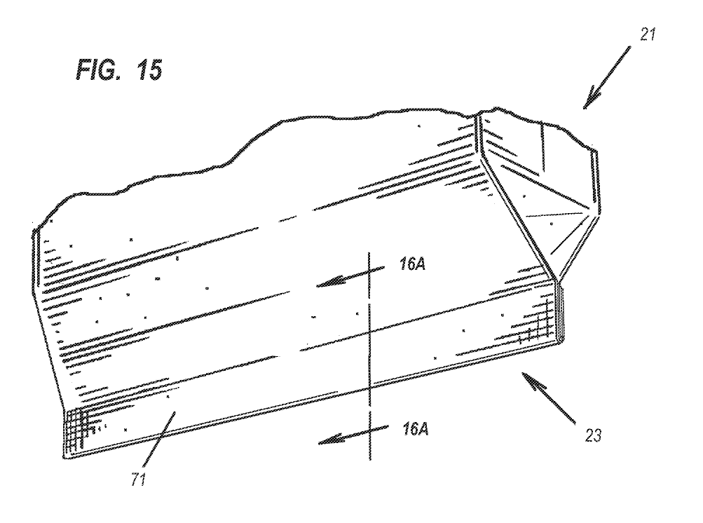

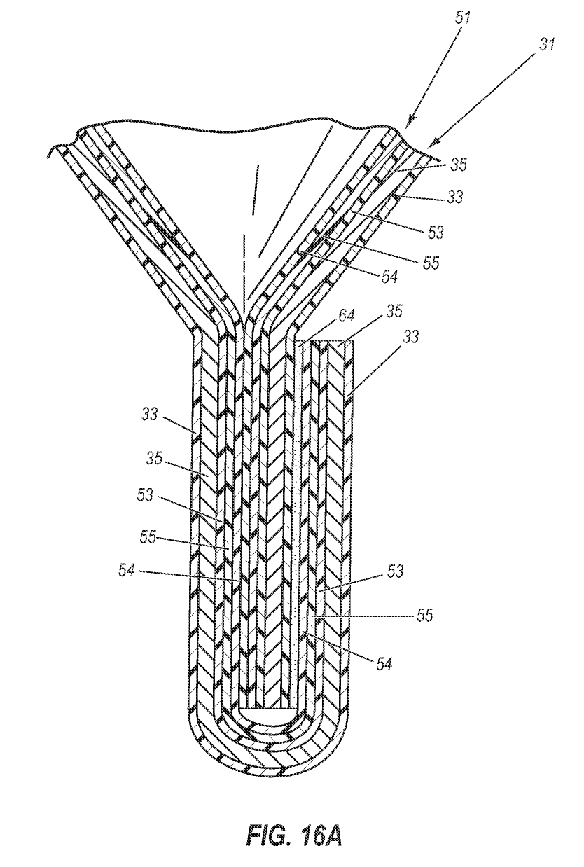

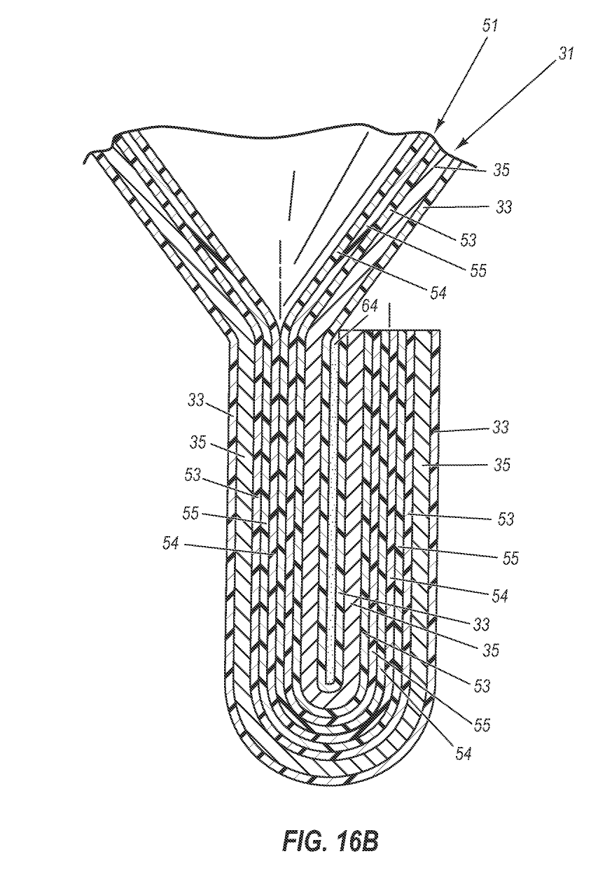

In a further embodiment in which one or more bag ends or other bag closures are heat-sealed, a bag end 23 is adapted to be positioned so that opposingly facing first and second portions of the inner ply 51 are compressed between opposingly facing first and second portions of the outer ply 31 to define a compressed lip 71, as shown in FIGS. 15-16B. The compressed lip 71, for example, can have a first portion of the second heat-sealable film 54 of the inner ply 51 meltingly bonded with an opposingly facing second portion of the second heat-sealable film 54 of the inner ply 51 along a transverse extent of at least one of the pair of bag ends 23 and 25 responsive to heat applied thereto. Application of the heat to the bag end 23 thereby closingly seals the bag end 23 so that a food element 17, when positioned therein, is retained within inner confines of the bag 15 defined by other unsealed portions of the second heat-sealable film 54 positioned between the opposing bag ends 23 and 25. FIG. 3 shows an embodiment of a bag where the food element 17 is positioned inside the bag, illustrating the grease component G being prevented from penetrating the inner and outer plies 51, 31 of the food bag 15.

Each of the materials used to construct the bag 15 can have a different range of melting temperatures. For example, in some embodiments, a polyester film 33 of the outer ply 31 has a melting point temperature greater than a heat-sealable film 54 of the inner ply 51. In one embodiment, the polyester film 33 of the outer ply 31 has a melting temperature in the range of about 300 degrees Fahrenheit to about 475 degrees Fahrenheit, and preferably greater than 425 degrees Fahrenheit. In one embodiment, the heat-sealable film 54 of the inner ply 51 has a melting point temperature in the range of about 220 degrees Fahrenheit to about 300 degrees Fahrenheit, and preferably greater than 240 degrees Fahrenheit. As understood by those skilled in the art, the polyethylene heat-sealable film 54 of the inner ply 51 has a lower melting temperature and therefore melts easier and at lower temperatures than the grease-resistant polyester film 33 of the outer ply 31. A sufficiently low melting point temperature for the heat-sealable film 54 of the inner ply 51 allows for the melting and bonding of the second heat-sealable film 54 to closingly seal the bag end 23 and 25.

For example, as understood by those skilled in the art, heat-sealing bag machine performs the function of forming and shaping the multi-layered structure into a bag 15 by accordingly compressing and melting the bag ends 23 and 25 to closingly seal the bag ends 23 and 25. The heat-sealing bag machine has an extended heater belt and/or heated jaws that carry out the heat-sealing procedure. The heat can alternatively be applied, for example, by heated rollers, heated wire/wires, or a heated air zone that adequately melts the heat-sealable film 54, as understood by those skilled in the art. The extended heater belt and/or heated jaws can mass-produce the heat-sealed products through a continuous high-speed operation, which manufactures a quality product in massive quantities to be delivered to customers. In some applications, for example, the bag manufacturer typically heat-seals one end of each bag and delivers the bag to a customer, and the customer fills the bag with the proper elements and ultimately heat-seals the other end of the bag. The heat-sealing process can form bags with a lip as herein described, or can alternatively form bags that have a flattened top end and flattened bottom end to thereby provide the capability of stacking multiple bags neatly on top of one another.

To describe heat-sealing processes for certain embodiments more specifically, the polyethylene portion of the heat-sealable film 54 of the inner ply 51 at the bag ends 23 and 25 can be heated to a melting point temperature of at least 220 degrees Fahrenheit to melt the heat-sealable polyethylene film of the bag ends 23 and 25. Alternatively, the temperature could be raised in excess of 300 degrees Fahrenheit, in one embodiment for example, to melt not only portions of the polyethylene heat-sealable films 54 together but also to melt portions of the polyester films 33 together as well, thus forming an even tighter closed seal at the bag ends 23 and 25. In one embodiment, for example, the manufacturer utilizing the heat-sealing bag machine will seal only one end 23 and 25 portion of the bag 15, thereby leaving another end 23 and 25 portion of the bag 15 open to eventually fill the bag 15 with food or other elements 19. The distributor of the goods, for example, then fills the bag 15 with the food or other elements 19, and thereafter seals the other end 23 and 25 portion of the bag 15 after the bag 15 is full.

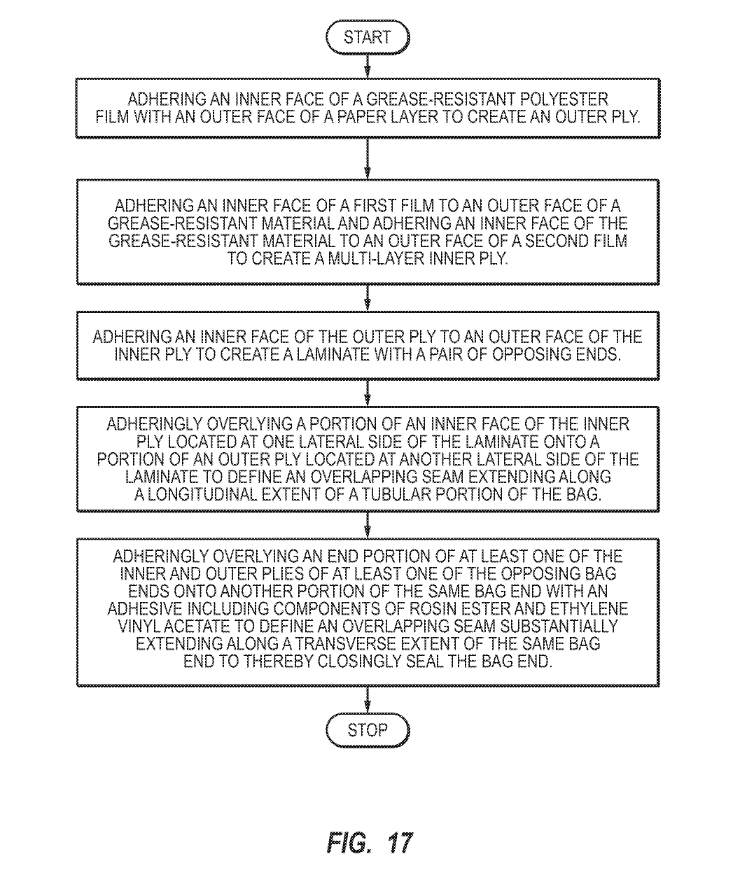

FIG. 17 illustrates a schematic diagram of an embodiment of a method for constructing a composite bag, as disclosed herein. Other embodiments of methods of assembling, positioning, using, and constructing a multi-layered bag 15 are also disclosed herein. The following discussion includes specific references to certain of such embodiments. The discussion is for illustrative purposes only, and should not be construed as limiting. Moreover, any suitable combination of the following disclosure with any portion of the foregoing disclosure is contemplated.

In certain embodiments, before any of the layers of a tube-forming material are bonded or adhered together, the method of constructing a bag 15 can include printing printed indicia 29 on the inner face of the grease-resistant film 33 of the outer ply 31 to enhance visual appearance of the bag 15. Also, before adhering the layers of film, the method can include clay-coating and bleaching the paper layer 35, and treating the paper layer 35 with a chemical to provide enhanced protection from grease penetrating through the paper layer 35 of the bag 15.

In certain embodiments, a method of constructing a bag 15 can include adhering an inner face of a grease-resistant polyester film 33 with an outer face of a paper layer 35 to create an outer ply 31. The method can also include adhering an inner face of a first film 53 to an outer face of a grease-resistant material 55 and adhering an inner face of the grease-resistant material 55 to an outer face of a second film 54 to create a multi-layer inner ply 51. The method can also include adhering an inner face of the outer ply 31 to an outer face of the inner ply 51 to create a laminate with a pair of opposing ends 23 and 25. The method can also include overlying a portion of an inner face of the inner ply 51 located at one lateral side of the laminate onto a portion of an outer face of the outer ply 31 located at another lateral side of the laminate to define an overlapping seam extending along a longitudinal extent of a tubular portion of the bag. The method can also include adheringly overlying an end portion of at least one of the inner and outer plies 51, 31 of at least one of the opposing bag ends 23 onto another portion of the same bag end 23 with an adhesive 64 including components of rosin ester and ethylene vinyl acetate to define an overlapping seam substantially extending along a transverse extent of the same bag end 23 to thereby closingly seal the bag end 23.

In some embodiments, an inner face of the inner ply 51 of at least one of the opposing bag ends 23 is adhered to an outer face of the outer ply 31 of the same bag end 23 to define an overlapping seam substantially extending along a transverse extent of the bag end 23. The method can further include closingly sealing the overlapping seam responsive to the adhering to thereby prevent grease from penetrating from within the bag 15 to outside the bag 15 and prevent grease from penetrating from outside the bag 15 to within the bag 15.

The method can also include adhering an outer face of the outer ply 31 of at least one of the opposing bag ends 23 against the same outer face of the same outer ply 31 of the same bag end 23 to define an overlapping seam substantially extending along a transverse extent of the bag end 23. The method can further include closingly sealing the overlapping seam responsive to the adhering to thereby prevent grease from penetrating from within the bag 15 to outside the bag 15 and prevent grease from penetrating from outside the bag 15 to within the bag 15.

Certain embodiments of bags and methods herein disclosed can have important benefits and advantages. The combined use of polymeric structures and paper, for example, can combine the advantages of the thickness and bending stiffness of paper with the puncture-resistant and grease-resistant properties of polyester, including in some embodiments the heat-sealable characteristics of films such as polyethylene. Furthermore, the grease-resistant properties of the inner ply 51 can offer enhanced grease-resistance in addition to the grease-resistance properties of the outer ply 31. Embodiments of a bag can provide increased barrier protections from grease, endurance, strength, physical integrity, and heat-sealable characteristics not offered with other bags. The bag 15 can prevent problems customarily associated with greasy products such as pet food, for example, and eliminate the absorption and penetrable effect of the grease component included in such foods as pet food. Various bags 15 are often used in other settings where greasy elements are contained within the bags 15, and embodiments of the bag contribute to solving such problematic concerns attributable to the grease. Other applications of the bag 15 may include dry foods, beverages, feed, soil, lawn and garden, building materials, and other markets to prevent grease from penetrating from outside the bag 15 to within the bag 15 and to prevent grease from penetrating from within the bag 15 to outside the bag 15. Furthermore, certain embodiments can offer enhanced strength to allow the bag to carry over twenty-five pounds of pet food with relative ease.

In some embodiments, materials used in constructing a bag can be environmentally friendly, in that the resulting bag is less toxic and increasingly biodegradable. Further, in some embodiments, a bag 15 can be manufactured on existing equipment, such that investment in new and expensive bag manufacturing equipment is unnecessary.

As discussed above, a variety of bag styles are possible. For example, in various embodiments, the bag 15 can comprise a gusseted pinch-bottom bag configuration, a non-gusseted pinch-bottom bag configuration, other various pinch-bottom bag configurations, and various block-bottom configurations. As previously discussed, the bag-end closures can be substantially grease-resistant or grease-proof so as to substantially prevent grease from exiting the bag via the closed ends.

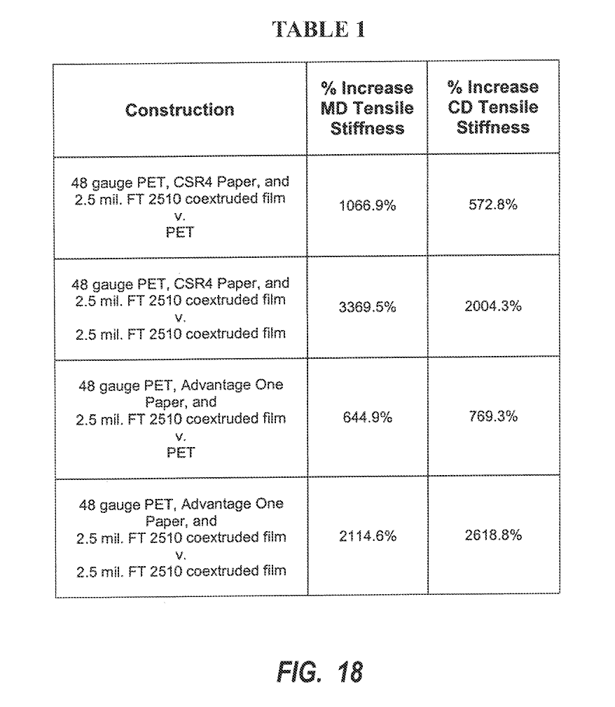

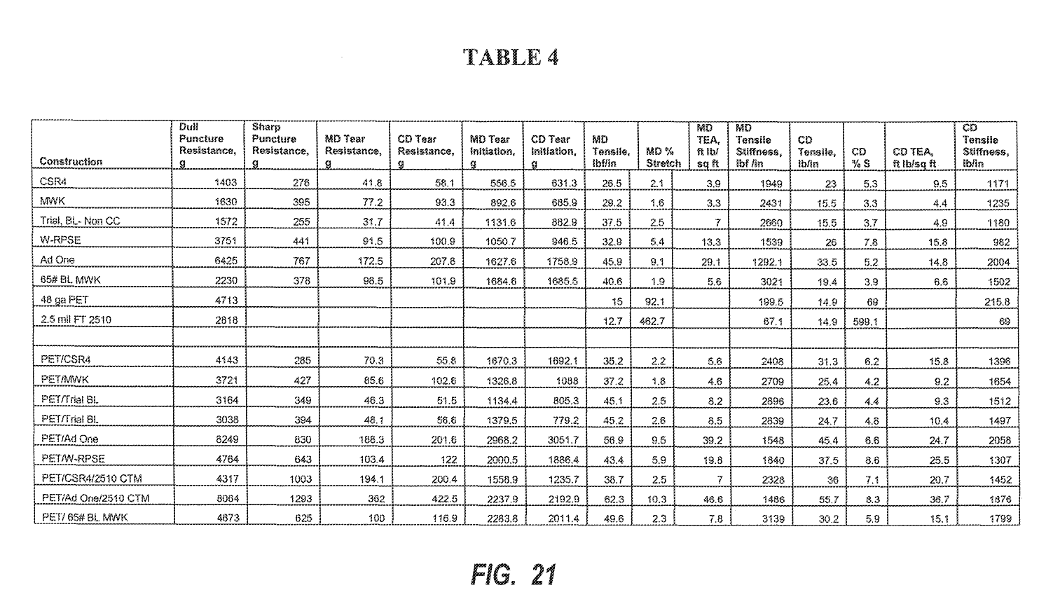

FIGS. 18-20, which contain Tables 1-3, illustrate comparisons of different illustrative examples of an outer ply 31 and inner ply 51 construction, as compared with other materials, in such categories as stiffness, puncture resistance, tear resistance, and tear initiation. FIG. 21, which contains Table 4, illustrates raw data utilized in the calculations of tables 1-3 of FIGS. 18-20. The data from Table 4 of FIG. 21 includes properties of various materials and multi-layer combinations of materials. The raw data of Table 4 of FIG. 21 illustrate advantages that are possible with multi-layer combinations.

Many different grades and gauges for the PET, paper, and film are possible. FIGS. 18-21 illustrate certain advantages that can result from non-limiting examples of body materials having a multi-layer structure, which include, for example, enhanced stiffness, puncture resistance, tear resistance, and/or tear initiation.

Abbreviations are used in Tables 1-4. In particular, CSR4 (i.e., tradename CSR4) represents a type of fluorocarbon treated, clay coated, bleached sheet of paper; MWK represents a type of multi-wall Kraft (MWK) brown paper; Trial BL Non-CC represents type of fluorocarbon treated, bleached (BL) sheet of paper that is non-clay-coated (Non-CC); W-RPSE represents a type of Royal Performance semi-extensible (RPSE) white paper; Ad One (i.e., Advantage One) represents a type of substrate of a heavy extensible sheet of paper; 65# BL-MWK represents a bleached (BL) multi-wall Kraft (MWK) sheet of paper having a basis weight of 65 lbs; 48 gauge PET represents a PET layer of 48 gauge; and 2.5 mil. FT 2510 coextruded film represents a nylon coextruded core film having a 2.5 mil. gauge and a 2510 grade specification. Furthermore, in Tables 1-4 in FIGS. 18-21, references to paper correspond to the paper layer 35 of the outer ply 31, references to PET correspond to the outer layer 33 of the outer ply 31, and references to FT 2510 coextruded film correspond to the multi-layer or mono-layer formation of the inner ply 51.

FIG. 18 illustrates the percent increase in machine-direction tensile stiffness and cross-direction tensile stiffness, as these measurements are understood by those skilled in the art, for the following illustrative comparisons: 48 gauge PET, CSR4 paper, and 2.5 mil. FT 2510 coextruded film v. PET; 48 gauge PET, CSR4 paper, and 2.5 mil. FT 2510 coextruded film v. 2.5 mil. FT 2510 coextruded film; 48 gauge PET, Advantage One paper, and 2.5 mil. FT 2510 coextruded film v. PET; and 48 gauge PET, Advantage One paper, and 2.5 mil. FT 2510 coextruded film v. 2.5 mil. FT 2510 coextruded film.

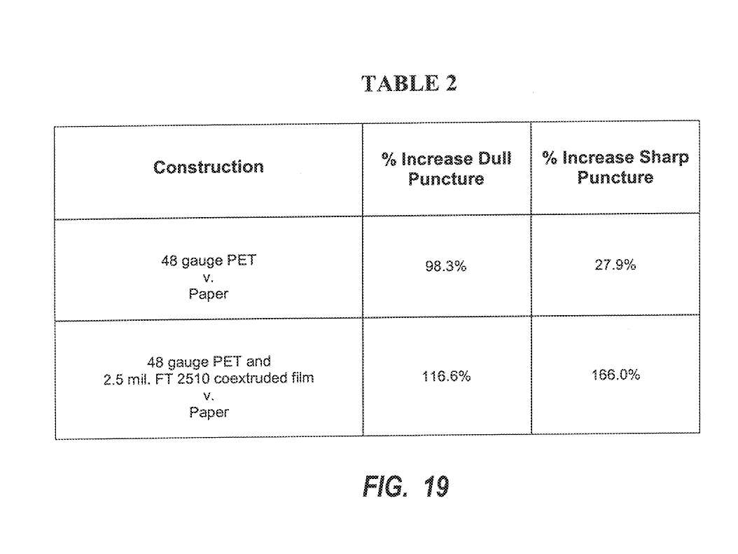

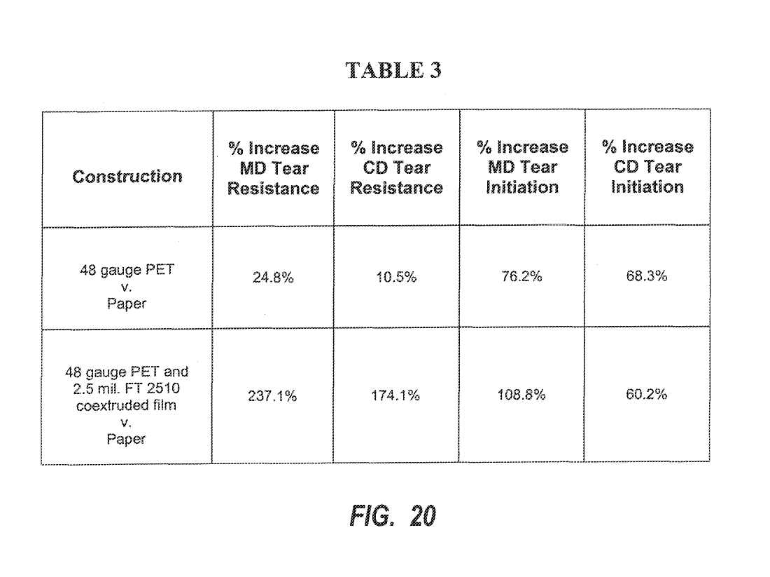

FIG. 19 illustrates the percent increase in dull-puncture and sharp-puncture, as these measurements are understood by those skilled in the art. FIG. 20 illustrates the percent increase in machine-direction tear resistance and cross-direction tear resistance, as these measurements are understood by those skilled in the art. FIG. 20 also shows the percent increase in machine-direction tear initiation and cross-direction tear initiation, as these measurements are understood by those skilled in the art. Each of the tables in FIGS. 18-20 illustrates data relating to the following illustrative comparisons: 48 gauge PET v. paper; and 48 gauge PET and 2.5 mil. FT 2510 coextruded film v. paper.

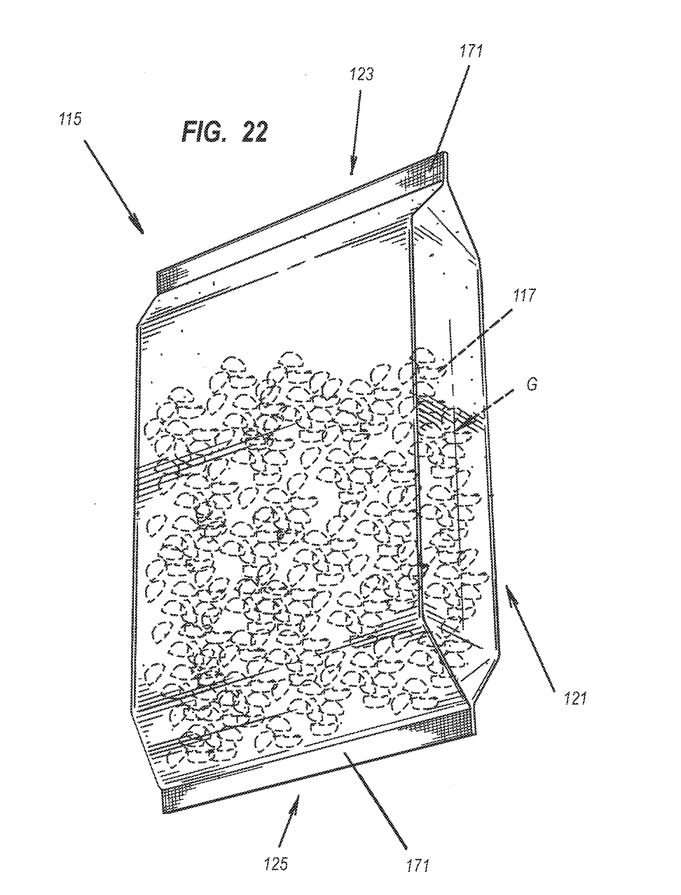

FIG. 22 illustrates a perspective view of another embodiment of a bag 115. The bag 115 can resemble the bag 15 in many respects, thus like features are identified with like reference numerals, incremented by 100. Any suitable feature of the various embodiments of bag 15 can be incorporated into or otherwise used with the bag 115, and any suitable feature of the various embodiments of the bag 115 can be incorporated into or otherwise used with the bag 15. Further, the bag 115 may be assembled and/or used according to any suitable method, such as any suitable method discussed above with respect to the bag 15.

The bag 115 can include a body portion 121, which can be substantially tubular in form. The body portion 121 may comprise a top end 123 and a bottom end 125. As further discussed below, the material from which the body portion 121 is formed can comprise multiple layers, each of which can provide or aid in providing desirable functional characteristics to the bag 115. In certain embodiments, the bag 115 can have contents disposed therein, such as a product 117. In some embodiments, the product 117 includes a grease component G. Once the product 117 is within the bag 115, the top end 123 of the bag 115 can be closed in any suitable fashion. For example, in the depicted embodiment, each of the top end 123 and the bottom end 125 is heat sealed at or along a compressed lip 171.

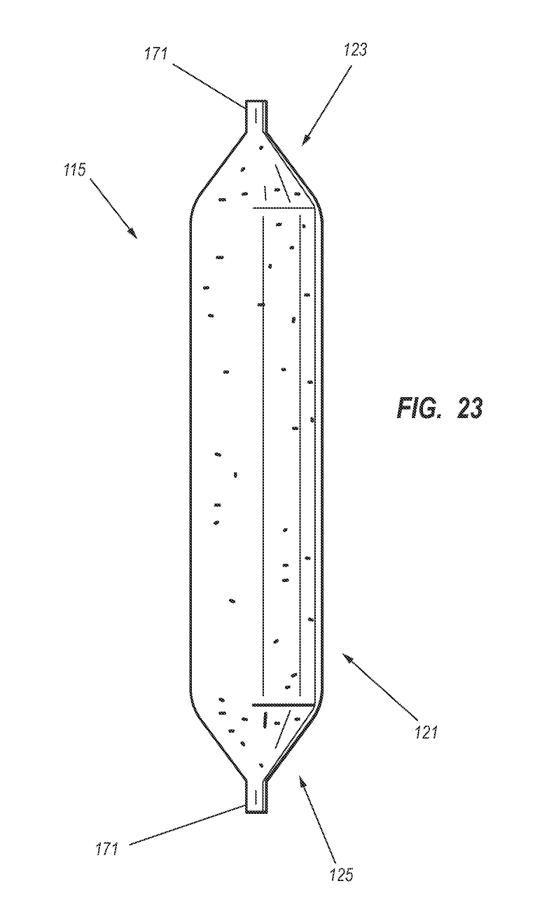

FIG. 23 illustrates a side elevation view of the composite bag 115 of FIG. 21. The tubular structure of body portion 121 may be more readily appreciated in the depiction of FIG. 23. The top end 123 is closed via an upper compressed lip 171, and the bottom end 125 is closed via a lower compressed lip 171. As described herein, the top and bottom ends 123 and 125 may be closed via a variety of techniques, which may employ adhesives, heat-seal films, stitches, or a combination of the preceding. For example, in some embodiments, the bag ends 123, 125 are not necessarily compressed in order to form a closure.

The body portion 121 may be similar to body portion 21 described above. For example, various embodiments of the body portion 121 may comprise a structure that is substantially the same as that of any suitable embodiment of the body portion 21. For example, body portion 121 may comprise a composite material that includes an outer ply 131 joined to an inner ply 151 (see FIG. 26). The outer and inner plies 131, 151 can be substantially the same as one or more embodiments of the outer and inner plies 31, 51 described above.

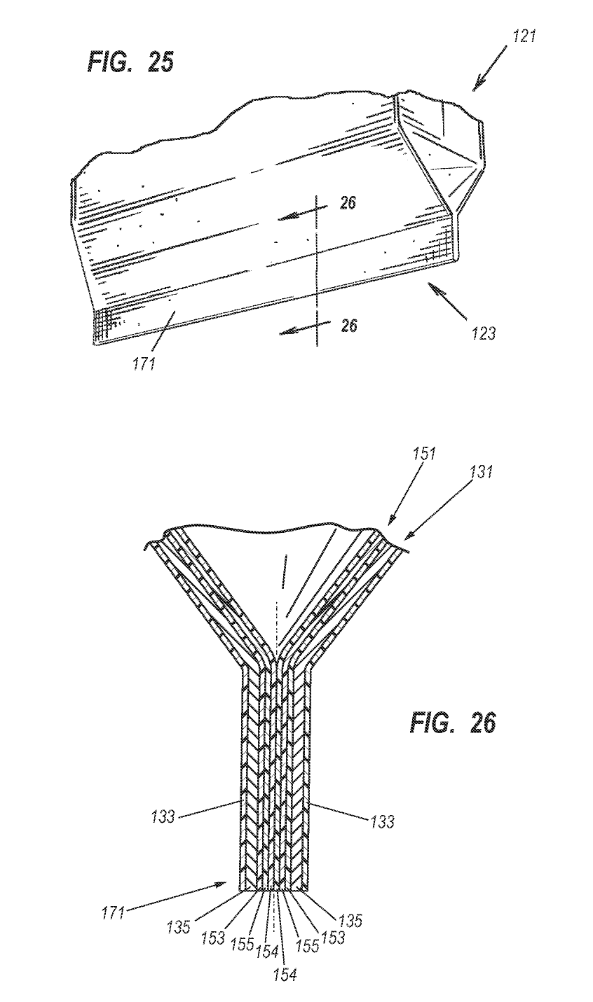

In the embodiments of bag 115 depicted in FIGS. 22-28, the inner ply 131 comprises one or more layers of heat-sealable film 153, 154, which can resemble embodiments of the heat-sealable films 53, 54 described above. As described below, heat-sealable layers may be employed to close and seal one or more of the ends 123, 125 of bag 115.

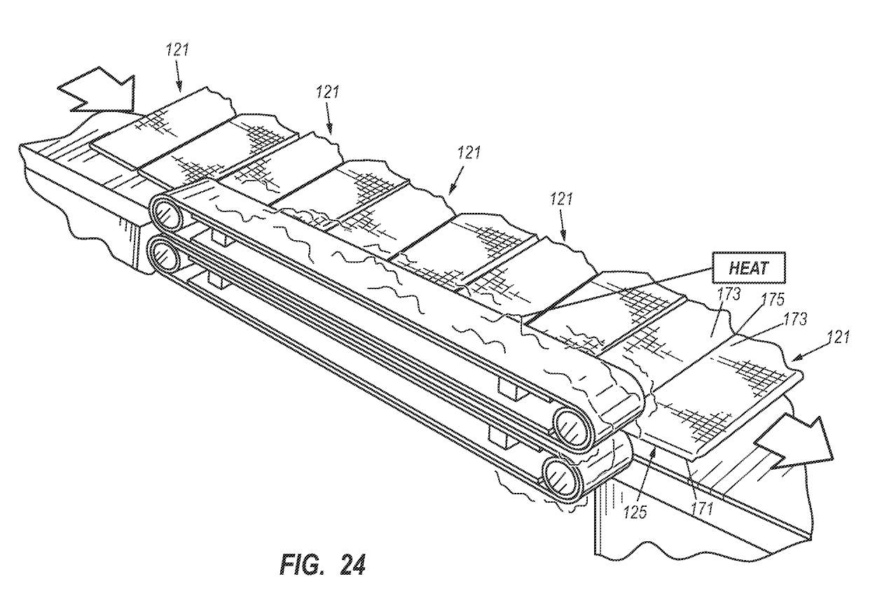

As shown in FIGS. 24-26, each of the pair of bag ends 123 and 125 is configured to be positioned so that opposingly facing first and second portions of the inner ply 151 are compressed between opposingly facing first and second portions of the outer ply 131 to define a compressed lip 171. The compressed lip 171, for example, can have a first portion of the second heat-sealable film 154 of the inner ply 151 meltingly bonded with an opposingly facing second portion of the second heat-sealable film 154 of the inner ply 151 along a transverse extent of at least one of the pair of bag ends 123 and 125 responsive to heat applied thereto. Application of the heat to the bag end 123 and 125 thereby seals at least one of the pair of bag ends 123 and 125 so that a product, when positioned therein, is retained within inner confines of the bag 115, which may be defined by unsealed portions of the second heat-sealable film 154 that extend between the opposing bag ends 123 and 125.

Each of the materials used to construct the bag 115 can have a different range of melting temperatures. The polyester film 133 of the outer ply 131, for example, may have a melting point temperature greater than the heat-sealable film 154 of the inner ply 151. In one embodiment, the polyester film 133 of the outer ply 131 has a melting temperature in the range of about 300 degrees Fahrenheit to about 475 degrees Fahrenheit, and preferably greater than 425 degrees Fahrenheit. In one embodiment, the heat-sealable film 154 of the inner ply 151 has a melting point temperature in the range of about 220 degrees Fahrenheit to about 300 degrees Fahrenheit, and preferably greater than 240 degrees Fahrenheit. As understood by those skilled in the art, the polyethylene heat-sealable film 154 of the inner ply 151 has a lower melting temperature and therefore melts easier and at lower temperatures than the grease-resistant polyester film 133 of the outer ply 131. A sufficiently low melting point temperature for the heat-sealable film 154 of the inner ply 151 allows for the melting and bonding of the heat-sealable film 154 to close and seal the bag ends 123 and 125.

In certain embodiments, a heat-sealing bag machine performs the function of forming and shaping the multi-layered structure into a bag 115 by compressing and melting the bag ends 123 and 125 so as to closingly seal the bag ends. The heat-sealing bag machine can include an extended heater belt and/or heated jaws that carry out the heat-sealing procedure. The heat can alternatively be applied, for example, by heated rollers, heated wire/wires, or a heated air zone that adequately melts the heat-sealable film 153. The extended heater belt and/or heated jaws can mass-produce the heat-sealed products through a continuous high-speed operation, which manufactures a quality product in massive quantities to be delivered to customers in the ordinary course of business, as shown for example in FIG. 24. The bag manufacturer can heat-seal one end of each bag and deliver the bags to an intermediate customer, and the customer fills the bag with the desired elements and ultimately heat-seals the other end of the bag. The heat-sealing process can form bags with a lip as herein described, or can alternatively form bags that have a flattened top end and flattened bottom end to thereby provide the capability of stacking multiple bags neatly on top of one another.

To describe embodiments of the heat-sealing process more specifically, for example, the polyethylene portion of an embodiment of the heat-sealable film 154 of the inner ply 151 at the bag ends 123 and 125 can be heated to a melting point temperature of at least 220 degrees Fahrenheit, in one embodiment for example, to melt the heat-sealable polyethylene film of the bag ends 123 and 125. Alternatively, the temperature could be raised in excess of 300 degrees Fahrenheit to melt not only portions of the polyethylene heat-sealable films 154 together but also to melt portions of the polyester films 133 together, which may produce an even tighter closed seal at the bag ends 123 and 125.

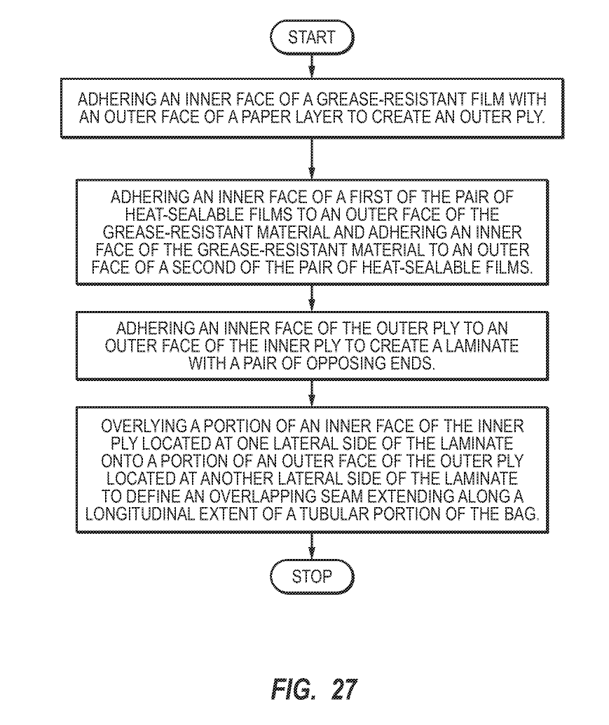

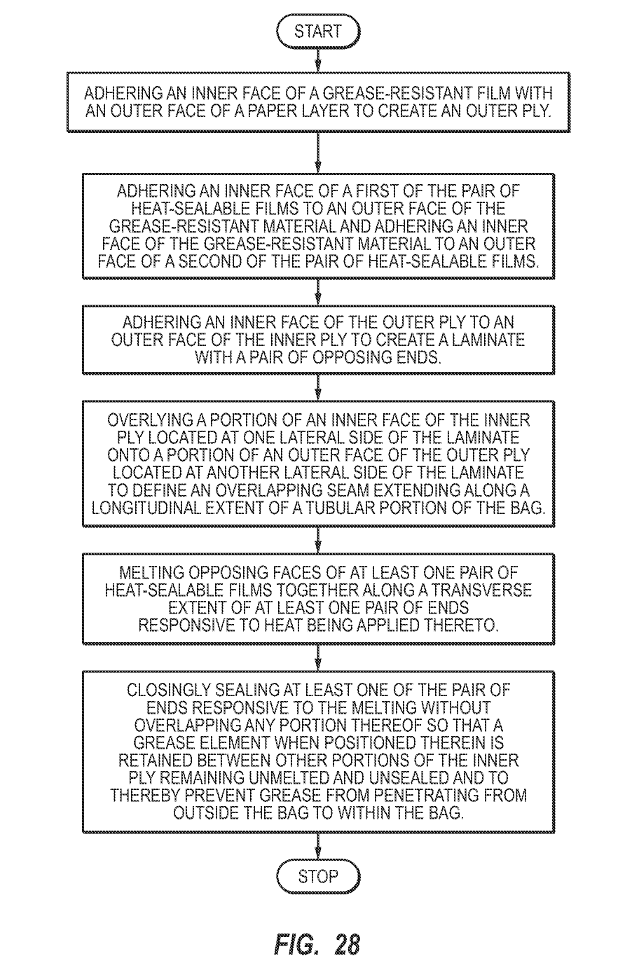

As illustrated in FIGS. 22-28, and especially FIGS. 27 and 28, the present disclosure also includes embodiments of methods of assembling, positioning, using, and constructing a multi-layered bag 115. For example, in some embodiments, before any of the layers are bonded or adhered together, a method of constructing a bag 115 can include printing printed indicia on the inner face of the grease-resistant film 133 of the outer ply 131 to enhance visual appearance of the bag 115. Also, before adhering the layers of film, the method can include clay-coating and bleaching the paper layer 135. In some embodiments, the method can include treating the paper layer 135 with a chemical to provide enhanced protection from grease penetrating through the paper layer 135, while in other embodiments, the paper layer 135 is untreated.

In certain embodiments, a method can include adhering an inner face of a grease-resistant film 133 with an outer face of a paper layer 135 to create an outer ply 131. The method can include applying a tie layer 37 (see, e.g., FIG. 4) between the inner face of the grease-resistant film 133 of the outer ply 131 and the outer face of the paper layer 135 to attach the grease resistant-film to the paper layer 135. The method can also include adhering a grease-resistant material 155 between a pair of heat-sealable films 153, 154 to create a multi-layer inner ply 151 by adhering an inner face of a first of the pair of heat-sealable films 153, 154 to an outer face of the grease-resistant material 55 and adhering an inner face of the grease-resistant material 155 to an outer face of a second of the pair of heat-sealable films 153, 154, and applying tie layers (e.g., of solvent-based petroleum distillate) between the grease-resistant material 155 of the inner ply 151 and the pair of heat-sealable films 153, 154 to adhere the grease-resistant film 133 between the pair of heat-sealable films 153, 154.

Other embodiments of the methods disclosed herein include adhering an inner face of the outer ply 131 to an outer face of the inner ply 151 to create a laminate with a pair of opposing ends 123 and 125. Also, for example, the method can include providing a coating 127 to the outer face of the grease-resistant film 133 of the outer ply 131, which can provide enhanced protection from grease penetrating from outside the bag 115 to within the bag 115. The method can further include cutting each of the pair of opposing ends 123 and 125 so that the outer ply 131 has a substantially similar longitudinal length from one bag end 123, 125 to the other bag end 123, 125 along a circumferential periphery of each of the pair of opposing bag ends 123, 125 and the inner ply 151 has a substantially similar longitudinal length from one bag end 123, 125 to the other bag end 123, 125 along the circumferential periphery of each of the pair of opposing bag ends 123, 125, and overlying a portion of an inner face of the inner ply 151 located at one lateral side 173 of the laminate onto a portion of an outer face of the outer ply 131 located at another lateral side 173 of the laminate to define an overlapping seam 175 extending along a longitudinal extent of a tubular portion of the bag 115.

Embodiments of the methods disclosed herein can further include melting opposing faces of at least one of the pair of heat-sealable films 153, 154 together along a transverse extent of at least one of the pair of ends 123, 125 responsive to heat being applied thereto, and compressing opposingly facing first and second portions of the inner ply 151 between opposingly facing first and second portions of the outer ply 131 at a location of at least one of the pair of ends 123, 125 along a transverse extent to thereby define a compressed lip 171, and closingly sealing at least one of the pair of ends 123, 125 responsive to the melting without overlapping any portion thereof so that a grease element 117, when positioned therein is, retained between other portions of the inner ply 151 remaining unmelted and unsealed, which can prevent grease from penetrating from within the bag 115 to outside the bag 115 and prevent grease from penetrating from outside the bag 115 to within the bag 115.

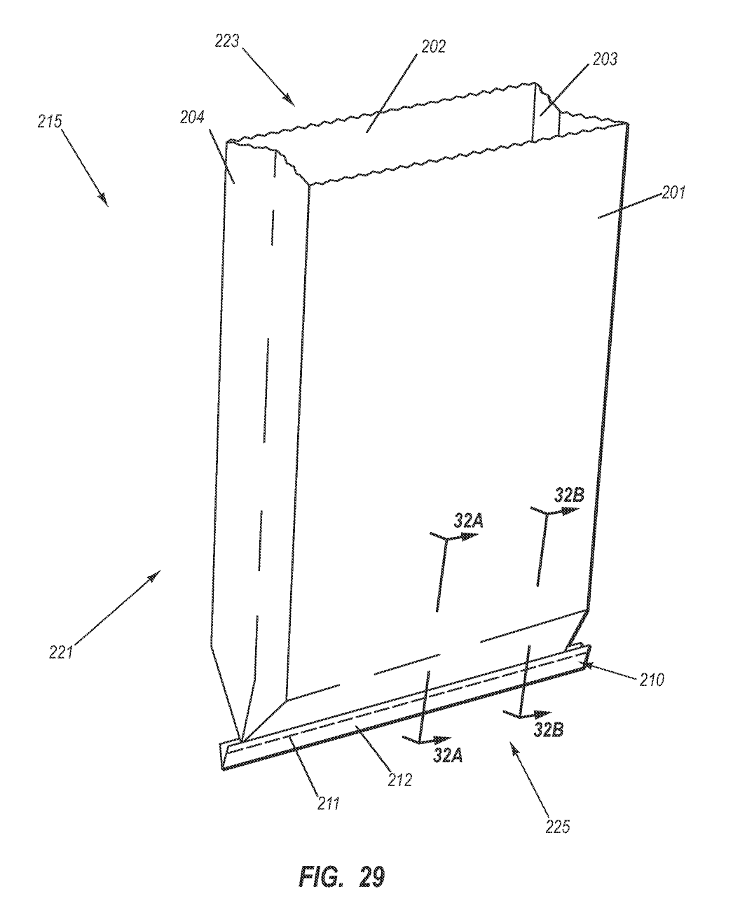

FIG. 29 illustrates a perspective view of another embodiment of a bag 215. The bag 215 can resemble the bags 15, 115 in many respects, thus like features are identified with like reference numerals, with a leading hundreds numeral incremented to the value “2”. Any suitable feature of the various embodiments of bags 15, 115 can be incorporated into or otherwise used with the bag 215, and any suitable feature of the various embodiments of the bag 215 can be incorporated into or otherwise used with the bags 15, 115. Further, the bag 215 may be assembled and/or used according to any suitable method, such as any suitable method discussed above with respect to the bags 15, 115.

The bag 215 can include a body portion 221, which can be substantially tubular in form. In some embodiments, the body portion 221 defines a front wall 201, a back wall 202, a first side wall 203, and a second side wall 204. In certain embodiments, the bag 215 defines a sewn-open-mouth configuration, and can include a closure seam 210 at a bottom end 225 of the body portion 221. In some embodiments, the seam 210 comprises one or more stitching elements 211, such as threads, strings, or yarns, which extend through the front wall 201 and the back wall 202 in a sewn or stitching pattern. In some embodiments, the one or more stitching elements 211 can further extend through end portions of the first side wall 203 and/or the second side wall 204. In some embodiments, a closure strip 212, which can comprise paper or any other suitable material, is positioned over (e.g., at an outwardly facing surface of) the front wall 201 and the back wall 202 and is sewn to the front and back walls 201 and 202 via the one or more stitching elements 211. When the bag 215 is in a sewn-open-mouth configuration, a top end 223 of the bag 215 can be open such that a product can be received into the bag 215, and the product can be maintained within the bag 215 via the closed bottom end 225.

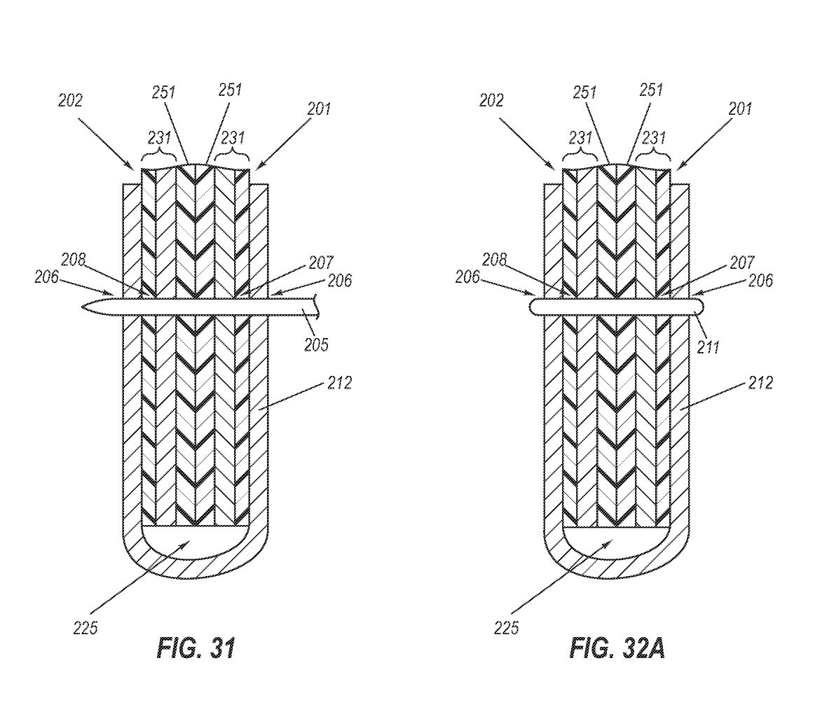

In some embodiments, the body portion 221 comprises a sheet of material that is folded or otherwise formed into the substantially tubular structure. The body portion 221 may resemble the body portions 21, 121 described above. For example, various embodiments of the body portion 221 may comprise the same structure as any of the embodiments of the body portions 21, 121, such as those depicted and described in FIGS. 4-12 and 26 and the associated written disclosure. For example, the body portion 221 may comprise a composite material with an outer ply 231 and an inner ply 251 (see, e.g., FIG. 31). The outer and inner plies 131, 151 can be substantially the same as one or more embodiments of the outer and inner plies 31, 51, 131, 151 described above.

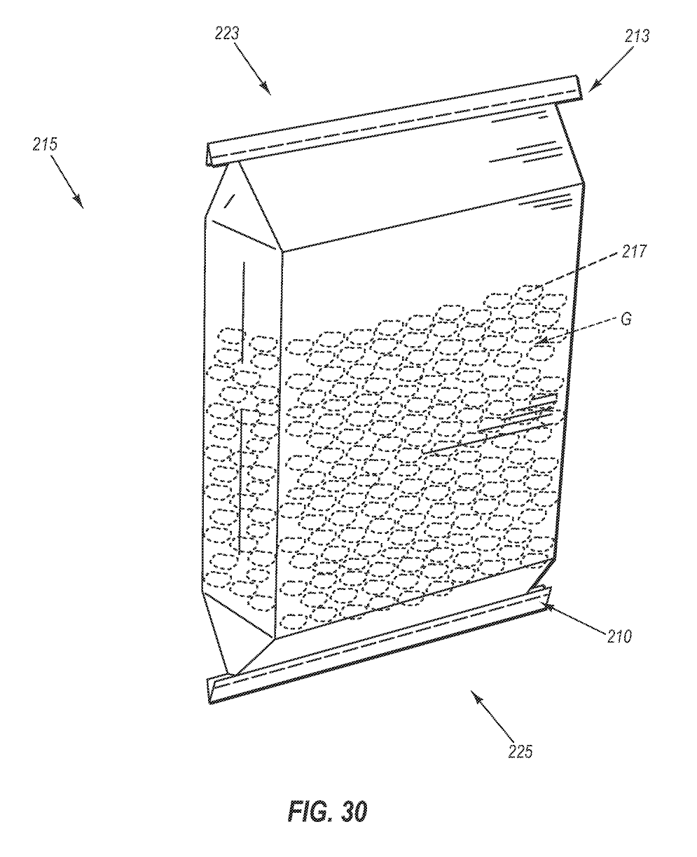

With reference to FIG. 30, in certain embodiments, the bag 215 can have contents disposed therein, such as a product 217. In some embodiments, the product 217 includes a grease component G. Once the product 217 is within the bag 215, the top end 223 of the bag 215 can be closed in any suitable fashion. For example, the illustrated embodiment includes a closure seam 213 such as the closure seam 210 at the bottom end 225 of the bag 215 (discussed above).

With reference to FIGS. 29 and 30-32A, in certain embodiments, at least one end 223, 225 of a tubular body 221 (such as, for example, the tubular body 21 depicted in FIG. 12) can be sewn closed to provide a bag 215 in a sewn-open-mouth configuration (e.g., having a first end that is sewn closed and a second end that is open). In some embodiments, the bottom end 225 of the bag 215 comprises a closure seam 210 and the top end 223 is left open such that a product can be received into the bag 215 via the top end 223.

With reference to FIG. 31, in some embodiments, a method of forming the bag 215 into a sewn-open-mouth configuration includes urging the front wall 201 and the back wall 202 of the tubular body 221 toward one another. Although each of the front and back walls 201 and 202 in the illustrated embodiment comprise three layers (i.e., a two-layered outer ply 231 and a single-layered inner ply 251), any suitable layered arrangement disclosed herein is possible. As shown in FIG. 30, the front wall 201 and the back wall 202 can be placed in abutting contact with each other. In further embodiments, a closure strip 212 is placed over the bottom end 225 of the front and back walls 201 and 202. For example, the closure strip 212 can be folded or bent such that a portion of the closure strip 212 contacts an outer surface of the front wall 201 and another portion of the closure strip 212 contacts an outer surface of the back wall 202.

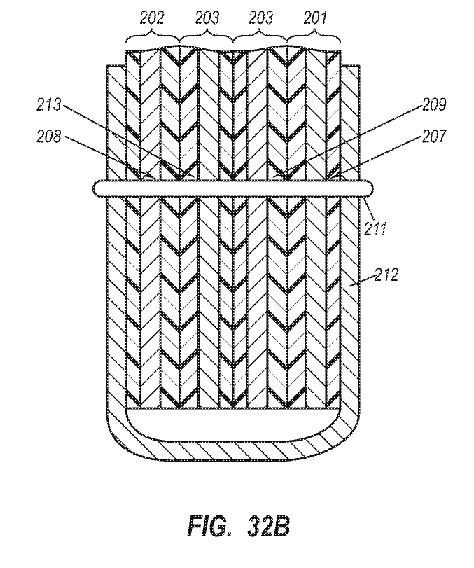

With reference to FIGS. 31 and 32A, in some embodiments, a stitching element 211 is introduced into a bottom region of the tube body 221 via a stitching needle 205. The stitching needle 205 can be configured to pierce through a first portion of the closure strip 212, the front wall 201, the back wall 202, and a second portion of the closure strip 212. The stitching needle 205 thus can form openings 206 in the closure strip 212, an opening 207 in the front wall 201, and an opening 208 in the back wall 202.

In some embodiments, the stitching needle 205 carries the stitching element 211 through the openings 206, 207, and 208 and positions a portion of the stitching element 211 within the openings 206, 207, and 208. Accordingly, upon removal of the stitching needle 205 from the bottom end 225 of the tube body 221, the stitching element 211 can extend through the openings 206, 207, and 208 in a substantially fixed state.

The stitching element 211 can hold the front wall 201 and the back wall 202 in close engagement with one another so as to form a substantially grease-impermeable seal. As used herein the term grease-impermeable seal is used in its ordinary sense, and can include a seal that prevents the passage of grease thereby. Accordingly, a substantially grease-impermeable seal formed at a bottom end 225 of a bag 215 can substantially prevent grease from entering or exiting the bag 225 via the bottom end 225. As illustrated in FIG. 29, in some embodiments, the stitching element 211 can extend across a full transverse width of the bag 215 (e.g., from one lateral edge of the front wall 201 to an opposing lateral edge of the front wall 201), and can form a substantially grease-impermeable seal along the full transverse width of the bag 215. In further embodiments, the substantially grease-impermeable seal can also substantially prevent the passage of odors via the seal.

In some advantageous embodiments, the front and back walls 201, 202 are configured to close around the stitching element 211 upon removal of the stitching needle 205. For example, in some embodiments, the memory of the inner ply 251 (or a portion thereof, such as a core layer 255) is sufficiently large to permit the inner ply 251 to elastically deform as the stitching needle 205 passes through it. Upon removal of the needle 205, the inner ply 251 can move toward a more relaxed, more natural, or more constricted configuration and can close around the stitching element 211. The inner ply 251 can contact, constrict, or otherwise interact with the stitching element to form a substantially grease-impermeable seal. In some embodiments, a substantially grease-impermeable seal formed between the front and back walls 201, 202 and the stitching element 211 at the openings 206 and 207 can substantially prevent the passage of odors via the seal.

In some embodiments, the outer ply 231 can form, or contribute to the formation of, a substantially grease-impermeable seal between the front and back walls 201 and 202 and the stitching element 211. For example, in some embodiments, the memory of the outer ply 231 (or a portion thereof, such as the film 233) is sufficiently large to permit the outer ply 231 to elastically deform as the stitching needle 205 passes through it and to move toward a more constricted state upon removal of the needle 205.

In some embodiments, the memory of a material is affected by the thickness of the material. The term “memory” is used herein in its ordinary sense, and can include a property of the material by which the material can be stretched from a first position to a second position, and upon release from the second position, can completely return, or can return by a percentage amount, to the first position. By way of example, in some instances, PET films have a relatively low memory and PE films have a relatively high memory. In many instances, the memory of a material increases as the thickness of the material increases. In various embodiments, the thickness of the inner ply 251, or a portion thereof (e.g., the core layer 255), is between about 1 mils and about 6 mils, between about 2 mils and about 5 mils, or between about 3 mils and about 4 mils. In various embodiments, the thickness of the outer ply 233, or a portion thereof (e.g., the film 233), is between about 1 mils and about 6 mils, between about 2 mils and about 5 mils, or between about 3 mils and about 4 mils.

In certain embodiments, the stitching element 211 can comprise a material configured to interact with one or more materials of the front and back walls 201 and 202 to form a substantially grease-impermeable seal therewith. In various embodiments, the stitching element can comprise cotton, a polyolefin, and/or a blend of synthetic materials and cotton.

As illustrated in FIGS. 29 and 32B, in certain embodiments, a bag 215 can be formed with gusseted sidewalls 203 and 204. With reference to FIG. 12, in some embodiments, the sidewalls of a substantially tubular body can be urged inward to form the gussets, as depicted by block arrows, and can be creased or folded. With reference to FIG. 32B, in some embodiments, the stitching element 211 can extend through two separate portions of a gusseted side wall (e.g., the side wall 203). In the illustrated embodiment, the front wall 201 defines the opening 207, the back wall defines the opening 208, a first portion of the side wall 203 defines a third opening 209, and a second portion of the side wall 203 defines a fourth opening 216. The stitching element 211 can extend through the first, second, third, and fourth openings 207, 208, 209 and 216 in a substantially fixed state. The stitching element 211 can hold the front wall 201 and the first portion of the side wall 203 in close engagement with one another so as to form a substantially grease-impermeable seal. Similarly, the stitching element 211 can hold the second portion of the side wall 203 and the back wall 202 in close engagement with one another so as to form a substantially grease-impermeable seal.

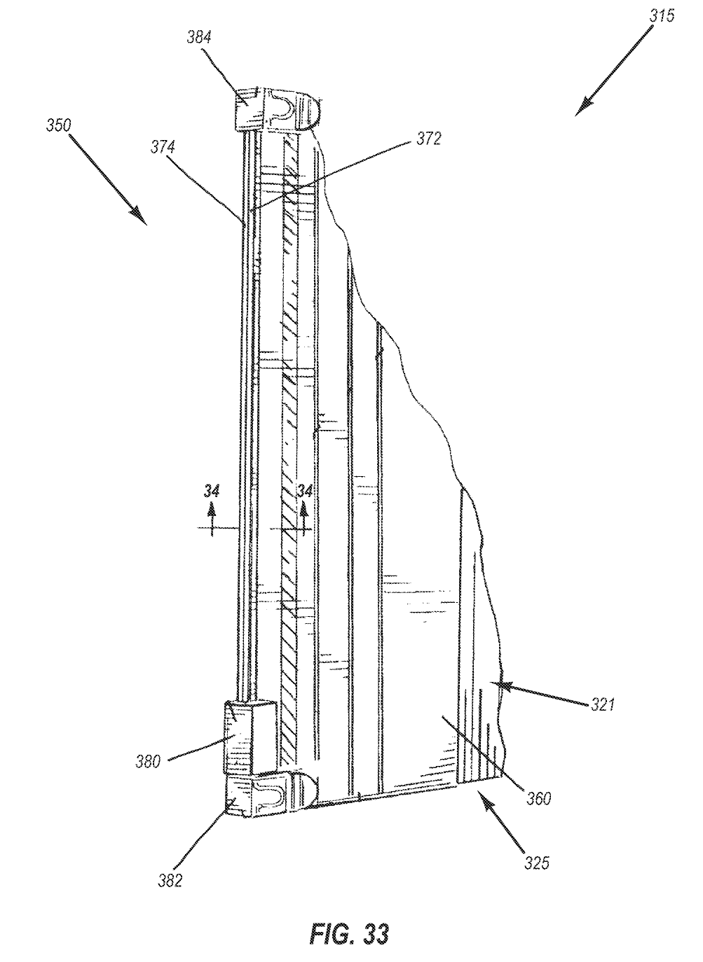

FIG. 33 depicts another embodiment of a bag 315 that includes a bottom end 325 that is closed via a zipper closure 350. The bag 315 may resemble (e.g., may be configured similar to and may function similar to) the bags 15, 115, and 215 described above, thus like features are identified with like reference numerals, with a leading hundreds numeral incremented to the value “3”. Any suitable feature of the various embodiments of bags 15, 115, 215 can be incorporated into or otherwise used with the bag 315, and any suitable feature of the various embodiments of the bag 315 can be incorporated into or otherwise used with the bags 15, 115, 215. Further, the bag 315 may be assembled and/or used according to any suitable method, such as any suitable method discussed above with respect to the bags 15, 115, 215.

With reference to FIG. 33, the bottom end 325 of the bag can comprise a zipper closure 350. As used herein, the terms “top end” and “bottom end” are not absolute and thus should not be construed as limiting. In general, these terms are used from the perspective of a bag manufacturer. Accordingly, in some embodiments, the “bottom end” of a bag may ultimately serve as the “top end” of the bag via which an end user may access the contents of a filled bag.

In certain embodiments, the zipper closure 350 can be reclosable such that the closure can be selectively opened or closed repeatedly, as desired. In some embodiments, the zipper closure 350 comprises one or more connection portions 360, which can comprise a skirt, flaps, or extensions. The connection portions 360 can be connected to the bottom end 325 of the tube body 321 in any suitable manner, and in some embodiments, can form a substantially airtight, fluid-tight, and/or grease-impermeable seal therewith, as further discussed below. The body 321 can resemble any suitable embodiment of the similarly numbered bag bodies 21, 121, 221 described above.

In some embodiments, the zipper closure 350 comprises a first zipper track 372 and a second zipper track 374 that are configured to selectively engage each other and disengage from each other. In some embodiments, the zipper tracks 372, 374 can form a substantially airtight, fluid-tight, and/or grease-impermeable seal when engaged with each other. In further embodiments, the zipper closure comprises a sliding block 380 configured to transition the zipper tracks 372, 374 between the engaged and disengaged states. The block 380 can move between two stops 382, 384, which can serve to limit the translational movement of the block 380.

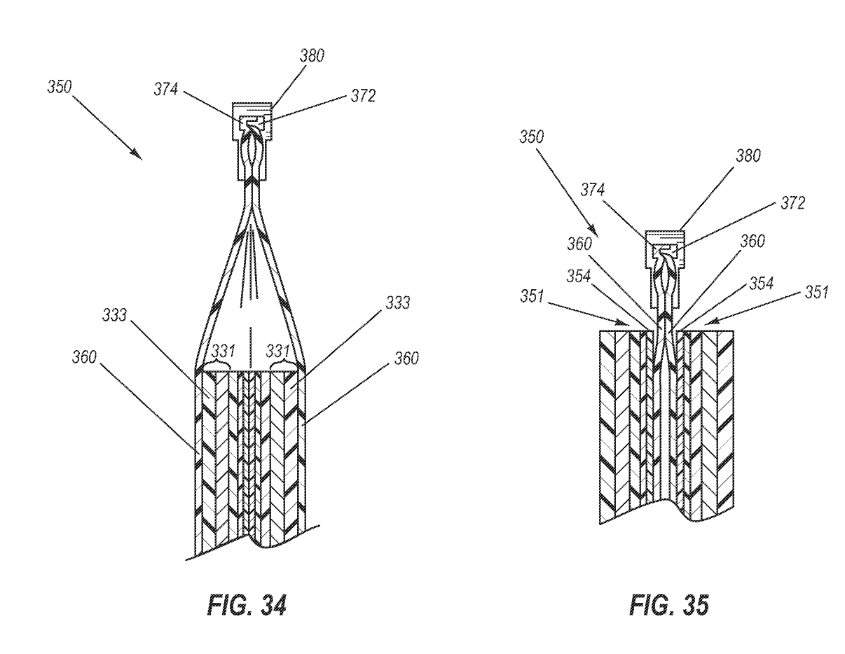

With reference to FIGS. 34 and 35, in some embodiments, the block 380 can compress the first and second zipper tracks 372, 374 into sealed contact with each other to transition the zipper tracks 372, 374 to the engaged state. The block 380 can cause the first and second zipper tracks 372, 374 to separate from each other to transition the zipper tracks 372, 374 to the disengaged state.

With reference to FIG. 35, in some embodiments, the connection portion 360 of the zipper closure 350 comprises a heat sealable material. In some embodiments, the connection portion 360 is placed in contact with an outer surface of a heat sealable portion of the outer ply 331 (e.g., the film 333) and is heat sealed thereto. With reference to FIG. 35, in other embodiments, the connection portion 360 is placed in contact with an inner surface of a heat sealable portion of the inner ply 351 (e.g., the film 354) and is heat sealed thereto. Any suitable heat sealing methods and materials may be used, such as those discussed herein.

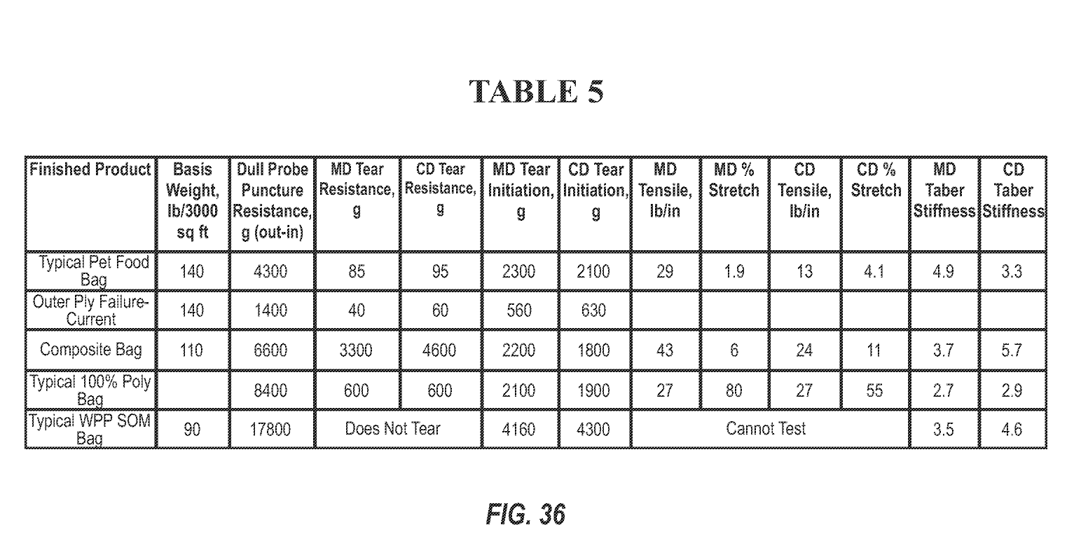

FIG. 36 depicts Table 5, which includes comparative measurements of a variety of bags, such as embodiments of bags depicted in FIGS. 4-12 and 16A-16B and described in the accompanying text. In particular, various properties are compared among a typical pet food bag (both the bag as a whole and an outer ply thereof), an illustrative, non-limiting embodiment of a composite bag (e.g., a bag comprising a multi-layered construction), a 100% polyolefin bag, and a common woven polypropylene sewn-open-mouth bag. The typical pet food bag represented in the first row of data in Table 5 comprises a construction having a CSR4 outer ply (a bleached 41 pound per 3,000 square feet clay-coated grease-resistant treated paper), two plies of multiwall Kraft, and 2 plies of 0.75 mil BOPP film liner. The second row of data in Table 5 represents measurements related to the CSR4 outer ply of the typical pet food bag (i.e., the pet food bag represented in the first row of data). In particular, the label “Failure-Current” represents a stage at which the outer ply has ripped or torn. In certain of such instances, the entire package can be considered a failure at the “Failure-Current” state, even though remaining plies of the package have not failed, since consumers are less likely to purchase the package due to visible damage to the package. The composite bag represented in the third row of data in Table 5 comprises a 48 gauge PET layer, a 50 pound bleached extensible paper layer, and a 3 mil coextruded film inner ply. The typical woven polypropylene bag represented in the fifth row of data in Table 5 includes a 0.75 mil BOPP extrusion laminated to 850 denier weave having an 8×10 thread count that is coated with 1.0 mil PE; the extrudate is a PP copolymer having a thickness of 1.0 mil.

The tests performed on the various bags are listed in the first row of Table 5. It is noted that the abbreviation “MD” is used to denote “Machine Direction,” and the abbreviation “CD” is used to denote “Cross Direction.” For the examples shown, dull probe puncture resistance was measured in accordance with test method ASTM D5748, tear resistance was measured in accordance with test method TAPPI T414, tear initiation was measured in accordance with test method ASTM D1004-07, tensile, elongation was measured in accordance with test method TAPPI T494, and taber stiffness was measured in accordance with test method ASTM D5748.

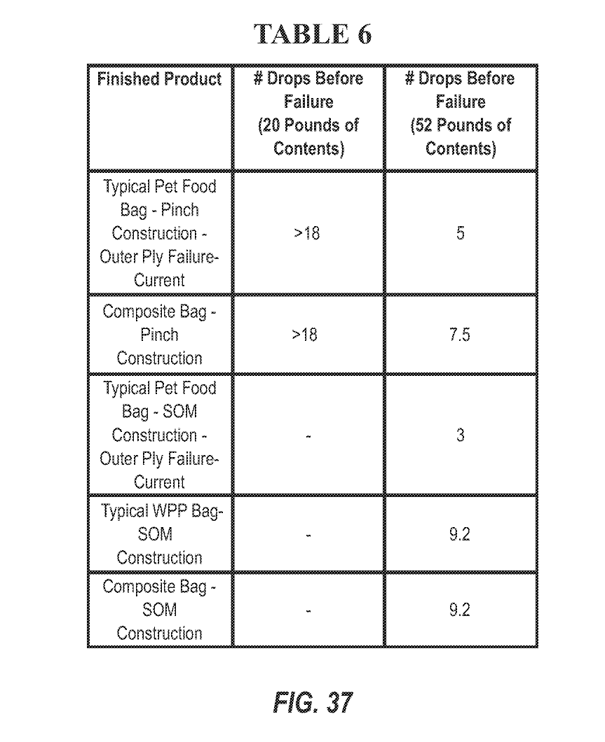

As shown in FIG. 37, other tests can be performed to compare embodiments of composite bags, including configurations of bags as depicted in FIGS. 4-12 and 16A-16B with other bag varieties. For example, it can be desirable to compare the results of drop tests to determine the relative durability of the composite bag as compared with other bag varieties. One suitable drop test can be performed in accordance with test method ASTM D 5276 and/or test method TAPPI UM 806. The foregoing tests can also be altered or augmented. In some instances, the drop test can comprise a 6-stage cycle, with each stage comprising dropping the bag from a height of 4 feet. The 6 stages of the cycle can comprise separately dropping the bag on its front, back, left edge, right edge, top, and bottom. In some instances, testing can be stopped after three full dropping cycles (i.e., after 18 total drops of the bag). Drop test results can depend on the bag design style (e.g., SOM vs. pinch) and upon the filled weight of the bag.

The typical pet food bag represented in the first and third rows of data in Table 6 comprises a construction having a CSR4 outer ply (a bleached 41 pound per 3,000 square feet clay-coated grease-resistant treated paper), two plies of 50 pound multiwall Kraft, and one ply of 1.25 mil BOPP. For the first row of data, the pet food bag is formed with a pinched bottom seal and a pinched top seal; for the third row of data, the pet food bag comprises a sewn-open-mouth configuration. The composite bag represented in the second and fifth rows of data in Table 6 comprises a 48 gauge PET layer, a 50 pound bleached extensible paper layer, and a 3 mil coextruded film inner ply. For the second row of data, the composite bag is formed with a pinched bottom seal and a pinched top seal; for the fifth row of data, the composite bag comprises a sewn-open-mouth configuration. The typical woven polypropylene bag represented in the fourth row of data in Table 6 includes a 0.75 mil BOPP extrusion laminated to 850 denier weave having an 8×10 thread count that is coated with 1.0 mil PE; the extrudate is a PP copolymer having a thickness of 1.0 mil.

As shown in Table 6, in some cases, a typical pinch-bottom/pinch-top pet food bag filled with 20 pounds of pet food and subjected to the conditions of a test such as described above can experience more than 18 drops before failing. However, in other cases, a typical pinch-bottom/pinch-top pet food bag can average about 15 drops before reaching a Failure-Current state, which is often the result of gusset failures and outer ply failures. When the pinch-construction pet food bag is filled with 52 pounds of pet food, it can average about 5 drops before failing.

The composite bag of the present example, which has a pinch-bottom/pinch-top configuration and is filled with 20 pounds of pet food can experience more than 18 drops before failing. In contrast to the typical pet food bag, the composite bag of the present example generally is not prone to gusset failures or outer ply failures due to its laminated structure and the strength of the materials it contains. When filled with 52 pounds of pet food, the composite bag can average about 7.5 drops before failing. Often, the mode of failure in such instances is a failure of a back seam that runs along the longitudinal length of the bag (e.g., the seam 75, and related structures disclosed herein).

A typical sealed-open-mouth pet food bag subjected to the testing conditions can experience 9.1 drops before failing, and a composite sealed-open-mouth pet food bag subjected to the testing conditions can experience 9.2 drops before failing.

Various differences between the specific embodiment of a composite bag used in the tests and each of the other bags are evident from Table 5. For example, as compared with a typical pet food bag that is tested in its entirety (i.e., the first row of data in Table 5), the composite bag used in this particular test is more lightweight, more puncture-resistant, more tear-resistant, slightly less resistant to tear initiation, exhibits greater tensile strength, has a greater capacity to elongate (is “stretchier”), and is less stiff in a machine direction but stiffer in a cross direction. As compared with typical pet food bag that is tested to the “Failure-Current” state described above (i.e., the second row of data in Table 5), the composite bag is significantly more puncture resistant, more tear resistant, and less prone to tearing. Additionally, as is apparent from the drop test results, the composite bag can be considered to have superior overall strength and to hold up better under typical product handling conditions.

As shown in Table 6, a typical sewn-open-mouth pet food bag filled with 52 pounds of pet food can fail after only 3 drops. The typical woven polypropylene bag and the composite bag of the present example each can be more durable than the typical pet food bag, each failing after about 9.2 drops on average. In many instances, the woven polypropylene and composite bags fail due to ruptures of the sewing line.

The foregoing examples should not be interpreted as limiting. For example, many embodiments of a composite bag can have measurements that are different from those listed in Tables 5 and 6. To illustrate, in various embodiments, a composite bag can have a dull probe puncture resistance within a range of from about 5,000 grams to about 8,000 grams, a machine-direction tear resistance within a range of from about 2,000 grams to about 4,000 grams, a cross-direction tear resistance within a range of from about 3,000 grams to about 6,000 grams, a machine-direction tear initiation within a range of from about 1,000 grams to about 3,000 grams, a cross-direction tear initiation within a range of from about 1,000 grams to about 3,000 grams, a machine-direction tensile strength within a range of from about 30 pounds per inch to about 50 pounds per inch, a machine-direction stretch within a range of from about 3% to about 15%, a cross-direction tensile strength within a range of from about 15 pounds per inch to about 30 pounds per inch, a cross-direction stretch within a range of from about 5% to about 15%, a machine-direction taber stiffness within a range of from about 2.5 to about 5.0, and/or a cross-direction taber stiffness within a range of from about 3.0 to about 7.0. Any subset of the foregoing ranges is possible, and values outside of the listed ranges are also possible.

Non-limiting examples compatible with certain embodiments described herein are now provided. The examples are given by way of illustration, and are not intended to limit the disclosure herein.

### Example 1

In certain embodiments, a material for forming a bag 15, 115, 215, and/or 315 is laminated on an in-line tuber. Specifically, an approximately 48 gauge PET layer (e.g., film 33) is reverse printed and laminated to bleached 35 lb. paper (e.g., paper layer 35), which in turn is laminated to a 5-layer co-extruded film (e.g., inner ply 51) that contains a nylon core (e.g., core layer 55). The 35 lb. paper and 5-layer co-extruded film are laminated to each other via solventless adhesive. For material that is used in bags that are configured to contain about 20 or more kilograms of product, the thickness of the co-extruded film is about 4 mils. For material that is used in bags that are configured to contain less than about 20 kilograms of product, the thickness of the co-extruded film is about 3 mils. The multi-layer, laminated material is then converted to bags on standard converting equipment.

Bags formed in the foregoing manner can demonstrate excellent grease resistance, odor resistance, and pest resistance. In some embodiments, bags that contain a food product having a fat content of less than 10% by weight exhibit no grease leakage from a sewn closure (e.g., neither through a sealed end of the bag nor through openings in the bag walls through which a stitching element extends) after three months of storage in an environment at about 130 degrees Fahrenheit. The bags can exhibit substantially no odor leaks under the same conditions.

In some embodiments, bags that contain a food product having a fat content of less than 10% by weight exhibit no grease leakage from a sewn closure after nine months of storage in an environment at room temperature. The bags can exhibit substantially no odor leaks under the same conditions.

In some embodiments, bags that contain a food product having a fat content of at least about 15% by weight exhibit no grease leakage from a sewn closure after 30 days of storage in an environment at about 130 degrees Fahrenheit.

### Example 2

In certain embodiments, a material for forming a bag 15, 115, 215, and/or 315 is laminated on an in-line tuber. Specifically, an approximately 48 gauge PET layer is reverse printed and laminated to 50 pound bleached extensible paper, which in turn is laminated to a 5-layer co-extruded film that contains a nylon core. The 50 pound paper and 5-layer co-extruded film are laminated to each other via solventless adhesive. For material that is used in bags that are configured to contain about 20 or more kilograms of product, the thickness of the co-extruded film is about 4 mils. For material that is used in bags that are configured to contain less than about 20 kilograms of product (e.g., between about 2 kg and about 10 kg), the thickness of the co-extruded film is about 2 mils. The multi-layer, laminated material is then converted to bags on standard converting equipment. Bags formed in the foregoing manner can demonstrate grease and odor resistance such as that described above with respect to Example 1.

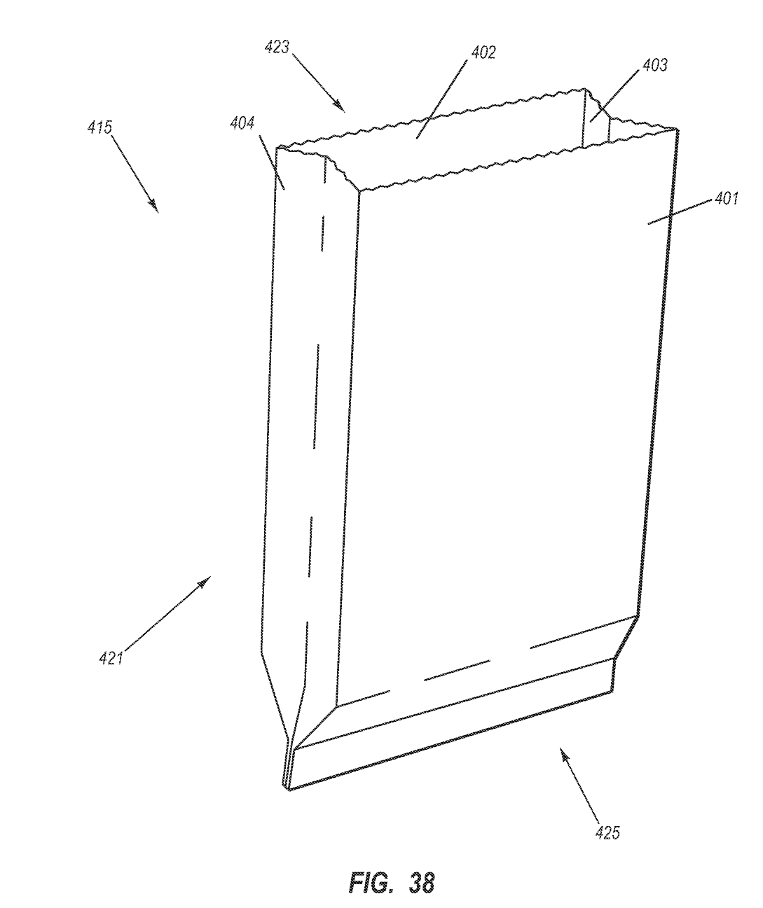

FIG. 38 illustrates a perspective view of another embodiment of a bag 415 that comprises a composite material. The bag 415 can resemble the bags 15, 115, 215, 315 described above in many respects, thus like features are identified with like reference numerals, with a leading hundreds numeral incremented to the value “4”. Any suitable feature of the various embodiments of the bags 15, 115, 215, 315 described above can be incorporated into or otherwise used with the bag 415, and any suitable feature of the various embodiments of the bag 415 can be incorporated into or otherwise used with the bags 15, 115, 215, 315. Further, the bag 415 may be assembled and/or used according to methods that may, in certain respects, resemble those discussed above with respect to the bags 15, 115, 215, 315. For example, any suitable closure arrangement, or combination of closure arrangements, described above may be used with the bag 415.

The bag 415 can comprise a body portion 421 similar to the body portions 21, 121, 221, 321 described above. For example, in some embodiments, the body portion 421 may be formed from one or more materials that are the same as those that form some or all of the body portions 21, 121, 221, 321. However, in some embodiments, the relative orientations of the various materials (e.g., the ordered layering of the materials) may vary from those of the bags 15, 115, 215, 315, as further described below.

In certain embodiments, the body portion 421 can be substantially tubular in form and may, for example, define a front wall 401, a back wall 402, a first side wall 403, and a second side wall 404. The bag 415 can define a top end 423, which is depicted in an open configuration such that a product can be received into the bag 415, and the product can be maintained within the bag 415 via a closed bottom end 425.

In some embodiments, the body portion 421 comprises a sheet of material that is folded or otherwise formed into the substantially tubular structure. The body portion 421 may comprise a composite material, which can include multiple layers or plies. The term “ply,” as used herein, is a broad term and is not intended to limit the disclosure. For example, the terms “ply” and “layer” may be used synonymously herein, and a given ply may itself include multiple layers or plies. Thus, although certain embodiments described above are cast in terms of inner and outer plies, in some instances, one or more of the inner and outer plies each may include multiple plies or layers.

The bottom end 425 is depicted in a closed pinch-bottom configuration. Any other suitable closure configuration may be used, including, for example, any of those depicted in FIGS. 13-16B and FIGS. 25-26 and described in the associated text. Similarly, the bottom end 425 may be formed into a variety of closed configurations via sewing, such as, for example, any of the sewn closures depicted in FIGS. 29-32B and described in the associated text. In some embodiments, the top bottom end 425 comprises a resealable closure, such as, for example, any of the zipper closures depicted in FIGS. 33-35 and described in the associated text. The top end 423 may be closed via any suitable configuration, including any of the configurations described herein with respect to the bottom end 425.

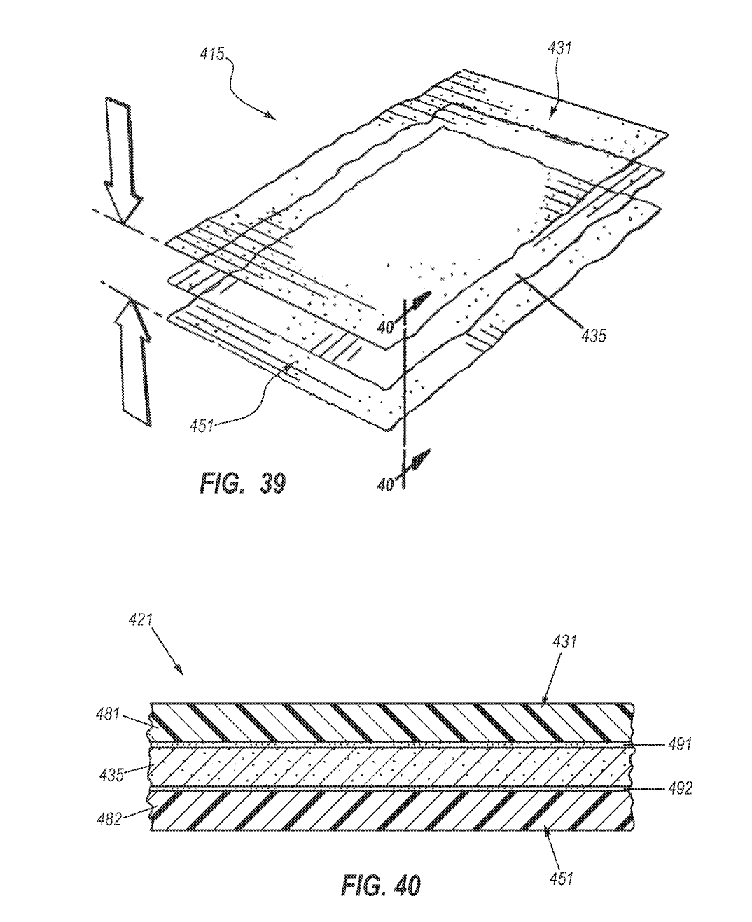

FIG. 39 illustrates an exploded partial perspective view of a body material, or a composite laminate material, from which the bag 415 may be formed. In the illustrated embodiment, the material comprises an outer ply 431, a paper layer 435, and an inner ply 451. The outer ply 431 may comprises a tough extensible film. For example, the outer ply 431 can comprise one or more layers 481 of a polyamide-based film, such as, for example, a nylon film. The layer 481 can comprise any suitable nylon material, such as, for example, the nylon materials described above. In some embodiments, the layer 481 comprises a cast nylon film, such as, for example, a film of nylon 6,6 formed via a cast-film process. In some embodiments, the layer 481 comprises Dartek® cast nylon film, which is available from Exopack of Spartanburg, S.C. In various embodiments, the layer 481 can comprise a nylon film having a thickness of from about 0.5 mil to about 3.0 mil, from about 0.75 mil to about 2.5 mil, from about 1.0 mil to about 2.5 mil, no less than about 0.5 mil, no less than about 0.75 mil, no less than about 1.0 mil, no less than about 1.5 mil, no less than about 2.0 mil, about 0.75 mil, or about 1.0 mil. Other thicknesses are also possible.

The paper layer 435 may comprise an extensible paper, such as, for example, any suitable extensible paper described above. In some embodiments, the extensible paper has relatively high tensile energy absorption (TEA) indices in the machine direction and the cross direction. For example, in various embodiments, the machine direction TEA index of the paper layer 435 is within a range of from about 12.0 foot-pounds per square foot to about 20.0 foot-pounds per square foot, is no less than about 12.0 foot-pounds per square foot, no less than about 14.0 foot-pounds per square foot, no less than about 16.0 foot-pounds per square foot, no less than about 18.0 foot-pounds per square foot, or no less than about 20.0 foot-pounds per square foot. In other or further embodiments, the cross direction TEA index of the paper layer 435 is within a range of from about 14.0 foot-pounds per square foot to about 24.0 foot-pounds per square foot, is no less than about 14.0 foot-pounds per square foot, no less than about 16.0 foot-pounds per square foot, no less than about 18.0 foot-pounds per square foot, no less than about 20.0 foot-pounds per square foot, no less than about 22.0 foot-pounds per square foot, or no less than about 24.0 foot-pounds per square foot. In various embodiments, the paper layer 435 can comprise Polar® extensible paper or PolarX extensible paper, which are available from Premium 1 Papers of British Columbia, Canada. In some embodiments, the paper layer 435, or the extensible properties thereof, can cooperate with and/or reinforce an extensible outer ply 431 so as to increase the strength (e.g., the tear resistance, puncture resistance, etc.) of the bag material. For example, the outer ply 431 and the paper layer 435 can be stretched or otherwise deformed in tandem, and, together, can be more resistant to tearing, puncturing, or otherwise being compromised than if one or the other of the outer ply 431 and the paper layer 435 were inextensible.

In other embodiments, the paper layer 435 may comprise a bleached clay coated paper. In still other embodiments, the paper layer 435 may comprise an unbleached Kraft paper. In various embodiments, the paper layer 435 has a basis weight within a range of from about 30 pounds per ream to about 80 lbs per ream, from about 40 pounds per ream to about 70 pounds per ream, no less than about 30 pounds per ream, no less than about 40 pounds per ream, no less than about 50 pounds per ream, no less than about 60 pounds per ream, or can be about 50 pounds per ream. In various embodiments, the paper layer 435 can have a thickness within a range of from about 2.5 mil to about 4.5 mil, about 3.0 to about 4.0 mil, about 3.2 to about 3.7 mil, no less than about 2.5 mil, no less than about 3.0 mil, no less than about 3.2 mil, or no less than about 3.5 mil.

In certain embodiments, the paper layer 435 is substantially free of fluorocarbons, such that the paper layer 435 either comprises no fluorocarbons or only trace amounts of fluorocarbons. For example, the paper layer 435 can be included in the laminate material without first being treated with fluorocarbons. Many known bag structures utilize fluorocarbon-treated paper due to the grease-resistant characteristics of such paper. However, certain embodiments of the laminate structures used to form the bags 415 function well without fluorocarbon treated paper due to printing properties and/or grease-resistant properties of their outer ply 431 and/or due to grease-resistant properties of their inner ply 451, as further discussed below. In other embodiments, fluorocarbon-treated paper may be used.

In some embodiments, at least a portion of an outer surface of the paper layer 435 can be surface printed prior to lamination to the outer ply 431. For example, in some embodiments, the outer ply 431 is substantially clear or transparent such that an outer surface of the paper layer 435 is visible through the outer ply 431. In certain of such embodiments, it may be desirable for the paper layer 435 and/or the inner ply 451 to be substantially grease resistant so as to prevent grease spots from eventually developing on the paper layer 435, which would be visible through the outer ply 431.

In other embodiments, at least a portion of the outer ply 431 is reverse printed (e.g., in a manner such as that depicted in FIG. 5C with respect to the film 33). Any combination of printing on an inner surface of the outer ply 431 and/or printing on an outer surface of the paper layer 435 is possible. In some embodiments, the outer ply 431 is flood-coat printed such that the printing on the outer ply 431 can substantially mask any grease spots that may develop on the paper layer 435. Accordingly, in certain of such embodiments, the inner ply 451 and/or the paper layer 435 can be permeable to grease substantially without affecting the appearance or grease-resistance of the bag 415. For example, the outer ply 431 can be substantially grease-resistant as well as flood-coat printed. The flood-coat printing likewise may cover or render imperceptible pin-holing that may result when contents of the bag 415 are sufficiently sharp to develop small openings through the inner ply 451 and the paper layer 435. Additionally, the outer ply 431 can provide the bag 415 with a plastic and/or shiny appearance.

The inner ply 451 may comprise one or more layers 482 of a polyolefin film, such as BOPP. In various embodiments, the layer 482 of BOPP has a thickness within a range of from about 0.5 mil to about 3.5 mil, from about 1.0 mil to about 3.0 mil, no less than about 0.5 mil, no less than about 1.0 mil, no less than about 1.5 mil, no less than about 2.0 mil, no more than about 0.7 mil, or no more than about 1.0 mil. In some embodiments, the layer 482 of BOPP comprises a thickness of about 0.7 mil, and in others, about 2.0 mil. Other materials are also possible, such as those discussed above with respect to the inner ply 51.

In some embodiments, the inner ply 451 comprises a coextruded film, which can, in further embodiments, resemble the coextruded films discussed above. For example, the inner ply 451 can resemble the inner ply 51 illustrated in FIG. 10A. In certain of such embodiments, the inner ply 451 includes a nylon core sandwiched between two layers of metallocene LDPE. The nylon core can be connected with the metallocene LDPE layers via suitable tie layers. In other embodiments, the inner ply 451 includes a polypropylene core between metallocene LDPE layers. In various embodiments, the thickness of the inner ply 451 is within a range of from about 2.5 mil to about 4.0 mil, no less than about 2.5 mil, no less than about 3.0 mil, no less than about 3.5 ml, or no less than about 4.0 mil. In other or further embodiments, the thickness of each metallocene LDPE layer can be within a range of from about 10 percent to about 25 percent, no less than about 10 percent, no less than about 15 percent, no less than about 20 percent, or no less than about 25 percent of the total thickness of the inner ply 451. In some embodiments, the core of the coextruded film can provide puncture resistance, toughness, and/or grease resistance.

In some embodiments, the inner ply 451 comprises one or more heat-sealable films. For example, in some embodiments, the heat-sealable films can resemble the heat-sealable films described above with respect to the inner ply 51. In other or further embodiments, the heat-sealable films can comprise metallocene LDPE. The one or more heat-sealable films can allow one or more of the ends 423, 425 of the bag 415 to be heat sealed in a manner such as described above. Likewise, the one or more heat-sealable films can be coupled with a resealable closure, such as, for example, the zipper closure 350 described above.

In certain embodiments, the inner ply 451 is substantially impermeable to grease and oil. In various embodiments, the inner ply 451 and/or the outer ply 431 can provide grease-resistant properties similar to those of other bags described herein (e.g., the bag 15 depicted in FIG. 4 and described in the associated text).

FIG. 40 illustrates a cross sectional view of the composite material configuration of FIG. 39 after the layers of material have been laminated to one another. In the illustrated embodiment, the outer ply 431 is adhered to the paper layer 435 via a tie layer 491. In certain embodiments, the tie layer 491 comprises a layer of solventless adhesive. Any suitable solventless adhesive may be used, such as, for example, one or more of the solventless adhesives described above. In some embodiments, the adhesive comprises a polyurethane-based single-component solventless adhesive, which may be moisture cured. For example, the tie layer 491 can comprise Liofol® Tycel® 7910™, which is available from Henkel Corporation of Rocky Hill, Conn. Other suitable adhesives are available from HB Fuller Company of Vadnais Heights, Minn., from Ashland Inc. of Covington, Ky., and from Rohm and Haas Company of Philadelphia, Pa. In other embodiments, the tie layer 491 can comprise a solvent adhesive. In various embodiments, the adhesive can provided in an amount of from about 2.0 pounds to about 3.0 pounds per ream, no less than about 2.0 pounds per ream, no less than about 2.5 pounds per ream, no less than about 3.0 pounds per ream, or about 2.5 pounds per ream. In still other embodiments, the outer ply 431 can be joined to the paper layer 435 via extrusion lamination.

In the illustrated embodiment, the inner ply 451 is adhered to the paper layer 435 via a tie layer 492. In certain embodiments, the tie layer 492 comprises a solventless adhesive. Any suitable solventless adhesive may be used, such as, for example, one or more of the solventless adhesives described above. In other embodiments, the tie layer 492 comprises a solvent adhesive. In still other embodiments, the inner ply 451 can be joined to the paper layer 435 via extrusion lamination. In some embodiments, in-line lamination is used to join the inner ply 451 and the paper layer 435 via a water-based adhesive. Any suitable water-based adhesive may be used. For example, in some embodiments, Product No. 33-4057 from Henkel Corporation of Rocky Hill, Conn. may be used.

In various embodiments, a total thickness of the body material of which the body portion 421 is formed can be within a range of from about 4.0 mil to about 11.5 mil, from about 5.0 mil to about 10.0 mil, from about 6.0 mil to about 9.0 mil, can be no less than about 4.0 mil, no less than about 5.0 mil, no less than about 6.0 mil, no less than about 7.0 mil, no less than about 8.0 mil, no less than about 9.0 mil, no less than about 10.0 mil, no more than about 11.0 mil, no more than about 10.0 mil, no more than about 9.0 mil, no more than about 8.0 mil, no more than about 7.0 mil, or no more than about 6.0 mil. In various embodiments, the outer layer 481 can define a thickness that is within a range of from about 10 percent to about 40 percent, from about 15 percent to about 35 percent, is no less than about 10 percent, no less than about 15 percent, no less than about 20 percent, or no less than about 25 percent of the total thickness of the body material. In other or further embodiments, the paper layer 435 can define a thickness that is within a range of from about 20 percent to about 80 percent, from about 30 percent to about 70 percent, from about 40 percent to about 60 percent, is no less than about 20 percent, no less than about 30 percent, no less than about 40 percent, no less than about 50 percent, no less than about 60 percent, or no less than about 70 percent of the total thickness of the body material. In other or further embodiments, the inner layer 451 can define a thickness that is within a range of from about 10 percent to about 50 percent, from about 15 percent to about 40 percent, from about 20 percent to about 30 percent, is no less than about 10 percent, no less than about 15 percent, no less than about 20 percent, no less than about 30 percent, or no less than about 40 percent of the total thickness of the body material.

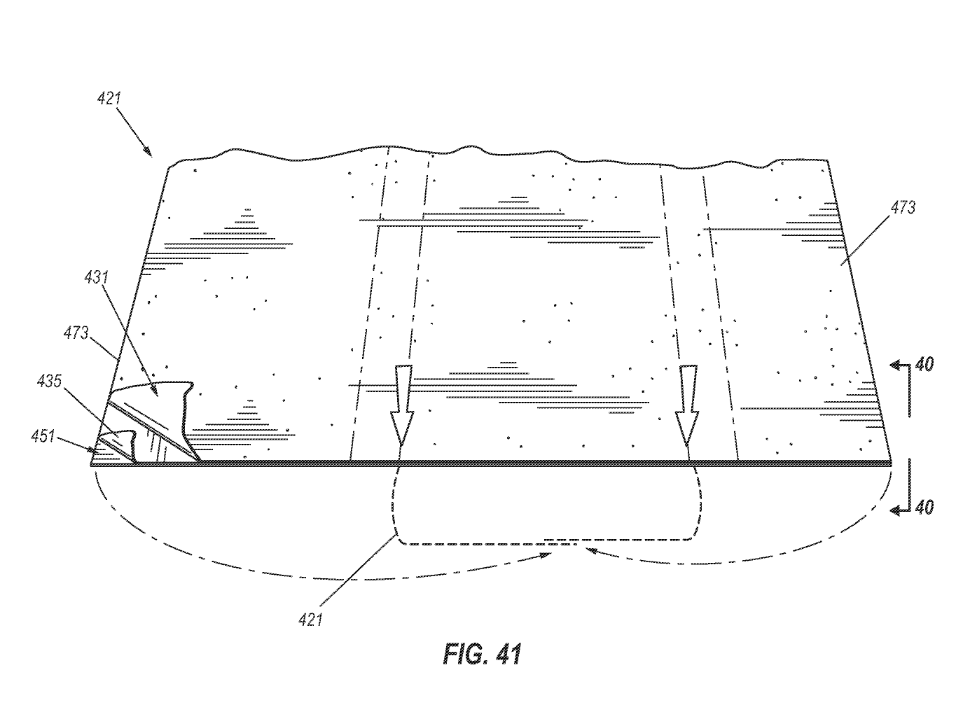

FIG. 41 illustrates a partial perspective view of the material of FIG. 40, from which the bag 415 is formed. To aid in identifying the various layers, the outer ply 431 and the paper layer 435 are depicted as being partially peeled back. After the outer ply 431, the paper layer 435, and the inner ply 451 have been laminated, the material can be formed into a tubular structure, such as that depiction of FIGS. 11-12 and described in the associated text. Lateral sides 473 of the material can be arranged in an overlapping fashion, to form a seam, as previously described.

One or more hot melt adhesives may be applied to an outer surface of the bag 415 to form a pinch-type closure, such as any of the pinch-type closures previously described. In some embodiments, at least one end of the bag 415 is closed via a pinch closure such as those shown in FIGS. 13-16B and described in the associated text. For example, the front wall 401 of the bag 415 can be longer than the rear wall 402 of the bag 415 so as to form a flap that can be folded over the rear wall 402. A suitable hot melt adhesive may be applied between the flap and the rear wall 402 such that when heat and pressure are applied thereto, the flap and the rear wall 402 are retained in a pinch fold closure configuration. Any suitable hot-melt adhesive may be used. In some embodiments, polyamide hot-melt adhesives are used. For example, in various embodiments, Product Nos. 34-3402 or 34-3412 from Henkel Corporation of Rocky Hill, Conn. may be used.

In some embodiments, a portion of the bag to which the hot melt adhesive is to be applied, or with which the hot melt adhesive will otherwise come into contact, is preheated. For example, in some embodiments having a pinch-type closure such as that depicted in FIGS. 14A and 14B, the front wall 401 can include a flap such as the flap 45 of the front wall 41 discussed above with respect to the bag 15. In like manner, an inner face of the flap of the front wall 401 and/or a portion of the back wall 402 can be preheated, as discussed above with respect to the bag 15.

The ends of the bag 415 may be closed using any other suitable techniques. For example, in some embodiments, at least one end is closed via stitching, such as that shown in FIGS. 29-32B and described in the associated text.

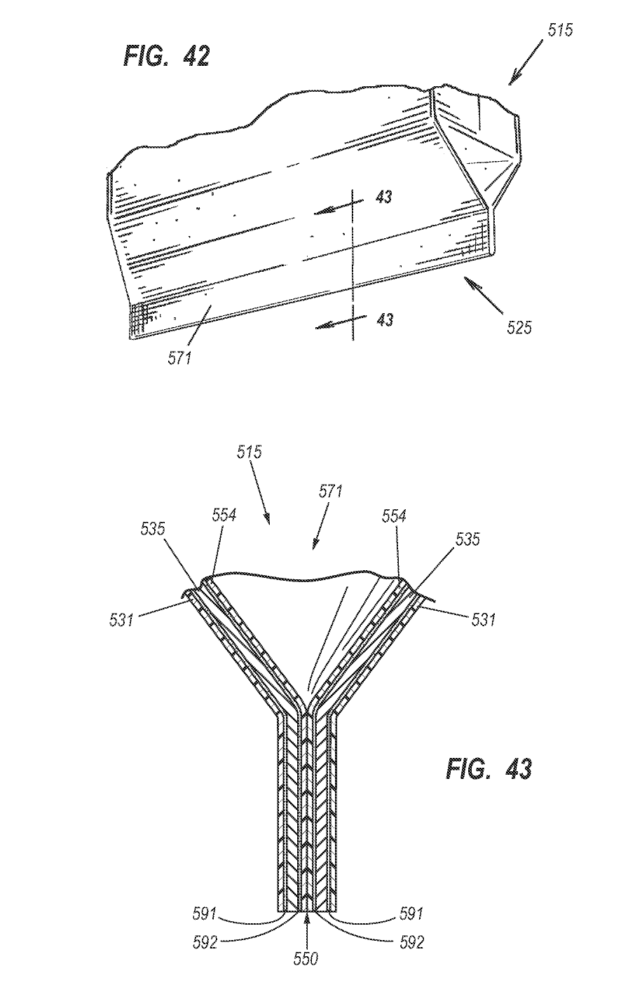

FIGS. 42-43 illustrate another embodiment of a bag 515 and a composite laminate material from which the bag 515 may be formed. With reference to FIG. 42, a partial perspective view of a lower end 525 of the bag 515 is shown. As illustrated, the lower end 525 can be closed via a compressed lip 571. The bag 515 may have a configuration that resembles that of the bag 415 and other bags disclosed herein, and may function in similar manners. The configuration of closed end 525 may be said to be a pinch closure.

FIG. 43 illustrates a cross sectional view along the view line 43-43 shown in FIG. 42, which shows the composite laminate structure of the bag 515 and the configuration of the compressed lip 571. The bag 515 may comprise an outer ply 531 of nylon and a paper layer 535, which can resemble the outer ply 431 and the paper layer 435, respectively, described above. The bag 515 can include an inner ply 554 that comprises a heat-sealable film, as described herein. The outer ply 531, the paper layer 535, and the inner ply 554 may be coupled, respectively, via tie layers 591, 592 that may be configured as the tie layers 491, 492 described above.

The compressed lip 571 may be formed by positioning the heat-sealable films of opposing inner plies 554 adjacent each other and applying heat and pressure, such that a heat seal 550 is formed. Other pinch type closures may be employed with the composite laminate structure of the bag 515, such as, for example, those depicted in FIGS. 13-16B and described in the associated text. In further embodiments, the bag 515 may comprise a zipper closure, such as, for example, those depicted in FIGS. 33-35 and described in the associated text.

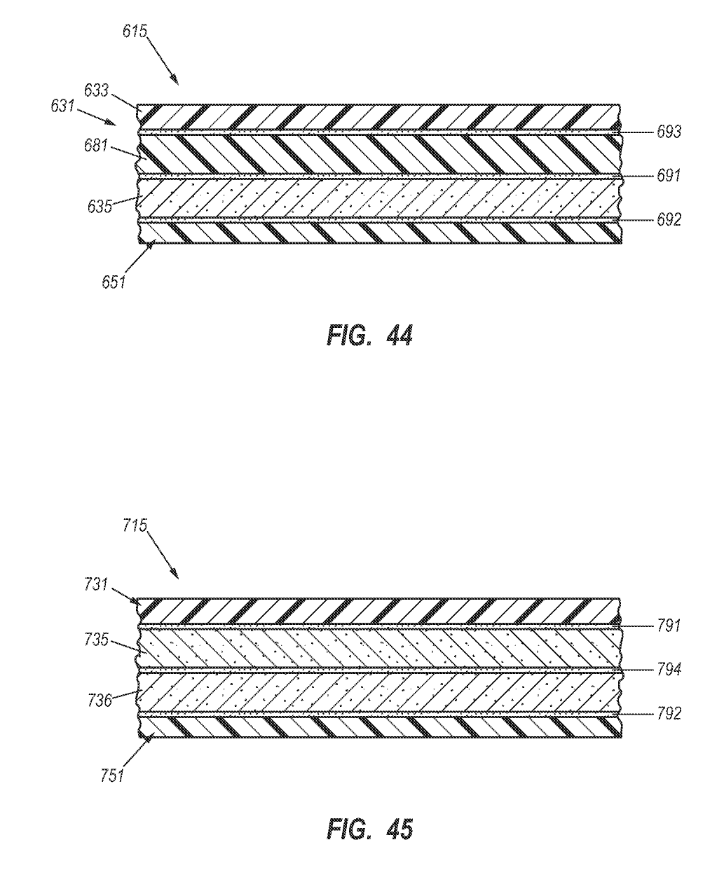

FIG. 44 illustrates a cross-sectional view of an embodiment of a composite laminate structure that may be employed to form a bag 615, which can comprise any suitable configuration disclosed herein. The cross-sectional view of FIG. 44 is similar to the view of FIG. 40, and the composite laminate structure of the bag 615 can resemble the structures of the bags 415 and 515 in many respects, thus like features are identified with like reference numerals, with a leading hundreds numeral incremented to the value “6”. For example, the laminate structure can include an inner ply 651, a paper layer 635, a tie layer 691, and a tie layer 692 that resemble similarly named and numbered features described above, such that the applicable disclosure relative to these features apply equally to the present disclosure. The laminate structure can further include an outer ply 631 that includes both a polyolefin layer 633 and a polyamide layer 681. The polyolefin layer 633 can overlie the polyamide layer 681, and can resemble the polyolefin layer 33 described above. For example, in some embodiments, the polyolefin layer 633 can comprise PET, and may be reverse printed. The polyolefin layer 633 can be attached to the polyamide layer 681 via any suitable tie layer 693.

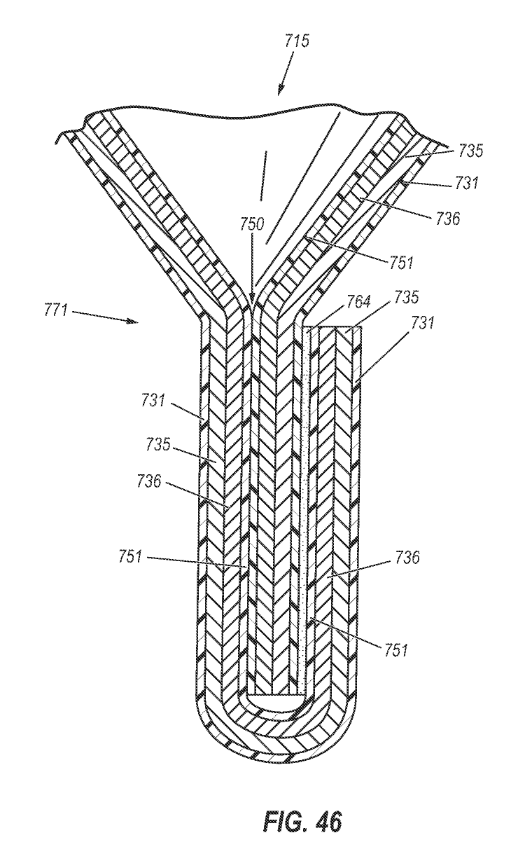

FIGS. 45 and 46 depict another embodiment of a bag 715, which can comprise any suitable configuration disclosed herein. FIG. 45 illustrates a cross-sectional view of an embodiment of a composite laminate structure that may be employed to form the bag 715. The cross sectional view of FIG. 45 is similar to the view of FIG. 40, and the composite laminate structure of the bag 715 can resemble the structures of the bags 415, 515, and 615 in many respects, thus like features are identified with like reference numerals, with a leading hundreds numeral incremented to the value “7”. For example, the laminate structure can include an inner ply 751, a first paper layer 735, an outer ply 731, a tie layer 791, and a tie layer 792 that resemble similarly named and numbered features described above, such that the applicable disclosure relative to these features apply equally to the present disclosure. As a further example, the composite laminate structure of bag 715 may be configured to be compatible with the bag end closures described herein, including pinch-type and sewn configurations. In some embodiments, the bag 715 may comprise a zipper closure such as is depicted herein by FIGS. 33-35 and described in the associated text.

In certain embodiments, the bag 715 can include a second paper layer 736, which can comprise any suitable paper layer described herein. In some embodiments, the paper layers 735, 736 are substantially the same as each other. In other embodiments, the paper layers 735, 736 can differ from each other, such as, for example, in basis weight and/or paper type. In some embodiments, the first paper layer 735 includes an extensible paper and the second layer 736 includes a Kraft paper. The paper layers 735, 736 can be joined to each other in any suitable fashion. In some embodiments, the paper layers 735, 736 are adhered to each other over all or substantially all of an area over which the paper layers 735, 736 face each other via any suitable adhesive 794. In other embodiments, spot pasting may be employed to attach the paper layers 735, 736 to each other.

In various embodiments, a total thickness of the body material can be within a range of from about 5.0 mil to about 15.0 mil, from about 5.0 mil to about 12.0 mil, from about 6.0 mil to about 10.0 mil, can be no less than about 5.0 mil, no less than about 6.0 mil, no less than about 7.0 mil, no less than about 8.0 mil, no less than about 9.0 mil, no less than about 10.0 mil, or no less than about 11.0 mil. In various embodiments, the outer ply 731 can define a thickness that is within a range of from about 5 percent to about 35 percent, from about 10 percent to about 30 percent, is no less than about 5 percent, no less than about 10 percent, no less than about 15 percent, no less than about 20 percent, or no less than about 25 percent of the total thickness of the body material. In other or further embodiments, the first paper layer 735 can define a thickness that is within a range of from about 15 percent to about 70 percent, from about 25 percent to about 60 percent, from about 30 percent to about 50 percent, is no less than about 15 percent, no less than about 25 percent, no less than about 30 percent, no less than about 40 percent, no less than about 50 percent, or no less than about 60 percent of the total thickness of the body material. In other or further embodiments, the second paper layer 736 can define a thickness that is within a range of from about 15 percent to about 70 percent, from about 25 percent to about 60 percent, from about 30 percent to about 50 percent, is no less than about 15 percent, no less than about 25 percent, no less than about 30 percent, no less than about 40 percent, no less than about 50 percent, or no less than about 60 percent of the total thickness of the body material. In other or further embodiments, the inner ply 751 can define a thickness that is within a range of from about 5 percent to about 40 percent, from about 10 percent to about 35 percent, from about 15 percent to about 30 percent, is no less than about 5 percent, no less than about 10 percent, no less than about 15 percent, no less than about 20 percent, no less than about 25 percent, or no less than about 30 percent of the total thickness of the body material.

FIG. 46 depicts a compressed lip configuration 771 of a pinch-type closure similar to those depicted in FIGS. 13-16B and described in the associated text. The composite laminate structure of the material from which the bag 715 is formed may be compatible with other types of bag end closures disclosed herein. The outer ply 731, the paper layer 735, second paper layer 736, and inner ply 751 form a bag wall. As described above, an end of a bag can be closed by bringing two portions of the bag wall adjacent to each other and fixedly coupling them together. In the embodiment depicted in FIG. 46, one of the portions of the bag wall (e.g., a rear wall portion) is longer than an opposing portion of the wall (e.g., a front wall portion) such that the longer portion can wrap around and overlie the shorter wall portion. An adhesive layer 764 can fixedly couple the two portions of the bag wall to each other. The adhesive layer 764 can comprise any suitable adhesive, such as, for example, a hot melt adhesive. The hot melt adhesive can comprise, for example, any suitable hot melt adhesive described above with respect to the adhesive 64. In some embodiments, a portion of the bag 715 to which the hot melt adhesive 764 is to be applied is preheated, such as described above with respect to the bag 415. In certain embodiments, a seal 750 may be formed in addition to that provided by the adhesive layer 764, which can fixedly couple the bag walls together. The seal 750 may comprise a heat seal, if inner ply 751 comprises a heat-sealable film. Otherwise, if present, the seal 750 may comprise a tie layer as disclosed herein.

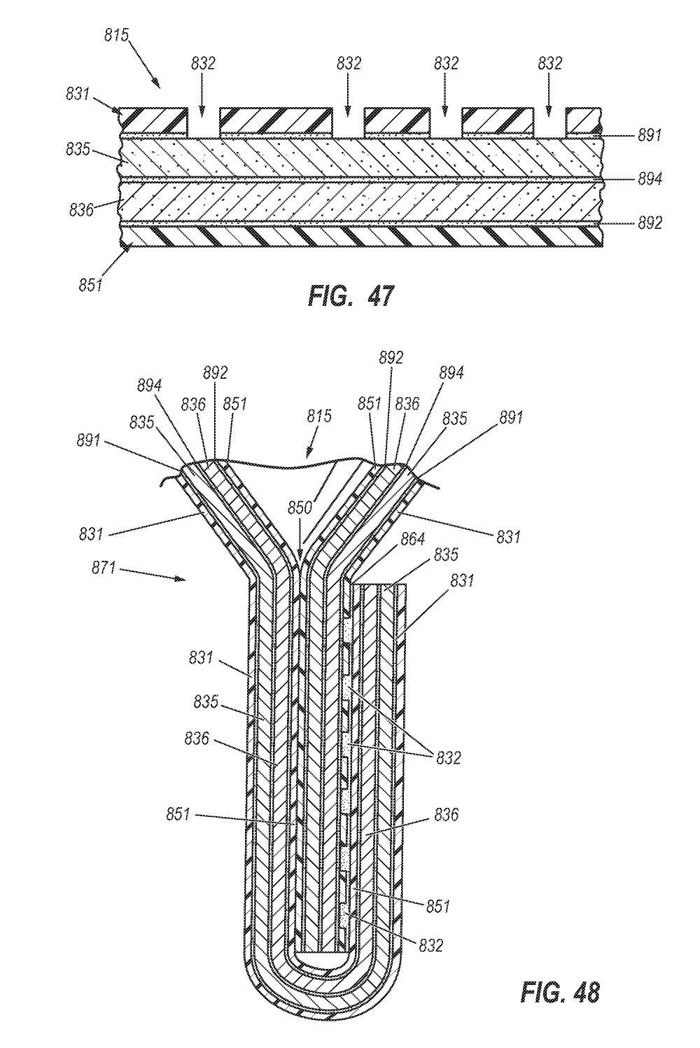

FIGS. 47 and 48 depict another embodiment of a bag 815, which can comprise any suitable configuration disclosed herein. FIG. 47 illustrates a cross-sectional view, similar to that of FIG. 40, of an embodiment of a composite laminate structure that may be employed to form the bag 815. The composite laminate structure of the bag 815 can resemble the structures of the bags 415, 515, 615, 715 in many respects, thus like features are identified with like reference numerals, with a leading hundreds numeral incremented to the value “8”. For example, the laminate structure can include an outer ply 931, a first paper layer 935, a second paper layer 936, and an inner ply 951 that resemble similarly named and numbered features described above, such that the applicable disclosure relative to these features apply equally to the present disclosure. Likewise, the laminate structure can include tie layers 991, 992, and the paper layers 935, 936 can be joined via an adhesive 994. The outer ply 931 can include an outermost polyolefin layer 933, which can be reverse printed in some embodiments. The polyolefin layer 933 can be attached to a

In the illustrated embodiment, a portion of the outer ply 831 and the tie layer 891 immediately underlying the outer ply 831 include one or more channels 832 extending through them so as to provide access to the first paper layer 835. The channels 832 can be formed in any suitable manner, such as via perforations, slits, or other mechanical alterations.

As shown in FIG. 48, at least one end of the bag 815 can be closed via a compressed lip configuration 871 of a pinch-type closure, similar to those depicted in FIGS. 13-16B. In a manner such as previously described, an end of a bag 815 can be closed by bringing two bag walls into close proximity and fixedly coupling them together. In the embodiment illustrated in FIG. 48, one of the bag walls is longer than the other (e.g., includes a flap) such that the longer portion can wrap around and overlie the shorter bag wall to form a seal therewith via an adhesive layer 864. In other or further embodiments, a seal 850 may be formed in addition to that provided by the adhesive layer 864, which can fixedly couple the bag walls together. The seal 850 may comprise a heat seal, if inner ply 851 comprises a heat-sealable film. Otherwise, if present, the seal 850 may comprise a tie layer as disclosed herein.

The channels 832 may be located at or near an end of the bag 815. In the illustrated embodiment, the channels 832 are primarily located on the shorter bag wall portion such that a seal between the outer ply 831 of the shorter portion and the inner ply 851 of the longer portion is enhanced. For example, the adhesive layer 864 may form a stronger bond with the paper layer 835 than it does with the outer ply 831. In certain embodiments, the adhesive layer 864 comprises a hot melt adhesive, such as, for example, any suitable hot melt adhesive disclosed herein.

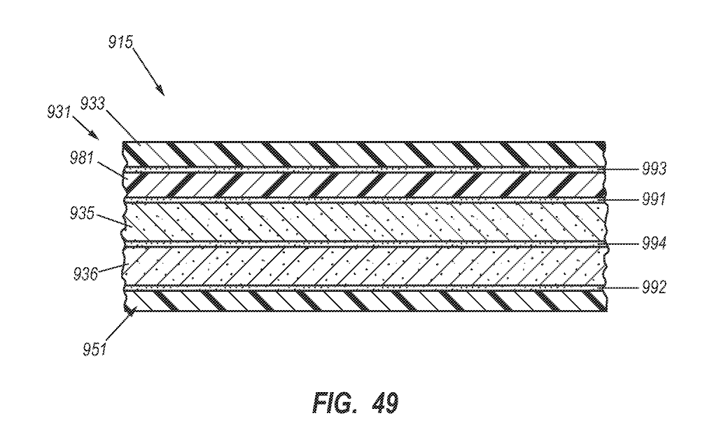

FIG. 49 depicts a cross-sectional view, similar to that of FIG. 40, of another embodiment of a composite laminate structure that may be employed to form a bag 915, which can comprise any suitable configuration disclosed herein. The composite laminate structure of the bag 915 can resemble the structures of the bags 415, 515, 615, 715, 815 in many respects, thus like features are identified with like reference numerals, with a leading hundreds numeral incremented to the value “9”. For example, the laminate structure can include an outer ply 931, a first paper layer 935, a second paper layer 936, and an inner ply 951 that resemble similarly named and numbered features described above, such that the applicable disclosure relative to these features apply equally to the present disclosure. Likewise, the laminate structure can include tie layers 991, 992, and the paper layers 935, 936 can be joined via an adhesive 994.

The outer ply 931 can include both a polyolefin layer 933 and a polyamide layer 981. The polyolefin layer 933 can overlie the polyamide layer 981, and can resemble the polyolefin layers 33, 633 described above. For example, in some embodiments, the polyolefin layer 933 can comprise PET, and may be reverse printed. The polyolefin layer 933 can be attached to the polyamide layer 981 via any suitable tie layer 993.

Any suitable feature of the various embodiments of the bags 15, 115, 215, 315, 415, 515, 615, 715, 815, 915 described above can be incorporated into or otherwise used with any of the remaining bags 15, 115, 215, 315, 415, 515, 615, 715, 815, 915. Further, the bags 15, 115, 215, 315, 415, 515, 615, 715, 815, 915 may be assembled and/or used according to methods that may, in certain respects, resemble those discussed above with respect to any of the remaining bags 15, 115, 215, 315, 415, 515, 615, 715, 815, 915. For example, any suitable body material structure and/or any suitable closure arrangement, or combination of closure arrangements, may be used with a given bag. By way of further illustration, in some embodiments, channels such as the channels 832 of the bag 815 can be provided in a closure region of the bags 615, 715, 915. For the bags 615, 915, the channels 832 can extend through the layers 633, 681 and 933,981 to provide access to the paper layers 635, 935, respectively.

Following are non-limiting examples compatible with certain embodiments described herein. The examples are provided by way of illustration, and are not intended to limit the disclosure.

### Example 3

Material for forming a bag, such as the material used to form the bag 415, was laminated on an in-line tuber. The material included an outer ply of 75 gauge Dartek® cast nylon film. The nylon film was laminated to a layer of 50 pound PolarX extensible paper via a polyurethane single-component solventless adhesive—specifically, Henkel Corporation's Tycel® 7910™ adhesive in an amount of 2.5 pounds per ream. A 2.0 mil layer of BOPP film was then laminated to an opposite side of the extensible paper via Tycel® 7910™ adhesive in an amount of 2.5 pounds per ream. The material was then formed into a pinched bottom open mouth (PBOM) configuration using standard forming equipment and subsequently filled with 35 pounds of dog food. The other open end of the bag was then closed using a pinch closure, such that the top and bottom ends were sealed in a hot-melt-sealed configuration such as that shown in FIG. 14B.

### Example 4

Material for forming a bag, such as the material used to form the bag 715, was laminated on an in-line tuber. The material included an outer ply of 75 gauge Dartek® cast nylon film. The nylon film was laminated to a layer of 50 pound PolarX extensible paper via a polyurethane single-component solventless adhesive—specifically, Henkel Corporation's Tycel® 7910™ adhesive in an amount of 2.5 pounds per ream. The extensible paper was then spot-pasted to 40 pound converting Kraft paper, which had a thickness within a range of from 3 mil to 4 mil. Water-based adhesive was used for the spot-pasting. A 70 gage film of BOPP was then laminated to the 40 pound Kraft paper using a water-based adhesive. The material was then formed into a pinched bottom open mouth (PBOM) configuration using standard forming equipment and subsequently filled with 35 pounds of dog food. The other open end of the bag was then closed using a pinch closure, such that the top and bottom ends were sealed in a hot-melt-sealed configuration such as that shown in FIG. 14B.

Bags formed in accordance with Examples 3 and 4 demonstrate excellent performance in a variety of standardized and reproducible tests. For example, the bags can more durable than standard multiwall pet food bags and other bags with composite structures, in that they can be more resistant to puncturing and/or tearing under conditions that may arise during handling of the bags. The tables that follow demonstrate the results of certain tests involving these bags and comparative bags.

Drop tests can demonstrate the relative durability of the composite bag structures associated with Examples 3 and 4, as compared with other bag varieties. One suitable drop test can be performed in accordance with test method ASTM D 5276 and/or test method TAPPI UM 806. The foregoing test methods can also be altered or augmented. In some instances, the drop test can comprise a 6-stage cycle, with each stage comprising dropping the bag from a height of 4 feet. The 6 stages of the cycle can comprise separately dropping the bag on its front, back, left edge, right edge, top, and bottom. In some instances, testing can be stopped after three full dropping cycles (i.e., after 18 total drops of the bag). The results of one drop test are set forth in Table 7.

TABLE 7

| Bag Type | Number of Drops Before Failure |
|---|---|
| Multiwall | 8 |
| Composite | 10.6 |
| Example 3 | 13 |
| Example 4 | 18 |

In Table 7, the “Multiwall” bags consisted of 41 a standard body material having an outer layer of 41 pound bleached clay coated paper. The clay coated paper was spot pasted to an inner ply of 40 pound Kraft, which was spot pasted to another ply of 40 pound Kraft. The inner Kraft ply was laminated to a 70 gauge BOPP film via water-based adhesive. The bag was filled with 35 pounds of dog food and both ends were sealed with a hot-melt pinch closure. The “Composite” bags consisted of an outer layer of 0.48 mil thick PET film laminated via solventless adhesive to a bleached clay-coated paper, and an inner surface of the clay-coated paper was laminated via solventless adhesive to a 2.5 mil thick coextruded film having a nylon core. The “Example 3” and “Example 4” bags were formed in accordance with the descriptions set forth above under the headings “Example 3” and “Example 4,” respectively. The averaged results set forth in Table 7 indicate that the “Example 3” and “Example 4” varieties of bags demonstrated better durability than standard multiwall bags in row one or the specific variety of composite bag in row two. Moreover, the “Example 4” bags were more durable than the “Example 3” bags.

Additional tests performed on the varieties of bags used in the drop tests. These additional tests are listed in the header row of Table 8. It is noted that the abbreviation “MD” is used to denote “Machine Direction,” and the abbreviation “CD” is used to denote “Cross Direction.” For the examples shown, sharp probe and dull probe puncture resistances were measured in accordance with test method ASTM D5748, tear resistance was measured in accordance with test method ASTM D1922, and tear initiation was measured in accordance with test method ASTM D1004.

TABLE 8

| | Sharp | | | | | |
|---|---|---|---|---|---|---|
| | Probe | Dull Probe | MD | CD | MD | CD |
| | Puncture | Puncture | Tear | Tear | Tear | Tear |
| | Resistance | Resistance | Resistance | Resistance | Initiation | Initiation |
| Bag Type | (g) | (g) | (g) | (g) | (g) | (g) |
| Multiwall | N/A | 1519 | 56 | 55 | 707 | 597 |
| Composite - PET | 1230 | 6929 | 385 | 431 | 2292 | 2052 |
| Example 3 | 1051 | 9500 | 182 | 184 | 2300 | 2200 |
| (Composite - Nylon) | | | | | | |
| Example 4 | 700 | 4663 | 165 | 138 | 1119 | 1029 |
| Non-woven | 1779 | 16085 | 1159 | 1294 | 4077 | 3751 |

In Table 8, the “Multiwall” bag included a structure such as that described above with respect to the “Multiwall” bag of Table 7. The material identified as “Composite-PET” included an outer ply of 48 gauge PET, which was laminated to a layer of 50 pound PolarX extensible paper via a polyurethane single-component solventless adhesive—specifically, Henkel Corporation's Tycel® 7910™ adhesive in an amount of 2.5 pounds per ream. A 4.0 mil layer of coextruded film having a nylon core was then laminated to an opposite side of the extensible paper via Tycel® 7910™ adhesive in an amount of 2.5 pounds per ream. The material was then formed into a pinched bottom open mouth (PBOM) configuration using standard forming equipment and subsequently filled with 35 pounds of dog food. The other open end of the bag was then closed using a pinch closure, such that the top and bottom ends were sealed in a hot-melt-sealed configuration such as that shown in FIG. 14B The “Non-woven” bags consisted of an outermost layer of 0.48 mil thick PET laminated via solventless adhesive to a non-woven fabric comprising PET coated with LDPE and having a weight of 2.5 ounces per square yard, and an inner layer of the non-woven fabric was laminated via solventless adhesive to BOPP film having a thickness of 2.0 mil. The bag was filled and closed in a manner such as that described with respect to the “Composite-PET” bag.

As illustrated in Table 8, in various embodiments, bag types formed with composite structures such as those of the bags 415, 615, 715, 815, and 915 can have improved strength and durability. However, the specific measurements set forth in Table 8 should not be construed as limiting. For example, in various embodiments, a composite bag (e.g., a bag 415, 615, 715, 815, or 915, as described above) can have a sharp probe puncture resistance that is within a range of from about 800 grams to about 2,500 grams, from about 1,000 grams to about 2,000 grams, from about 1,000 grams to about 1,500 grams, from about 1,250 grams to about 1,750 grams, is no less than about 800 grams, no less than about 1,000 grams, no less than about 1,250 grams, no less than about 1,500 grams, no less than about 1,750 grams, no less than about 2,000, no less than about 2,250 grams, or no less than about 2,500 grams. In other or further embodiments, the composite bag can have a dull probe puncture resistance that is within a range of from about 4,000 grams to about 8,000 grams, from about 5,000 grams to about 8,000 grams, from about 6,000 grams to about 7,000 grams, is no less than about 4,000 grams, no less than about 5,000 grams, no less than about 6,000 grams, no less than about 7,000 grams, or no less than about 8,000 grams. In other or further embodiments, the composite bag can have a machine-direction tear resistance that is within a range of from about 2,000 grams to about 4,000 grams, from about 2,500 grams to about 3,500 grams, or from about 3,000 grams to about 4,000 grams, is no less than about 2,000 grams, no less than about 2,500 grams, no less than about 3,000 grams, no less than about 3,500 grams, or no less than about 4,000 grams. In other or further embodiments, the composite bag can have a cross-direction tear resistance that is within a range of from about 3,000 grams to about 6,000 grams or from about 4,000 grams to about 5,000 grams, is no less than about 3,000 grams, is no less than about 3,500 grams, is no less than about 4,000 grams, is no less than about 5,000 grams, is no less than about 5,500 grams, or is no less than about 6,000 grams. In other or further embodiments, the composite bag can have a machine-direction tear initiation that is within a range of from about 1,000 grams to about 3,000 grams or from about 1,500 grams to about 2,500 grams, is no less than about 1,000 grams, no less than about 1,500 grams, no less than about 2,000 grams, no less than about 2,500 grams, or no less than about 3,000 grams. In other or further embodiments, the composite bag can have a cross-direction tear initiation that is within a range of from about 1,000 grams to about 3,000 grams or from about 1,500 grams to about 2,500 grams, is no less than about 1,000 grams, no less than about 1,500 grams, no less than about 2,000 grams, no less than about 2,500 grams, or no less than about 3,000 grams.

In various embodiments, a composite bag can have a Mullen greater than 100 psi. In other or further embodiments, a composite bag can have a machine-direction tensile strength that is within a range of from about 30 pounds per inch to about 70 pounds per inch, is no less than about 30 pounds per inch, no less than about 40 pounds per inch, no less than about 50 pounds per inch, or no less than about 60 pounds per inch. In other or further embodiments, a composite bag can have a machine-direction stretch that is within a range of from about 3% to about 15%, is no less than about 3%, no less than about 5%, no less than about 10%, or no less than about 15%. In other or further embodiments, a composite bag can have a cross-direction tensile strength that is within a range of from about 15 pounds per inch to about 30 pounds per inch, is no less than about 15 pounds per inch, no less than about 20 pounds per inch, or no less than about 25 pounds per inch. In other or further embodiments, a composite bag can have a cross-direction stretch that is within a range of from about 5% to about 15%, is no less than about 5%, no less than about 10%, or no less than about 15%. In other or further embodiments, a composite bag can have a machine-direction taber stiffness that is within a range of from about 2.5 to about 5.0, is no less than about 2.5, no less than about 3.0, no less than about 4.0, or no less than about 4.5. In other or further embodiments, a composite bag can have a cross-direction taber stiffness that is within a range of from about 3.0 to about 7.0, is no less than about 3.0, no less than about 4.0, no less than about 5.0, or no less than about 6.0. Any subset of the foregoing ranges is possible, and values outside of the listed ranges are also possible. Additionally, it is noted that values recited in this paragraph for Mullen are determined in accordance with test method TAPPI T403, those for tensile and stretch are determined in accordance with test method TAPPI T494, and those for taber stiffness are determined in accordance with test method ASTM D5748.

Other ranges may be possible for constructions that include a non-woven layer of material. For example in some embodiments, a bag having a non-woven layer and a construction such as that described above with respect to Table 8 can have a sharp probe puncture resistance within a range of from about 1,000 grams to about 2,800 grams, or that is no less than about 1,000 grams, no less than about 1,500 grams, no less than about 2,000 grams, no less than about 2,500 grams, or no less than about 2,800 grams.

In various embodiments, the body material of a composite bag can be configured so as to have stiffness, dead-fold, and/or other handling properties similar to those of standard multiwall Kraft bags. For example, in some embodiments, although only one or two layers of paper may be present in the body material, the body material may be as stiff as constructions having more paper layers. Moreover, the body material may be able to maintain a crease in a fashion similar to standard multiwall Kraft bags. Accordingly, in some embodiments, the body material can behave similarly to standard paper structures, and thus bags can be formed on standard forming equipment with relatively few or even no modifications to the equipment.

As a further illustration of the durability of the structures described with respect to the bags 415, 515, 615, 715, 815, 915, a fork lift puncture test was devised to test the performance of a bag under abusive handling conditions. In this test, a prong tip comparable to the tips of prongs used in industrial forklifts (in particular, Hyster forklifts) was used. The elongated prong tip weighed 18 pounds and included a sharpened end. The prong tip was dropped from a height of twelve inches above an upward-facing surface of a bag lying on a rigid surface. Thus, the sharpened end of the prong tip fell through twelve inches to impact the upward-facing surface of the bag. The bags can be evaluated on a pass/fail basis, and the severity of the puncture can be noted with respect to the number of plies punctured. Three of the same bag types tested with respect to Table 8 were subjected to the fork lift puncture test, and the results are shown below in Table 9.

TABLE 9

| Bag Type | Pass/Fail | Severity of Puncture |
|---|---|---|
| Multiwall | Fail | Large split |
| Example 3 | Pass | No puncture - dent formed |
| Non-woven | Pass | No puncture - dent formed |

Table 10, which is set forth below, presents results from an insect infestation study performed using bags having four different construction types. The various constructions included three different body material configurations and two different end closure configurations. Ten total bags of each construction type were used—five included pet food with a first fat content and another five included pet food with a second fat content.

TABLE 10

Total Number
of Indian Meal
Moths Observed

| Bag Construction | Bag # | 8% Fat | 12% Fat |
|---|---|---|---|
| CC/MWK/BOPP | 1 | 11 | 3 |
| PBOM | 2 | 0 | 0 |
| | 3 | 0 | 0 |
| | 4 | 8 | 0 |
| | 5 | 23 | 5 |
| Composite | 1 | 0 | 0 |
| PBOM | 2 | 0 | 0 |
| | 3 | 0 | 0 |
| | 4 | 0 | 0 |
| | 5 | 2 | 0 |
| Woven Poly/BOPP | 1 | 34 | 5 |
| SOM | 2 | 22 | 4 |
| | 3 | 19 | 14 |
| | 4 | 3 | 13 |
| | 5 | 54 | 7 |
| Composite | 1 | 12 | 3 |
| SOM | 2 | 44 | 5 |
| | 3 | 15 | 12 |
| | 4 | 7 | 0 |
| | 5 | 23 | 8 |

In Table 10, the term “PBOM” represents a pinch-bottom-open-mouth configuration and the term “SOM” represents a sewn-open-mouth configuration. For each configuration, the top end of the bag was closed in the same manner as the bottom end of the bag. Thus, for the PBOM configurations, both the top and bottom ends included a pinch-type closure in which a flap extending from one side of the bag was folded over the other side of the bag and adhered thereto with a hot melt adhesive, similar to the closure depicted in FIG. 14B. For the SOM configurations, both the top and bottom ends included a closures similar to those depicted in FIG. 30.

For the first set of rows, the term “CC/MWK/BOPP” represents a standard body material having an outer layer of 41 pound bleached clay coated paper available under the name CSR4 from FraserPapers of Toronto, Ontario. The body material further includes two inner plies of 50 pound multiwall kraft. The innermost kraft ply is coated with a 0.7 mil layer of BOPP. The ends of the bag were closed using a polyethylene-based hot melt

The results in the second set of rows can be compared with those of the first set of rows. In the second set of rows, the term “Composite” represents a body material having a construction such as that shown in FIG. 10A. In particular, the body material included an outer ply 31 having an outermost layer 33 of 0.48 mil polyethylene adhered to a paper layer 35 of 50 pound PolarX extensible paper. An inner ply 51 included a 2.5 mil coextruded film having a nylon core 55 with metallocene LDPE layers 53, 54 attached to either side thereof via tie layers 37. The ends of the bag were closed using a polyamide hot melt having Product No. 34-3412, which is available from Henkel Corporation of Rocky Hill, Conn.

For the third set of rows, the term “Woven Poly/BOPP” represents a standard body material having an inner layer of 850 denier woven polypropylene fabric having an 8×8 thread count. The body material further included an outer ply of BOPP having a thickness of 0.7 mil.

The results in the fourth set of rows can be compared with those of the third set of rows. In the fourth set of rows, the term “Composite” represents a body material such as that described above with respect to the second set of rows.

Pet food containing 8% fat by weight was enclosed in five of each variety of bag. Likewise, pet food containing 12% fat by weight was enclosed in five of each variety of bag. The filled bags were randomly placed in a walk-in environmental chamber. The chamber was maintained at 27 degrees C. and 60% relative humidity with a alternating light/dark cycle of twelve hours each. The walk-in chamber included an initial population of 2,000 mixed-sex adult Indian Meal Moths (IMM) (Plodia interpunctella). The bags were left inside the chamber for eight weeks. It is noted that the development time for the IMM from egg to adult is 28 days, and that the female IMM, under laboratory conditions, lays 300 eggs at a time. Thus, the bags used in this study were exposed to several generations of IMM.

The results reported in Table 10 represent the number of IMM found inside a particular bag. It is believed that an impregnated female IMM would deposit her eggs on a bag at the point where the odor trail of pet food was strongest. The eggs would hatch, and if the odor trail led to a hole which granted access to the interior of the bag, the larva would crawl inside the bag. Once inside the bag, it would feed. If other larvae matured inside the bag and nature took its course, the mature IMM, now inside the bag, would reproduce. As the adult IMM is significantly larger than the larva, it was thought to be extremely difficult for the adult to have access to the inside of the bag directly, absent manufacturing defects in the bag.

The results of the experiment indicate that the pet food that included 8% fat had a stronger odor than the pet food that included 12% fat. In general, PBOM closures are more successful at resisting IMM infestation than are SOM closures. For either closure type, however, the Composite construction had a lower rate of IMM infestation. Moreover, the PBOM Composite construction was the most resistant to IMM infestation, and for pet foot having 12% fat, was completely effective at preventing IMM infestation under the experimental conditions set forth above.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims that follow are hereby expressly incorporated into the present written disclosure, with each claim standing on its own as a separate embodiment. Likewise, this disclosure includes all permutations of the independent claims with their dependent claims. For example, additional embodiments capable of derivation from each set of independent and dependent claims are expressly incorporated into the present written description. These additional embodiments can determined by replacing the dependency of all dependent claims with the phrase “any of the preceding claims up to and including the nearest independent claim.”

Recitation in the claims of the term “first” with respect to a feature or element does not necessarily imply the existence of a second or additional such feature or element. Recitation in the claims of the term “outer” with respect to an element does not necessarily imply that the element is the outermost of such elements. Similarly, recitation in the claims of the term “inner” with respect to an element does not necessarily imply that the element is the innermost of such elements. Elements recited in means-plus-function format are intended to be construed in accordance with 35 U.S.C. § 112 ¶ 6. It will be apparent to those having skill in the art that changes may be made to the details of the above-described embodiments without departing from the underlying principles of the invention. Embodiments of the invention in which an exclusive property or privilege is claimed are defined as follows.

1. A bag comprising:
a tube formed of a body material, wherein the body material comprises:
a paper layer having a basis weight within a range of from about 30 pounds per ream to about 80 pounds per ream;
a polyamide layer having a thickness in a range of from about 0.5 mil to about 3.0 mil adhered to an outwardly facing surface of the paper layer; and
a polyolefin layer adhered to an inwardly facing surface of the paper layer,
wherein a first end of the tube is closed so as to substantially prevent grease from entering or exiting the tube via the first end.

2. The bag of claim 1, wherein the paper layer comprises an extensible paper.

3. The bag of claim 2, wherein the paper layer defines a thickness within a range of from about 20 percent to about 80 percent of a total thickness of the body material.

4. The bag of claim 3, wherein the paper layer has a basis weight of about 50 pounds per ream and defines a thickness in a range of from about 3.3 mil to about 3.7 mil.

5. The bag of claim 1, wherein the polyamide layer comprises cast nylon.

6. The bag of claim 5, wherein the polyamide layer defines a thickness within a range of from about 10 percent to about 40 percent of a total thickness of the body material.

7. The bag of claim 1, wherein the polyamide layer is reverse printed.

8. The bag of claim 1, wherein the tube further comprises a polyolefin film at an exterior of the polyamide layer.

9. The bag of claim 8, wherein the polyolefin film comprises polyethylene terephthalate and is reverse printed.

10. The bag of claim 1, wherein the polyolefin layer comprises biaxially oriented polypropylene.

11. The bag of claim 10, wherein the polyolefin layer defines a thickness within a range of from about 10 percent to about 50 percent of a total thickness of the body material.

12. The bag of claim 1, wherein the polyamide layer is adhered to the paper layer via a polyurethane-based single-component solventless adhesive.

13. The bag of claim 12, wherein the adhesive is applied in an amount of about 2.5 pounds per 3,000 square feet.

14. The bag of claim 1, wherein the polyolefin layer is adhered to the paper layer via a water-based adhesive.

15. The bag of claim 1, wherein the tube includes a first wall and a second wall opposite the first wall, wherein the first wall includes a flap that is folded over and adhered to the second wall in a pinch fold closure.

16. The bag of claim 15, wherein the flap is adhered to the second wall via a hot melt adhesive.

17. The bag of claim 1, wherein the tube includes a first wall and a second wall that each define approximately the same longitudinal length, wherein the polyolefin layer comprises a heat sealable material, and wherein the first end of the tube is closed via a heat sealed pinch closure.

18. The bag of claim 1, wherein the first end of the tube is closed via stitching.

19. A bag comprising:
a tube formed of a body material, wherein the body material comprises:
an outer ply comprising a nylon film;
a paper layer adhered to an interior surface of the outer layer via a polyurethane-based single-component solventless adhesive; and
an inner ply comprising a polyolefin film that is adhered to an interior surface of the paper layer via a water-based adhesive,
wherein a first end of the tube is closed so as to substantially prevent grease from entering or exiting the tube via the first end.

20. The bag of claim 19, wherein the bag defines a total thickness within a range of from about 4.0 mil to about 11.5 mil, wherein the outer ply defines a thickness that is no less than about 10 percent of the total thickness, and wherein the inner ply defines a thickness that is no less than about 10 percent of the total thickness.

21. The bag of claim 20, wherein the paper layer defines a thickness that is no less than about 50 percent of the total thickness.

22. The bag of claim 19, wherein a sharp probe puncture resistance of the tube body is within a range of from about 800 grams to about 2,500 grams.

23. The bag of claim 19, wherein a dull probe puncture resistance of the tube body is within a range of from about 4,000 grams to about 8,000 grams.

24. The bag of claim 19, wherein a machine-direction tear resistance of the tube body is within a range of from about 2,000 grams to about 4,000 grams and a cross-direction tear resistance of the tube body is within a range of from about 3,000 grams to about 6,000 grams.

25. A bag comprising:
a tube formed of a body material, wherein the body material comprises:
a polyamide layer having a thickness in a range of from about 0.5 mil to about 3.0 mil;
a first paper layer adhered to an inner surface of the polyamide layer via a polyurethane-based single-component solventless adhesive;
a second paper layer adhered to an inner surface of the first paper layer; and
a polyolefin layer adhered to an inwardly facing surface of the second paper layer,
wherein a first end of the tube is closed so as to substantially prevent grease from entering or exiting the tube via the first end.

26. The bag of claim 25, wherein the polyamide layer comprises cast nylon.

27. The bag of claim 25 wherein the polyolefin layer comprises biaxially oriented polypropylene.

28. The bag of claim 25, wherein the polyolefin layer comprises a coextruded film.

29. The bag of claim 25, wherein at least one of the first and second paper layers comprises an extensible paper.

30. The bag of claim 29, wherein said at least one of the first and second paper layers defines a thickness within a range of from about 15 percent to about 70 percent of a total thickness of the body material.

31. The bag of claim 29, wherein said at least one of the first and second paper layers has a basis weight of about 50 pounds per ream and defines a thickness in a range of from about 3.3 mil to about 3.7 mil.

32. A method of manufacturing a bag, the method comprising:
laminating a polyamide layer to a first side of a paper layer via a polyurethane-based single-component solventless adhesive;
laminating a polyolefin layer to a second side of the paper layer;
forming the polyamide layer, the paper layer, and the polyolefin layer into a tube body such that the polyolefin layer is within the paper layer and such that the paper layer is within the polyamide layer, wherein the tube body has a first end, a second end, a front wall, and a back wall; and
forming a substantially grease-proof closure at the first end of the tube body.

33. The method of claim 32, wherein the forming a substantially grease-proof closure at the first end of the tube body comprises providing stitching through the first end of the tube body.

34. The method of claim 32, wherein forming a substantially grease-proof closure at the first end of the tube body comprises forming a pinch fold closure at the first end of the tube body.

35. The method of claim 34, wherein the pinch fold closure includes a polyamide hot melt adhesive.

36. A bag comprising:
a tube formed of a body material, wherein the body material comprises:
a first layer of material that comprises a polyamide;
a second layer of material that comprises a polyolefin;
a paper layer having an outer face and an inner face, wherein the outer face is adhered to one of the first and second layers of material and the inner face is adhered to the other of the first and second layers of material,
wherein a first end of the tube is closed so as to substantially prevent grease from entering or exiting the tube via the first end.
